(19) United States
(12) Patent Application Publication
(10) Pub. No.: US 2017/0321850 A1
(43) Pub. Date: Nov. 9, 2017

(54) LED and/or Laser Light Source or Bulb for Light Device

(71) Applicant: Tseng-Lu Chien, Walnut, CA (US)

(72) Inventor: Tseng-Lu Chien, Walnut, CA (US)

(21) Appl. No.: 15/355,515

(22) Filed: Nov. 18, 2016

Related U.S. Application Data
(63) Continuation-in-part of application No. 14/289,968, filed on May 29, 2014, now Pat. No. 9,551,477.
Application No. 14/289,968 is a division of application No. 14/280,865, filed on May 19, 2014, now Pat. No. 9,581,299.
Application No. 14/280,865 is a division of application No. 13/540,728, filed on Jul. 3, 2012, now Pat. No. 8,834,009.
Application No. 13/540,728 is a continuation-in-part of application No. 14/503,647, filed on Oct. 1, 2014, now Pat. No. 9,719,654.
Application No. 14/503,647 is a continuation-in-part of application No. 14/323,318, filed on Jul. 3, 2014.

(51) Int. Cl. F21K 9/65; F21V 29/70; F21K 9/232; F21K 9/60; F21V 5/04; F21W 131/30

(52) U.S. Cl. CPC F21K 9/65; F21K 9/60; F21V 5/04; F21V 29/70; F21K 9/232; F21W 2131/30

(57) ABSTRACT

The (LED or-and Laser) light source or bulb for light device including garden light has at least one of (1)more than one bulb-base(es)(2) more than one optics-elements which at least one is 180 of degree flat or ½ ball, ⅔ ball, sphere, dome shape for top cover(3) optic-lens or laser film or grating film to enlarge or created plurality of image, lighted patterns(4)built-in or add-on flexible bendable arms to change position ,direction, orientation of (LED or-and Laser) light beam(5) near-by and far-away illumination, image, lighted patterns, or desired light effects(6)more than one light beam emit out from (LED or-and Laser) light source or bulb for garden light controlled by IC or circuitry(7)more than one function selected from USB charger, power failure, remote control, Infra-red controller, blue-tooth, wifi, internet, App software, motion sensor and wireless with multiple-way communication(8) rechargeable circuit, batteries or rechargeable battery, USB ports for the (LED or-and Laser)-bulb be charged or supply other device current.

### RELATED U.S. APPLICATION DATA

(1) This filing is continuously filing for (#DD-1) U.S. application Ser. No. 12/834,435 filed on Jul. 12, 2010 which is continuously filing for (#DD-2008) U.S. application Ser. No. 12/292,153 filed on Nov. 12, 2008 now is U.S. Pat. No. 7,871,192 which has Child continuity filed cases U.S. application Ser. No. 12/886,832 filed on Sep. 21, 2010 and U.S. application Ser. No. 12/886,435 filed Jul. 12, 2010 and U.S. application Ser. No. 14/622,628 filed on Feb. 13, 2015 and U.S. application Ser. No. 14/737,434 filed on Jun. 11, 2015 and U.S. application Ser. No. 14/943,645 filed on Nov. 18, 2015 and U.S. application number 14/944,953 filed on Dec. 14, 2015 and U.S. application Ser. No. 14/968,153 filed on Dec. 14, 2015 which is pending claims the benefit of Ser. No. 12/292,153 filed on Nov. 12, 2008.

(2) The current invention is continuously filing (#XX-2) U.S. application number 15/170,071 filed on Jun. 1, 2016 which is Continuously filing of (#XX-1) U.S. application Ser. No. 14/844,314 filed on Sep. 2, 2015 which is continue of (#XX-2010) U.S. application Ser. No. 12/938,564 filed on Nov. 3, 2010 and now is U.S. Pat. No. 9,239,513.

(3) This filing is Division filing of (#ZZZ-4) for different LED or-and laser device under the U.S. application Ser. No. 15/296,599 filed date on Oct. 18, 2016 LED or-and laser light device has more than one optics-element to create image or lighted patterns to the big range or wider areas U.S. application is PENDING filed on Oct. 15, 2016 which is continue filing of LED or-and Laser Bulb (#ZZZ-3) U.S. application Ser. No. 14/503,647 filed on Oct. 1, 2014 which is Division filing of (#ZZZ-2) U.S. application Ser. No. 14/451,822 filed on Aug. 5, 2014, which is Continue In Part filing of (#ZZZ-1) U.S. application Ser. No. 14/323,318 filed on Aug. 5, 2014 which is Continue In Pat filing of (#ZZZ-13) U.S. application Ser. No. 14/023,889 filed on Nov. 11, 2013. Related to apply the reflective or refractive optics lens or optics element to create the wider area image or lighted patterns for (LED or-and Laser) light device powered by conductive parts including prong, USB-wires or for (LED or-and Laser) Bulb base for with or without motor/spin/rotating kits for moving image.

(4) This filing is continuously fling for LED or-and Laser Bulb (#QQQ-4) U.S. application Ser. No. ______ filed on ______ 2016 which is the Continue filing for (#QQQ-5) U.S. application Ser. No. 15/341,782 filed on Nov. 2, 2016 which is the Continue filing for (#QQQ-3) U.S. application Ser. No. 14/983,993 filed on Dec. 30, 2015 which is the Continue filing for (#QQQ-2) U.S. application Ser. No. 14/289,968 filed on May 29, 2014 allowance on Oct. 5, 2016, which is Division filing of (#QQQ-1) of U.S. application Ser. No. 14/280,865, filed on May 19, 2014 and is Continuously of (#QQQ-12) U.S. Ser. No. 13/540,728 LED Bulb now is allowanced and issue fee paid before May 19, 2014 Now is U.S. Pat. No. 8,834,009. Related for LED bulb has project or-and night light.

(5) This filing is Division filing of (#MMM-2) U.S. application Ser. No. ______ filed on ______ 2016 which is the Continue filing for (#MMM-1) U.S. application Ser. No. 14/606,242 filed on Jan. 27, 2015 now is allowed on Sep. 25, 2016 which is Continue in Part of (#MMM-11) U.S. application Ser. No. 13/367,758 filed on Feb. 7, 2012, Now is U.S. Pat. No. 8,967,831 related for the LED Bulb has extendable/retractable design to overcome block-items that may interfering the camera, electric signal delivery; and also (LED or-and laser) bulb has the USB ports and Rechargeable batteries and rechargeable circuit to be charged or supply current to other device so including USB Charger, Power bank, (LED or-and Laser) light device's functions has at least 3 functions in one unit.

(6) This filing is Division filing of (#JJJ-1) U.S. application Ser. No. 14/049,427 now is U.S. Pat. No. 9,010,986 Apr. 21, 2015 issued, which is continue filing of (#JJJ-11) U.S. application Ser. No. 13/296,508 Filed on Nov. 15, 2011. Now is U.S. Pat. No. 8,562,158 issued on Oct. 22, 2013. Related the LED bulb has built-in Camera and storage-kits with multiple functions to replay, see by wired or wireless.

All had the LED and Lser drawing and details.

This filing is Continue Filing or Division filing of the following parent filing case:

| Application Number | Filing Date | U.S. Pat. No. |
|---|---|---|
| 12-938564(XX-10) | Nov. 3, 2010 | 9,239,513 |
| 14-844314(XX-1) | Sep. 3, 2015 | |
| 14-023899(ZZ-13) | Sep. 11, 2013 | |
| 14-503647(ZZ-3) | Oct. 1, 2014 | |
| 12-886832(TT-10) | Sep. 21, 2010 | |
| 14-280865(QQQ-1) | May 19, 2014 | |
| 12-624,621(II-09) | Nov. 24, 2009 | 8,303,150 |
| 13-534611(II-1) | Jan. 27, 2012 | 8,717,799 |
| 13-540689 (II-2) | Jul. 3, 2012 | 8,511,877 |

### DESCRIPTION

(1) This filing is continuously filing for (#DD-1) U.S. application Ser. No. 12/834,435 filed on Jul. 12, 2010 which is continuously filing for (#DD-2008) U.S. application Ser. No. 12/292,153 filed on Nov. 12, 2008 now is U.S. Pat. No. 7,871,192 which has Child continuity filed cases U.S. application Ser. No. 12/886,832 filed on Sep. 21, 2010 and U.S. application Ser. No. 12/886,435 filed Jul. 12, 2010 and U.S. application Ser. No. 14/622,628 filed on Feb. 13, 2015 and U.S. application Ser. No. 14/737,434 filed on Jun. 11, 2015 and U.S. application Ser. No. 14/943,645 filed on Nov. 18, 2015 and U.S. application Ser. No. 14/944,953 filed on Dec. 14, 2015 and U.S. application Ser. No. 14/968,153 filed on Dec. 14, 2015 which is pending claims the benefit of Ser. No. 12/292,153 filed on Nov. 12, 2008.

(2) The current invention is continuously filing (#XX-2) U.S. application Ser. No. 15/170,071 filed on Jun. 1, 2016 which is Continuously filing of (#XX-1) U.S. application Ser. No. 14/844,314 filed on Sep. 2, 2015 which is continue of (#XX-2010) U.S. application Ser. No. 12/938,564 filed on Nov. 3, 2010 and now is U.S. Pat. No. 9,239,513.

(3) This filing is Division filing of (#ZZZ-4) for different LED or-and laser device under the U.S. application Ser. No. 15/296,599 filed date on Oct. 18, 2016 LED or-and laser light device has more than one optics-element to create image or lighted patterns to the big range or wider areas U.S. application is PENDING filed on Oct. 15, 2016 which is continue filing of LED or-and Laser Bulb (#ZZZ-3) U.S. application Ser. No. 14/503,647 filed on Oct. 1, 2014 which is Division filing of (#ZZZ-2) U.S. application Ser. No. 14/451,822 filed on Aug. 5, 2014, which is Continue In Part filing of (#ZZZ-1) U.S. application Ser. No. 14/323,318 filed on Aug. 5, 2014 which is Continue In Pat filing of (#ZZZ-13) U.S. application Ser. No. 14/023,889 filed on Sep. 11, 2013. Related to apply the reflective or refractive optics lens or optics element to create the wider area image or lighted patterns for (LED or-and Laser) light device powered by conductive parts including prong, USB-wires or for (LED or-and Laser) Bulb base for with or without motor/spin/rotating kits for moving image.

(4) This filing is continuously fling for LED or-and Laser Bulb (#QQQ-4) U.S. application Ser. No. ______ filed on ______ 2016 which is the Continue filing for (#QQQ-5) U.S. application Ser. No. 15/341,782 filed on Nov. 2, 2016 which is the Continue filing for (#QQQ-3) U.S. application Ser. No. 14/983,993 filed on Dec. 30, 2015 which is the Continue filing for (#QQQ-2) U.S. application Ser. No. 14/289,968 filed on May 29, 2014 allowance on Oct. 5, 2016, which is Division filing of (#QQQ-1) of U.S. application Ser. No. 14/280,865, filed on May 19, 2014 and is Continuously of (#QQQ-12) U.S. Ser. No. 13/540,728 LED Bulb now is allowanced and issue fee paid before May 19, 2014 Now is U.S. Pat. No. 8,834,009. Related for LED bulb has project or-and night light.

(5) This filing is Division filing of (#MMM-2) U.S. application Ser. No. ______ filed on ______ 2016 which is the Continue filing for (#MMM-1) U.S. application Ser. No. 14/606,242 filed on Jan. 27, 2015 now is allowed on Sep. 25, 2016 which is Continue in Part of (#MMM-11) U.S. application Ser. No. 13/367,758 filed on Feb. 7, 2012, Now is U.S. Pat. No. 8,967,831 related for the LED Bulb has extendable/retractable design to overcome block-items that may interfering the camera, electric signal delivery; and also (LED or-and laser) bulb has the USB ports and Rechargeable batteries and rechargeable circuit to be charged or supply current to other device so including USB Charger, Power bank, (LED or-and Laser) light device's functions has at least 3 functions in one unit.

(6) This filing is Division filing of (#JJJ-1) U.S. application Ser. No. 14/049,427 now is U.S. Pat. No. 9,010,986 Apr. 21, 2015 issued, which is continue filing of (#JJJ-11) U.S. application Ser. No. 13/296,508 Filed on Nov. 15, 2011. Now is U.S. Pat. No. 8,562,158 issued on Oct. 22, 2013. Related the LED bulb has built-in Camera and storage-kits with multiple functions to replay, see by wired or wireless.

All had the LED and Laser drawing and details.

The current invention is Continuously or Division filing for co-pending filing case as below which NOT ONLY for parent filing for (LED or-and Laser) light source for Bulb, garden light applications but also has features to use (LED or-and Laser) Light source or bulb for all kind of lighting device which has more features for any desired combination selected from (1) Project light (2) More than one function (3) adjust focus (4) adjust angle (5) Elastic contact points or conductive spring (6) LED heat solution (7) Heat sensitive parts isolation or ventilation (8) extend or movable parts (9) has camera, storage device (10) USB ports, rechargeable batteries, rechargeable circuit for been charged or supply current to other device as all prior filed patents; and has more features including below:

Features (1) The (LED or-and laser) light source or bulb has all parent filing of (#MMM-2011) U.S. Pat. No. 8,967,831 columns (4) line 60 to column 6 line 8 for listed a to z total 26 parts & accessories to make any combination to make the (LED or-and laser) bulb has desired functions. The current invention emphasizes more details (LED or-and Laser) light source for bulb which has the co-pending filing case's features as (#MMM-2011) U.S. Pat. No. 8,967,831. The parts as listed including: (e) “energy storage means for DC energy such as rechargeable or regular batteries” plus (g) “circuit means for a variety of desired functions” and USB ports, so can make the current invention has built-in USB charger, USB power back function for said (LED or-and laser) bulb for desk top or any light device use.

(2) The current invention also introduced the said light device incorporated with co-pending (LED or-and laser) light source or bulb including the garden light. To use the co-inventor's all prior art or parent filed case's (LED or-and Laser) light source or bulb fit into all kind of lighting fixture housing to become a desired application at least including; the garden light, security light, motion sensor light, power fail light. This feature listed as the (#MMM-2011) U.S. Pat. No. 8,967,831 Clam 6 listed application but not limited because the above listed prior arts has much more applications as well. It is appreciated all above listed or discussed co-inventor co-pending or co-issued patent all the idea, concept, claims, specification, features, functions still fall within the current invention scope of claims for replaceable, equivalent, equal functions reason. These feature and application can apply to the all kind of light device including garden light as wish. It is appreciated all the above listed or co-pending or issued parent filed cases all detail description, drawing, figure, content, claims should be still fall within the current invention.

(2) the co-pending invention (#QQQ-5) U.S. application Ser. No. 15/341,782 filed on Nov. 2, 2016 for (LED or-and Laser) Bulb has built-in more than one of the bulb-base(s) that can be desired combinations for market available bulb base(s) into one (LED or-and Laser) bulb. The one of (LED or-and Laser) more than one bulb male base(s) can fit into more than one of different size of female Bulb-socket. This will reduce the (LED or-and Laser bulb) products at factory or at the shelves of market. The current market existing bulb has only one size or one specification of bulb-base to fit into only one bulb socket. For Examples, the (LED or-and Laser) bulb has E26 bulb-base which only can fit into E-26 bulb socket is for current market all (LED or-and Laser) bulb specification. The Current invention (LED or-and Laser) Bulb may have E26 (bigger) and E-17 (medium) or further has E12 (Small) diameter of the Bulb-base so can fit into at least 3 different (LED or-and Laser) Bulb-Socket receiving end including E26+ E17+ E12 . . . or other desired combination E26+E12 or E-26+ E17 or E26+ E17+ E12 . . . . The said (LED or-and Laser) bulb market available bulb base has different construction including but not limited for (1) Screw Bases (2) Twist & Lock Bases (3) Specialty Bases (4) Bi-Pin Bases, and current invention d not discuss the (5) Fluorescent Pin Base (6) Compact Fluorescent plug in Lamp Base.

For examples, the current invention discussed the most common (LED or-and Laser) bulb base is the screw bases has different diameter from E10 (mini screw), E11 (mini candelabra), E12(candelabra), E14(European), E17(intermediate), E26(Medium-standard), E27(Medium), E39(Mogul), E40(Mogul), EX39 (Extended Mogul).

Feature (3) the co-pending invention (#QQQ-5) U.S. application Ser. No. 15/341,782 filed on Nov. 2, 2016 and (#ZZZ-4) U.S. application Ser. No. 15/296,599 filed date on Oct. 18, 2016 both disclosure the (LED or-and laser) light device has more than one optics-element to create image or lighted patterns to the big range or wider areas. Both co-pending filing case disclosure more than one optics-elements and at least one is optics-lens which in the form of (1)180 degrees flat or (2) ½ ball, (3) ⅔ ball, (4) sphere, (5) dome shape for top cover of the said (LED or-and Laser) Bulb, garden light or light device. The said top cover piece is optics-les that has refractive or simple protective-piece optics properties to enlarge the image or lighted patterns to wider range or big area to viewer. The (LED or-and Laser) bulb, garden light or other light applications has optic-lens property top-cover that need a wider opening lens. The top cover can be one of shape including; (1) around 180 of degree flat optics-lens or simple protective-piece, or (2) ½ ball, or (3) ⅔ ball, or (4) sphere, or (5) dome shapes lens. Those having refractive or laser-film; or grating-film optic-lens properties which let inner (LED or-and Laser) light source very narrow viewing angle Light beam to spread out through the Top Cover or laser-film or grating-film Optics-lens. For (LED or-and Laser) bulb or garden light or other lighting fixture the top cover can be a flat piece and has no extra optics or has laser treated lens/film/grating/hologram. If no treatment or optics properties, the top cover or flat piece will be only plain flat transparent piece for protection purpose only because all Laser treated piece or optics lens or other elements already put inside of unit.

Also, the co-pending filing (#ZZZ-4) to cover all (LED or-and laser) light device under the U.S. application Ser. No. 15/296,599 filed date on Oct. 18, 2016 (LED or-and laser) light device has more than one optics-element to create image or lighted patterns to the big range or wider areas. The (#ZZZ-4) Ser. No. 15,296,599 is PENDING filed on Oct. 18, 2016 which is continue filing of (LED or-and Laser) Bulb (#ZZZ-3) U.S. application Ser. No. 14/503,647 filed on Oct. 1, 2014. Both has details construction and preferred design and drawing (1014-10-01 drawing) for same optics application on FIG. 1, FIG. 1A, FIG. 1-1, FIG. 1-2, FIG. 1-3, FIG. 1-4, FIG. 1-5, FIG. 2, FIG. 2A, FIG. 2-6, FIG. 3-2 shown for all details and features for more than one optics-elements can create more special and complicated lighted patterns or-and image.

Features (4) has built-in or add-on flexible bendable arms to change position, or direction or orientation of (LED or-and Laser) light beam by variety choice of moveable parts as co-pending filing (#QQQ-5) Ser. No. 15/341,782 Page 4/15 drawing FIG. 09-B1 to 09-B7 and page 12/15 drawing (#FIG. 3D, FIG. 3E, FIG. 3F). All these daring show the add-on snake hose which one end is bulb-socket and the other end is bulb-base. The male bulb-base insert into existing bulb-socket. From FIG. 3E disclosure the (LED or-and laser) bulb has a built-in bendable device and incorporated with the snake-house. The one end is part of bulb and other end has the mail bulb-base. The bendable arms can adjust the said bulb to any direction or-and orientation or-and height to overcome all block-object including glass shade, depth location of bulb-socket of market all recess lighting, block-object which interfere the electric signal such as Wi-Fi or remote control (IR) or wireless controller.

From co-pending drawing (#QQQ-5) U.S. application Ser. No. 15/341,782 filed on Nov. 2, 2016 FIG. 3F for preferred the LED bulb has more than one levels and top level has 1^{st} function and lower level has 2^{nd} functions as just allowed (#QQQ-2) U.S. application Ser. No. 14/289,968 filed on May 29, 2014 now is allowed on Oct. 5, 2017 for 19 claims. It is appreciated all above listed or discussed co-inventor co-pending or co-issued patent all the idea, concept, claims, specification, features, functions still fall within the current invention scope of claims for replaceable, equivalent, equal functions reason. These feature and application also can apply to the garden light so can change position as wish and no need to dig out the garden light to move to other locations.

Feature (5) The (LED or-and laser) bulb for all kind of lighting fixture offer near-by and far-away areas illumination, image, lighted patterns, or any combination with all market available light effects or digital data display images. The current invention for (LED or-and Laser) bulb is a Child filing and is Continuously filing of (#QQQ-5) U.S. application Ser. No. 15/341,782 filed on Nov. 2, 2016. The (#QQQ-5) which is the Continue filing for (#QQQ-3) U.S. application Ser. No. 14/983,993 filed on Dec. 30, 2015. The (#QQQ-3) is the Continue filing for (#QQQ-2) U.S. application Ser. No. 14/289,968 filed on May 29, 2014 now allowed on Oct. 5, 2017. (#QQQ-2) is Division filing of (#QQQ-1) of U.S. application Ser. No. 14/280,865, filed on May 19, 2014 and is Continue of (#QQQ-12) U.S. Ser. No. 13/540,728 LED Bulb now is allowanced and issue fee paid before May 19, 2014 Now is U.S. Pat. No. 8,834,009. Related for LED or-and Laser Bulb has project or-and night light. While the same construction of (#QQQ-3) put into the garden light housing become the LED or-and laser garden light with the moving effects project or-and illumination light. It is simple to just make one of the top plurality of convex-lens has no image forming kits, it will just change from projection image light become offer illumination with pre-determined light brightness and kelvin temperature (LED color).

The (LED or-and Laser) light source or bulb for all Light device including Bulb, garden light or other lights applications which has more than one optics-elements and at least one is optic-lens. The said optic-lens is one of choice including; (1) around 180 big opening for Flat optic-lens which has multiple or plurality of tiny piece of optics-lens and each of tiny piece has different thickness and size to form a single piece of around 180 of degree flat lens and with different [IC1]optics properties. The said 180-degree flat lens may have refractive or just a protected plastic piece to protect inside laser film or grating film which has desired optics-properties so can let all inner (LED or-and laser) light beam to spread out to wider areas or big size on desired surface. The said (LED or-and Laser) light source may incorporate with following preferred parts and accessories to get more splendid light effects, including but not limited;

(AA) multiple or plurality of tiny reflective piece arranged on the one disc or dish-like inner surface to spread out single (LED or-and laser) light beam to plurality of light beam

(BB) has added more or No.3 or more optics-element including transparent solid-plastic unit has shape like nuts or core or geometric shape unit with desired surface treated or optics-design to become has multiple small piece has refractive properties so can spread narrow light beam to many light beam

(CC) has motor or movement device to make the optic-lens or image/pattern forming-unit to rotating. This will create moving image or lighted patterns. It also has plurality of light beam for splendid moving, colorful, color changing or other market light effects. The effects including moving Water wave, moving Aurora effects all be some samples but not limited such as the Disco ball has multiple lighted patterns shown surface also use more than one reflective or-and refractive tiny lens in one main top cover so need 2 pcs separated 2-piece optics-lens.

These features shown on the co-pending filing (#ZZZ-3) U.S. application Ser. No. 14/503,647 filed on Oct. 1, 2014 has details construction and preferred design. It also has the co-pending drawing (1014-10-01 drawing) for same optics application on FIG. 1, FIG. 1A, FIG. 1-1, FIG. 1-2, FIG. 1-3, FIG. 1-4, FIG. 1-5, FIG. 2, FIG. 2A, FIG. 2-6, FIG. 3-2 shown for all details and features for more than one optics-elements can create more special and complicated lighted patterns or-and image.

Feature (6) has more than one light beam emit out from (LED or-and Laser) light source for bulb, garden light which under control by the pre-determined controller or IC or circuitry. To incorporate with IC and more than one color LEDs or plurality of different color (LED or-and laser) light source under IC and circuit arrangement can get the more than one light beam emit out from the said (LED or-and Laser) light source for bulb, garden light. The more than one light beam emit out from (LED or-and laser) light source for bulb, garden light is same as Co-pending or co-issued filing case and current invention FIG. 3F which has 2 level or more for Bulb and top has at least one function for project image or lighted pattern or illumination functions. The lower portion can offer color changing light beam or multiple different kelvin temperature white light for illumination. It is appreciated to refer to Co-pending or issued (#QQQ-2) and (#QQQ-1) to get most detail construction, details. From U.S. application Ser. No. 14/983,993 filed on Dec. 30, 2015 which is continue filing for (#QQQ-2) U.S. application Ser. No. 14/289,968 filed on May 29, 2014 now is allowed on Oct. 5, 2017. That is Division filing of (#QQQ-1) of U.S. application Ser. No. 14/280,865, filed on May 19, 2014, and is Continue of (#QQQ-12) U.S. Ser. No. 13/540,728 LED Bulb now is allowanced and issue fee paid before May 19, 2014 Now is U.S. Pat. No. 8,834,009. These co-inventor co-pending filing related for (LED or-and Laser) light source for Bulb has project or-and illumination light or night light. Furthermore, the current invention disclosure changes the more than one of light performance can use (1) IR or RF remote controller to make change, or (2) use the pre-program IC circuitry to change the function 1 to function (N) by shut-down the power source and turn-on the power source. By control the power source on or off to make the said (LED or-and laser) light source to change function of (LED or-and Laser) product is very simple and cost saving while the said (LED or-and laser) products has more than one color, function, light source. This use power on-off design will become much cheaper than use IR/RF remote controller which had transmitter and receiver(s) extra cost.

Feature (7) The current invention has more than one function to emit light beam. The said functions may in any combination selected from USB Charger; USB Power bank; USB powered products; color/brightness/functions/light source(es) changing light products; flashlight; touch light; or power failure products. The said light has controller selected from remote control; Infra-red controller; blue-tooth; wifi; internet; App software; motion sensor; inductive switch; switch; and wireless with multiple-way communication to trigger at least one of the light beam to offer illumination for variety market available function or-and image or-and lighted patterns effects.

Features (8) The current invention has movable or extendable or retractable-parts to allow at least one level of (LED or-and Laser) light source for bulb, garden light or all light device can move the desire level(s) away from original position, location, orientation to overcome all the interfere block-objects. The movable device can overcome following trouble;

(a) heat issue from (LED(s) or-and Laser) light source(s) or circuit or electric components

(b) lamp shade metal frame's block out the (LED or-and Laser) bulb light beam traveling

(c) glass or metal or cement block means to block out the electric signals transmit or wireless electric signals delivery including but not limited including Bluetooth, wifi, internet, App software or any other electric wave or signals transmitting to control the said (LED or-and Laser) light source for bub, garden light, light device and its related electric parts or accessories.

Hereafter disclosure all below listed co-pending and patented as prior arts still fall within the current invention as below:

U.S. Ser. No. 13/367,758, U.S. Ser. No. 13/367,687, U.S. Ser. No. 13/296,508, U.S. Ser. No. 13/295,301, U.S. Ser. No. 13/021,107, U.S. Ser. No. 12/950,017, U.S. Ser. No. 12/938,564, U.S. Ser. No. 12/886,832, U.S. Ser. No. 12/876,507, U.S. Ser. No. 12/771,003, U.S. Ser. No. 13/021,124, U.S. Ser. No. 12/624,621, U.S. Ser. No. 12/622,000, U.S. Ser. No. 12/318,470, U.S. Ser. No. 12/914,584, U.S. Ser. No. 12/834,435, U.S. Ser. No. 12/292,153. U.S. Ser. No. 12/907,443, U.S. Ser. No. 12/232,505, U.S. Ser. No. 11/806,711, U.S. Ser. No. 11/806,285.

The current invention is Continue filing for Ser. No. 13/295,301 “The Device has build-in Digital Data means and Powered by unlimited power source of light device”.

The current invention is Continue filing for Ser. No. 13/296,508 “The Device has built-in Digital Data means and power unlimited power source of LED Bulb”

The current invention is continuously filing for Ser. No. 13/296,460 “The device has built-in Digital data means and powered by unlimited power source of Lamp Holder.

These (3) co-pending filing are Continuously filing of Ser. No. 12/951,501 “Lamp Holder has build-in LED Night light”

The current invention incorporated with above listed co-pending or patented cases' features, construction still fall within the current inventions scope and all related equivalent function or replace parts also should fall within the current invention. So the same construction of the co-inventor's prior arts, parent filing case, issued patents for the project assembly including all same concept, equal function, alternative skill, replacement method should be considering still fall within the current invention claims scope and range and coverage.

### BACKGROUND

From co-pending (#ZZZ-4) U.S. application Ser. No. 15/296,599 filed date on Oct. 18, 2016 (LED or-and laser) light device which is continuously filing of (#ZZZ-3) U.S. application Ser. No. 14/503,647 filed on Oct. 1, 2014. The co-pending filing (#QQQ-3) U.S. application Ser. No. 14/983,993 filed on Dec. 30, 2015, both show the drawing and brief drawing and details description. Both show the (LED or-and laser) light source for bulb or light is fit within the housing with at least one of the optics elements (non-optics lens) or-and optics lens. This arrangement can get desired (1) reflective or refraction by optics lens(es), or (2) shaped the light beam by stencil/opening/window/printed film, or (3) presentation the full color images, moving image, color changing light by slide/film/photos/LCD displayer/image forming kits/internet/APP/Wi-Fi/Wireless network/Wireless incorporated with image medium or interface kits. So the current invention continuously to develop the big improvement to make the co-pending filing and current filing of (LED or-and Laser) Bulb has more universal features to created desired functions as below:

The current invention is continuously filing (#XX-2) is related to (LED or-and Laser) bulb, garden light, light string, night light under U.S. application number 15/170,071 filed on Jun. 1, 2016 which is continuously filing of (#XX-1) U.S. application Ser. No. 14/844,314 filed on Sep. 2, 2015 which is continue of (#XX-2010) U.S. application Ser. No. 12/938,564 filed on Nov. 3, 2010 and now is U.S. Pat. No. 9,239,513

The current invention has fatal big improvement from marketing all (LED or-and Laser) Bulb to make them for Universal type to fit into more than one of bulb-socket female receiving end. From above discussed Features (A) the current invention main purpose to has built-in more than one of the bulb-base(s) for desired combinations for market available bulb base(s) into one (LED or-and Laser) bulb so the one (LED or-and Laser) bulb can fit into more than one of different size of Bulb-socket. This will reduce the (LED or-and Laser) bulb which only has one size or one specification of bulb-base to fit into only one bulb socket. For Examples, the (LED or-and Laser) bulb has E26 bulb-base which only can fit into E-26 bulb socket is for current market all LED bulb specification. The Current invention (LED or-and Laser) Bulb may have E26 (bigger) and E-17 (medium) or further has E12 (Small) diameter of the Bulb-base so can fit into at least 3 different (LED or-and Laser) Bulb-Socket receiving end including E26+ E17+ E12 . . . or other desired combination E26+E12 or E-26+ E17 or E26+ E17+ E12 . . . . The said (LED or-and Laser) bulb market available bulb base has different construction including but not limited for (1) Screw Bases (2) Twist & Lock Bases (3) Specialty Bases (4) Bi-Pin Bases, and current invention d not discuss the (5) Fluorescent Pin Base (6) Compact Fluorescent plug in Lamp Base.

For examples, the current invention discussed the most common (LED or-and Laser) bulb base is the screw bases has different diameter from E10 (mini screw), E11(mini candelabra), E12(candelabra), E14(European), E17(intermediate), E26(Medium-standard), E27(Medium), E39(Mogul), E40(Mogul), EX39 (Extended Module).

The current invention not only had the above listed features but also has co-pending filing case for (LED or-and Laser) light source for bulb, garden light, light device. The bulb has at least one level and its movable design can make (1) at least one level of the said (LED or-and Laser) Bulb to move; or-and (2) whole (LED or-and Laser) bulb adjust by the build-in or add-on bendable arms; or-and (3) the bendable device has one male base, or has bulb base male base & female socket. Incorporating with flexible bendable device to change the position, location, orientation away from original position while need to make desire locations has the pre-determined light functions, performance, effect.

The light device has at least one of the level or parts or accessories incorporate with movable-device. The movable device overcome block object by one of arrangement including;

(1) moving the at least one of level (including parts or accessories); or-and (2) moving the whole (LED or-and Laser) bulb by the build-in or add-on bendable flexible device away from original position, location, orientation, so can overcome some block-object(s) which affect or interfere the LED or-and Laser blub desire functions.

Such as the current invention's more than one level(s) (LED or-and Laser) light source for bulb, garden light, light device. The top part is a project light functions but while it installs on all desk lamp, floor lamp, down light, indoor lighting or outdoor lighting will have lamp shade problem because some of lamp shade has metal frame and ring on the center line of the LED or-and Laser bulb's and lamp socket. So if the LED or-and Laser bulb has no movable design to move the level(s) or-and flexible snake-house, the top part project light's image or lighted patterns will be block out by the lamp shade's metal frame and metal rings to destroy the project image or any lighted patterns performance. The current invention solved this issue and let the top part of the (LED or-and Laser) parts can move or extend or retracted so make project light or-and lighted patterns can move away from the said lamp shade's metal frame and metal ring. This arrangement can let the (LED or-and Laser) light beam pass though no block-objects-area and create the image/message/time/lighted patterns/digital data/digital image/LCD display image/arts on the desired ceiling or-and walls or-and floor surface. If use traditional (LED or-and Laser) Bulb, the lamp shade block-objects will totally destroy the (LED or-and Laser) project light performance including not limited full color image or color changing lighted patterns or light beam.

The current invention also can solve the heat issues of all market available (LED or-and Laser) Bulb. The simple solution is put some heat-created electric parts, accessories, components all located on the base of (LED or-and Laser) bulb. It also can simple to select movable device from (1) spin, rotate, hinge, arms, joint piece, join pieces, extendable, extractable; or (2) including one of built-in or added-on flexible bendable device has at least one of male bulb-base or both male bulb-base & female bulb receiving socket, or the other market available adjustable kits, parts, set to make the heat source away from the other part.

One of preferred embodiment the said more than one level(s) (LED or-and Laser) Bulb solve the block-object by following arrangement;

(1) Same as parent filing→all electric parts may put on Top part ,so all heat will flow to the base areas when installation as down light; or (2) Same as current invention some preferred embodiment drawings to show→all the electric parts put on the base part and move the top parts away from heat upper area so the heat will not affect to the other parts. The both solution has use the movable-design from extractable, extend, movable parts or accessories, rotate, pole, hinge, arm, bar, snake-house or whatever the movable or adjustable design can move the parts or-and whole LED or-and Laser Bulb to other location so can easily to overcome the heat issues.

The current invention LED or-and Laser bulb also good for LED or-and Laser Bulb for upper or down installation because has the movable-design including extractable, extendable which can overcome the down light application because some down light (LED or-and Laser Bulb base face sky) has lamp shade (like entrance door lighting) which made of glass , metal , cement, concrete surrounding the said Down light or recess light installation so these electric-signal block-objects will affect , interfere the electric signal transmitting so let Bluetooth control, Wi-Fi, remote control, infra-red control, internet control, App software control loose or reduce or limited the signal transmitting to let these functions become a problem. So the current invention has all proper movable-design help to overcome these electric signal block objects and make the LED or-and Laser bulb has its designed and pre-determined functions without any affect or interfere or limited by the said electric-signal block-means.

The current invention has more than one level(s) (including parts and accessories) LED or-and Laser bulb which each level can has its own functions or multiple functions control by market available skill or method may selected from Blue-tooth, Wi-Fi, internet, App software, IC, Remote signal, infra-red signal, motion sensor, heat sensor though computer, communication, consumer device by people. Such as the more than one levels LED or-and Laser Bulb has (1) Multiple colors with changeable colors and moving effects (2) Multiple functions select from market available any LED or-and Laser light effects for indoor and outdoor lighting (3) Multiple control which select from market available control, sensor, switch, blue-tooth, wife, internet, app software, remote, infra-red or other electric or electronic related circuit or device(s) (4) More than one movable designs (5) Changeable geometric shape (6) Changeable construction (7) moveable designs select from any group combination from bar, pole, spin, rotate, hinge, arms, joints, join, frame, connector, sections or-and move the whole LED or-and Laser bulb by the build-in or add-on bendable flexible snake-house to make the levels, whole LED or-and Laser Bulb, parts, accessories to be move away to desire location, positions. These are the 2^{nd} of main features of the current invention.

The current invention mainly for LED or-and Laser bulb, garden light which has following other features as parent filing case stated as below:

1. The current invention which the said LED or-and Laser Bulb, garden light has property that the LED or-and Laser bulb can have more twist degree or twist angle after LED or-and Laser Bulb's contact-Point touched electrodes, This features can get horizon more than 360 of degree to let the light beam to position the certain area(s) to get more wider of adjust angle and more wider of adjust directions and it also can incorporated with adjustable Focus means to make the same of LED or-and Laser light beams or image to shown different light performance on the desired locations or area(s). The Rotatable LED or-and Laser Ball with two arms to offer the said LED or-and Laser Bulb of preferable Geometric shape and construction, can adjust angle in vertical axis up to more than 360 of degree angle so can get the LED or-and Laser Bulb's plurality of light beams can cover all x-y-z axis areas by at least one of light beam or plurality of the light beam to illuminate the near-by or far-away or remote-away or any combination of the said LED or-and Laser Bulb. (Lamp holder co-pending).

2. The current invention which the said LED or-and Laser Bulb, garden light has One or more than one of the light beams arrange in LED or-and Laser bulb, garden light for desire light performance. As co-pending filing content which has more than one LED or-and Laser light source(s) are for Night light, or more than on project assembly for project LED or-and Laser lighting. The current invention can create same light performance as the co-pending or patented applications as attached drawings for LED or-and Laser bulb, garden light just change the power source input current from 2 prongs to the bulb-base 2 pole so can simple to get same functions or equivalent or replaceable from prong to bulb-base, the difference than prior-arts with night light because Night light has prongs-and for outlets installation and not have extend/retractable kits. The said LED or-and Laser bulb has bulb-base to get the power from outside power source.

3. The current invention which the said LED or-and Laser Bulb, garden light has Focus adjustable kits so can make same light beam emit out from same LED or-and Laser bulb, garden light to wherever surface(s) with desired light performance with brightness, size, light spots, color, lit-areas. The same light beam output from same LED or-and Laser Bulb, garden light with focus adjustable kits can create the different light pattern, light path, light brightness or color, light performance, light direction, light performance by viewer.

4. The current invention which the said LED or-and Laser Bulb, garden light has extendable kits such as extend tube, telescope tube, extended housing parts or move the multiple layers of bulb or equivalent extendable, receivable kits which can make the electric parts & accessories etc. of LED or-and Laser bulb, garden light keeps away from LED(s) or-and Laser's heat, block-means of lighting's curtain, lighting's shade, lighting's glass, cylinder tube of recess lighting, or other block-objects-which block the motion-sensor Fresnel lens & detector, remote control signal, or light beam emit direction. To keep the said LED or-and Laser bulb, garden light's related circuit board/control kits/IC/switch/sensor/electric parts or assembly—Away from the LED or-and Laser-units or block-objects to prevent from heat affect the desire functions, performance, such as Motion sensor or PIR sensor head or Fresnel lens or LED or-and Laser-unit light beam emit direction.

5. The current invention which the said LED or-and Laser Bulb, garden light has Extractable/extendable/movable kits to put heat sensitive or light sensitive parts or housing parts away from LED or-and Laser s’ heat, light's shade, light's curtain, light's glass, decorative material, ceiling block means, or any other block-objects which will interfere the LED or-and Laser bulb, garden light, or LED or-and Laser Bulb's related parts & accessories. The said extendable or extractable kits preferred to design on front of the LED or-and Laser bulb, but it depend on the different requirement and different consideration of heat, block-objects which offer the more space to install the preferred electric parts & accessories, offer the extra length to far-away from heat means or block-objects so the LED or-and Laser bulb, garden light can overcome heat and block-objects for any applications, installation.

6. The current invention is different from all market available LED or-and Laser Bulb which offer The illumination only cover the adjacent area which are start from the LED or-and Laser Bulb to certain distance (illumination surrounding LED or-and Laser Bulb or start from LED or-and Laser bulb to certain distance with illumination) and do not offer the desired areas or wider viewing angle or cover big areas away from the LED or-and Laser bulb, garden light illumination or-and image or-and lighted patterns to an area(s) which has certain direction(s), angle(s), distance(s) which far away or remote-away from the LED or-and Laser Bulb, garden light. The current invention can make any combination to offer the near-by areas illumination, far-away areas illumination or together for both illumination or-and image or-and lighted patterns effects. The market Laser Bulb only can offer the said laser beam from laser light source but it too harmful for people eyes, so the co-pending filing is continuously filing (#XX-2) is related to LED or-and Laser bulb, garden light, light string, night light under the U.S. application Ser. No. 15/170,071 filed on Jun. 1, 2016 which is continuously filing of (#XX-1) U.S. application Ser. No. 14/844,314 filed on Sep. 2, 2015 which is continue of (#XX-2010) U.S. application Ser. No. 12/938,564 filed on Nov. 3, 2010 and now is U.S. Pat. No. 9,239,513 which has the motion sensor protection device to shut-down the Laser light beams while people come close to the safety distance, Also, the laser light incorporated the grating film, piece, sheet to make the strong Laser beam been split into multiple light beams so become harmless to people eyes. For some cost concern, the bulb for some applications can save the motion sensor safety device.

7. The current invention which the said LED or-and Laser Bulb, garden light has more than one light beams output to different area(s), direction(s), location(s) and make more than one years with illuminations which all these areas may not adjacent, link, sit together. The said LED or-and Laser bulb, garden light may offer more than one area(s) have illumination is other features of current other features which can allow people to make the energy saving and only offer illumination for where needed such as Stair lighting which only Up or Down two direction need illumination to see stairs. (Please refer to co-inventor's U.S. application Ser. No. 12/771,003, Filed on Apr. 30, 2010, Now is U.S. Pat. No. 8,408,736 Apr. 2, 2013 issued) Rest areas no need the light at all and the said stair-lighting has Built in Motion Sensor has sensitivity up to 10-30 feet is enough to cover one floor stairs (Normally is 18 steps). One light beam for LED or-and Laser bulb to emit up 9 steps and one light beam of same LED or-and Laser bulb to emit down 9 steps. This will be enough illumination because each UP or DOWN stair is illuminated by each Floor's one LED or-and Laser Bulb, so 2 different of light beam(s) to offer same one UP or One Down 9 steps. This is pretty good power saving device while motion sensor device build-in more than one of light beam as output from one LED or-and Laser bulb.

8. The current invention also teach the co-pending filing (#ZZZ-4) U.S. application Ser. No. 15/296,599 filed date on Oct. 18, 2016 LED or-and laser light device and the said device including for bulb, or plug-in night light, or USB LED or-and laser light. These applications all use the same more than on of optics-elements and the top cover is a half-ball, ⅔ ball, sphere, dome or approximately 180 degree flat optics-lens which has at least one of refractive lens properties. All these application only need to connect the (+)(−) input current to connect to bulb-base or plug-in night light or USB light's relative electric poles with preferred working voltage so can have same construction for the optics-elements and LED or-and laser light source change from Bulb to Plug-in or USB light ,or change from Plug-in light to the bulb or USB light, or change from USB light to Bulb or plug-in light as (#ZZZ-4) U.S. application Ser. No. 15/296,599 filed date on Oct. 18, 2016 details drawing and descriptions.

9. The current invention also teach the co-pending and (JJ-3) and (#JJJ-1) U.S. application Ser. No. 14/049,427 now is U.S. Pat. No. 9,010,986 Apr. 21, 2015 issued, which is continue filing of (#JJJ-11) U.S. application Ser. No. 13/296,508 Filed on Nov. 15, 2011. Now is U.S. Pat. No. 8,562,158 issued on Oct. 22, 2013. Related the LED bulb has built-in Camera and storage-kits with multiple functions to replay, see by wired or wireless.

Hence, the current invention can has at least one or plurality of light beam output from one LED or-and Laser bulb, garden light to near-by area(s), remote-away area(s), far-away area(s) or any combination of these area(s) with adjust angle, adjust focus, elastic contact-point, rotate/spin/tilt frame or support or base to get desire direction to emit light beam, extend/retractable means to install all parts & accessories away from heat or block-means are all belong to current invention features so can let all light beam to emit to area(s) where need the illumination, Not like conventional LED or-and Laser bulb, garden light only can supply the near-by area(s) which start from the LED or-and Laser-bulb to certain limited distance areas (LED or-and Laser bulb has limited brightness to emit to long distance except like current invention to apply optics lens or lens assembly to project light beams to remote-away or far-away distance which current market items cannot create.) So the same construction of the co-inventor's prior arts, parent filing case, issued patents for the project assembly including all same concept, equal function, alternative skill, replacement method should be still fall within the current invention claims scope and range and coverage.

### DRAWINGS

FIGS. 1A to 1E are preferred 1^{st} embodiment which has (LED or-and Laser) light source or bulb for other lighting fixture to offer the projection or-and illumination or-and USB charger or-and USB power back functions.

FIG. 2 is the 2^{nd} preferred (LED or-and Laser) bulb to fit into any lighting fixture housing which has built-in (LED or-and laser) bulb female socket to receive the male (LED or-and laser) bulb's bulb-base to get power from power source for multiple functions from one piece of (LED or-and Laser) bulb which may have projection, white color illumination, colorful image, colorful lighted patterns, USB charger, USB power back, power fail light function from said bulb.

FIGS. 3A to 3D is the other preferred (LED or-and Laser) light source or bulb for different lighting fixture housing for different application which including the Garden light, desk lamp, outdoor lighting, camping light, anywhere light which has built-in different assembly of projection light ;or-and white light illumination; or-and colorful projection; or-and colorful lighted patterns; or-and USB charger; or-and USB power bank; or-and power fail light functions or other market available function with switch , sensor, remote controller, wireless controller to turn-on and turn-off the said (LED or-and laser) light source.

FIG. 4 is the co-pending filing case which has Laser light source inside the said garden light.

Below drawing are co-pending filing case (#XXX-2) 8 page

FIG. 5 is an isometric view of a first preferred embodiment of the invention. that provides additional protection.

FIGS. 6A to 6D show details of the preferred embodiment of FIG. 5.

FIG. 6E shows laser light beam performance with respect to walls and ceiling, and protection range of the sensor means.

FIGS. 7A TO 7F show a second preferred embodiment with different a shape of the laser projection light and both a laser and an LED light source in one unit.

FIG. 8 show 2^{nd} embodiment to apply laser-light for the Garden light which has the laser light source and at least one of optics-piece to create a plurality of laser beam has lighted light beams, lighted shapes, lighted matrix, lighted array, lighted image shown on the wider area for preferred distance.

FIGS. 9A and 9B show 3rd embodiment to apply laser light for the all kind of conventional light-string which has some other light source for illumination and some are laser light source has at least one of optics-piece to create a plurality of laser beam has lighted light beams, lighted shapes, lighted matrix, lighted array, lighted image shown on the wider area for preferred distance so the conventional all kind of light string become not only supply illumination but also has laser light effects or-and LED project light effects.

FIGS. 10A to 10G and FIGS. 10H to 10N shows the features and concept and how to get desired laser light effects and relation with the laser optic-piece or-and optic-piece so can created desired light effects not only for Laser project light but also discuss comparison and cooperation with LED project light.

Below drawing are co-pending filing case (#QQQ-5) 14 page

FIG. 11A shows the current commonly screw bases which used for bulb bases worldwide.

FIGS. 11B to 11G shows the exemplary of six different bulb bases connected to each of the multiple bulb bases (hereafter as combo bases) that are not of the same combination and each of the bulb base's size as the exemplary using this specific design of current invention. The figures show the details of measurements of each of these individual bulb bases and the gap existing while overlap each bigger one to small one, however, the measurements are not limited to this documents but the compatibility of the said combo-bases. The combo-bases are not limited to the combination shown in drawing this document but also the compatibility of the said adapter invention.

FIGS. 12-14 shows a way of conducting electricity throughout the said combo-bases. The usage of proper diameter conductive or elastic springs fit within the gap between the bigger and small diameter bases to deliver the current from lower position small base to all top bigger bases so the said combo-bases will carry electricity from the lower position's N-pole (the said of the “end” of a bulb base”) towards to the top location other base's N-pole. These springs, connecting between the whole combination, on all wall of each said bulb bases N-pole wall, will act as a conduit for electricity to pass while being able to be an assistant for the said stretch and shrink ability. The L-pole delivers current by center electric isolation channel with electric conductive springs fit within from the said biggest size, bulb base to the smallest size, bulb base. Noted that the combination of FIG. 12 and FIGS. 13 and 14 shown in these three figures will not limit the future said combo-bases to the number of total bulb bases, these figures are only for demonstration purposes of this said combo-bases.

FIG. 15 shows different bulb base (L-pole) insert into to connecting to the bulb female receiving socket of their size, connecting electricity to the said (L-pole) between lowest one towards to the highest one and current can go through the whole bulb.

FIG. 16 is an initiative imagery of the said combo-bases, showing the invention to be connected to three bulb bases, and while in the shrunk mode.

FIG. 18 shows the said combo-bases to have one spring in the middle of electric isolated tube to provide the ability to stretch/extend and shrink/retract and the power to connect electricity throughout the each of bulb bases along the whole combo-bases.

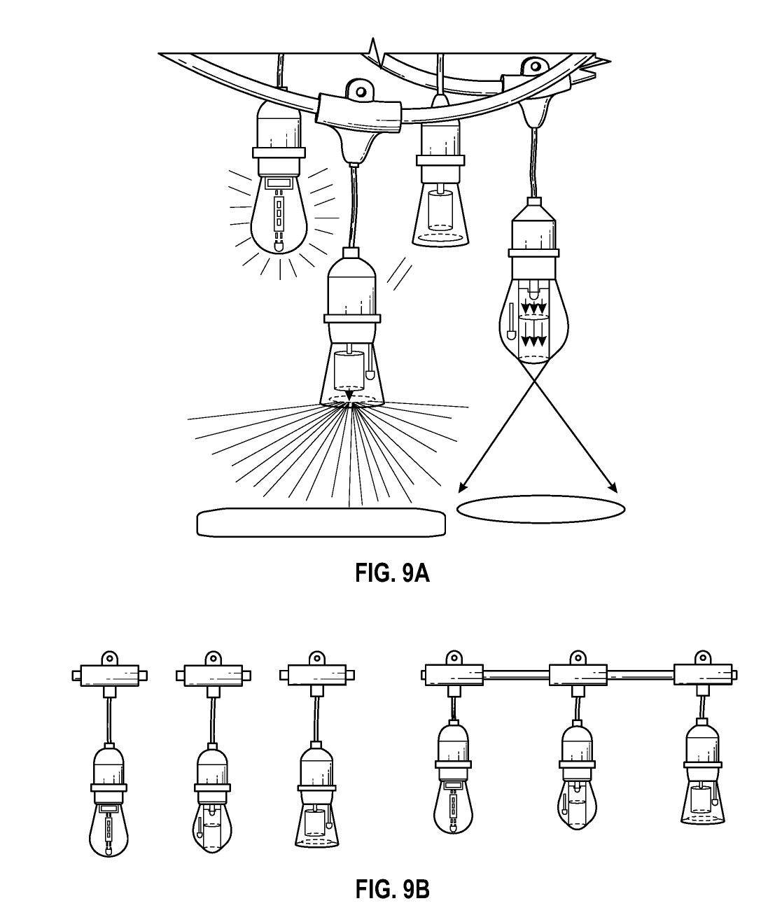

FIG. 17 shows the idea of the said combo-bases to be able to screw in more than one of the female receiving bulb socket while shrank/retract with two, exemplary, The Big bulb bases (Male E26) can fit into inside one big bulb-socket (Female E26) one; or one Medium bulb base (Male E17) can fit into inside one medium bulb-socket (Female E17) while combo-bases stretched half-way. This figure also shows the fully stretched exemplary combo-bases has the smallest base (Male E12) which can fit in the smallest size of bulb-socket (Female E12). From this FIG. 09 also show the reverse example.

FIGS. 19A to 19G show the said variety LED or-laser light device, garden light has the adjustable kits which in the form of flexible, bendable arm, tube, bar for built-in (has one end install the light device and one end has prong or bulb base) or Add-on (the arm or tube or bar both ends has desired combination for female bulb receiving socket, male bulb base, male prong, female outlet to receiving male prong), so these adjustable kits can allow the LED or-and Laser light kits light beams or sensor head to be position, orientation to desired location and overcome any block-object including depth recess hole, glass shade, heat so can get good lighting emitting, electric signal delivery, depth of hole for recess light bulb-socket location or other any other block-objects.

FIGS. 20A to 20B show the LED or-and laser light device, garden light which has more than one project assembly and each can project image or lighted patterns from individual project assembly as co-inventor's co-pending or issued variety US patents. In order to make moving or attractive light effects and save cost to incorporate with motor or movement or moving devices, the current invention apply IC to make each project assembly has different timing to turn-on and turn-off to get the 1^{st} project→2^{nd} project→3 project by IC and control circuits. The body besides the more than one of project assembly can design as other LED or-and Laser light source for desired light show including color changing, illumination to present any light functions available from market place. It also shown the current invention show the same unit of LED or-and Laser light device can get power from Prong or Bulb base to get power.

FIGS. 21-22: Disclosure the 1^{st} embodiment of the said project image main construction for LED or-and laser night light or LED or-and laser Bulb or LED or-and laser garden light has LED or-and Laser light source(s), image carrier(s), project-lens(s) to form the big project image on desired location and emit out from the said LED or-and laser night light or LED or-and laser bulb, garden light.

FIGS. 23-25 are schematic diagrams showing basic lens theory.

FIGS. 26A to 26C: Disclosure the 3 embodiment of the said project night light or bulb or garden light has the wider viewing angle moving project image from the said 3 different moving theory night light. FIG. 26A is use LEDs or-and laser light source(es) on time on different time period to change the Light source relative position, orientation to the said image carrier or-and project-lens(s). FIG. 26B is used motor or movement, spin, rotate, moving device to make the said image carrier(s) to moving to make the big project image or lighted patterns to moving. FIG. 26C use the magnetic & magnetic-coil with mechanical arms to make the image carrier to moving, shaking, swing to make the said big project image or-and lighted patterns moved.

FIG. 27: Disclosure the FIG. 26B for details construction which has movement or motor on bottom with axis long enough to hold and rotate the said image carrier and also allow the LEDs or-and laser and circuit board along the axis so can allow LED(s) or-and laser light beam passing through the top optic-lens (change narrow LED light beam to wider and parallel light beam or make the single laser beam to plurality of laser beams) to hit the top image-carrier and light passing through the image-carrier's opening, cutout, windows, printed window, film, slide, or display or digital data display, laser film, grating film and go through the top project-lens or protected piece which may in variety type including but not limited for one refraction-lens or multiple refraction-lens or refraction or simple protect inside parts or reflection lens or any combinations from market available type to create desired light effects. (This drawing same as co-pending filing (#ZZZ-3) U.S. application Ser. No. 14/503,647),

From FIG. 28; Disclosure the FIG. 26C for details construction which has the magnetic & magnetic coil sets to make the magnetic reaction force to pull and push the swing-arm's built-in magnetic unit so can move the swing-arms swinging to make the image-carrier to moving back-and-forth to simulate the sea wave moving effects. The LED light beam pass through the said sea-wave texture image-carrier and emit the tiny image to the top project-lens to magnify to project to wider viewing angle project image on the desire surfaces including wall, ceiling, floor. The moving device here is by magnetic reaction force not from the motor/movement/rotate or spin devices.

FIGS. 29A to 29G: Disclosure the other embodiment of the said LED bulb for down light, or entrance light, stair light, recess light applications such as FIGS. 29B to 29C for normal down light installations. Some of other LED Bulb which may has the block-means from the ceiling, walls, lamp shade which made of cement, concrete, metal, porcelain, pottery or any material which will block out the electric wave, electric signal to transmit though to affect or interfere the LED Bulb operated by Wi-Fi, Blue-tooth, internet, App software electric signal delivery so the current invention has different design (FIGS. 29D to 29F) has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.

FIGS. 30A to 30C disclosure the current invention co-pending filing (#ZZZ-1) U.S. application Ser. No. 14/323,318 which is Continue in Pat filing of (#ZZZ-13) U.S. application Ser. No. 14/023,889 both is related to the wider area image or project image night light with motor/spin/rotating kits to project moving big image.

FIGS. 31A to 31C disclosure the preferred 5^{th} embodiment which has the basic 3 main construction of the LED(s) or-and laser light source, image carrier(s) or-and laser film or-and grating film, project-lens assembly as all co-pending filing related to one or more than one project with or without the illumination functions inside all prior filing cases. The current invention had motor/movement means to drive axis to rotating and top of the motor has plurality of LED(s) or-and laser as light source, the LED or-and laser light beam go through the image-carriers' device or-and laser film or-and grating film those has one or more than one film/slide/openings/printed windows with or without the holder or disc which is not rotatable or moving. The lighted tiny image or lighted patterns from the said image carrier emit to the top project-lens assembly or refractive lens which may be one or more than one which is moving, rotate, spin to allow the tiny-image light beam or-and lighted patterns to fall within each project-lens or-and refractive-lens from one edge to other edge to form the big project image moving on top ceiling or walls or floor from angle N to N−1.

The normally the angle depend on how many project-lens inside a round or a disc or dish-shape of carrier or holder. Such as 6 lens arranged on the disc as FIG. 31A, each project-lens around 60 degree, the moving big project image also will show on the surface will has around same 60 degree from appear to dis-appear. This embodiment all parts all fit within the said LED bulb or garden light housing parts not as the co-inventor's earlier filing cases the LED, film/slide/displayer/screen, project-lens incorporate with tube or tube-assembly piece or housing body. The current invention mainly to fit within the LED or-and laser bulb or garden light housing parts only.

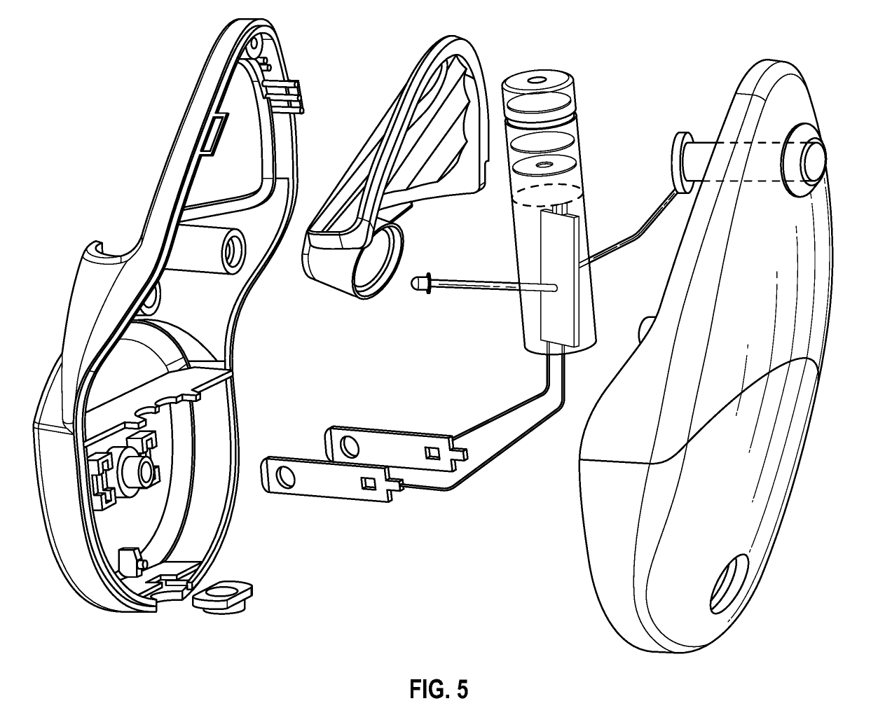

From FIG. 31B disclosure the alternative arrangement for the rotating multiple project-lens assembly which has a round holder to hold or fix the 6 project-lens or convex-lens each from edge to edge of lens around 60 degree or less so the big project image will move from appear to dis-appear around 60 degree on surface. The difference than the FIG. 5A is the light beam from LED(s) or-and laser and tiny-image light-beams has the relatively and separate tube(s) to position with each LED(s) or-and laser that Light output end of lighted tiny-image ends, so the light beams from these 2 sections will not leakage too much to inside of the said bulb or garden light or night light or light string's housing. o

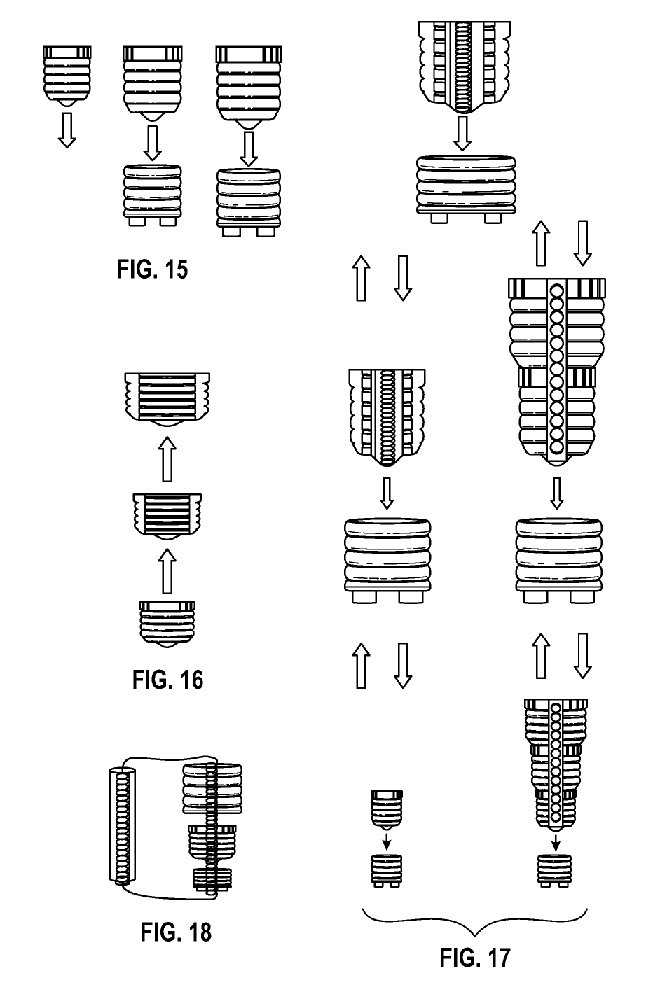

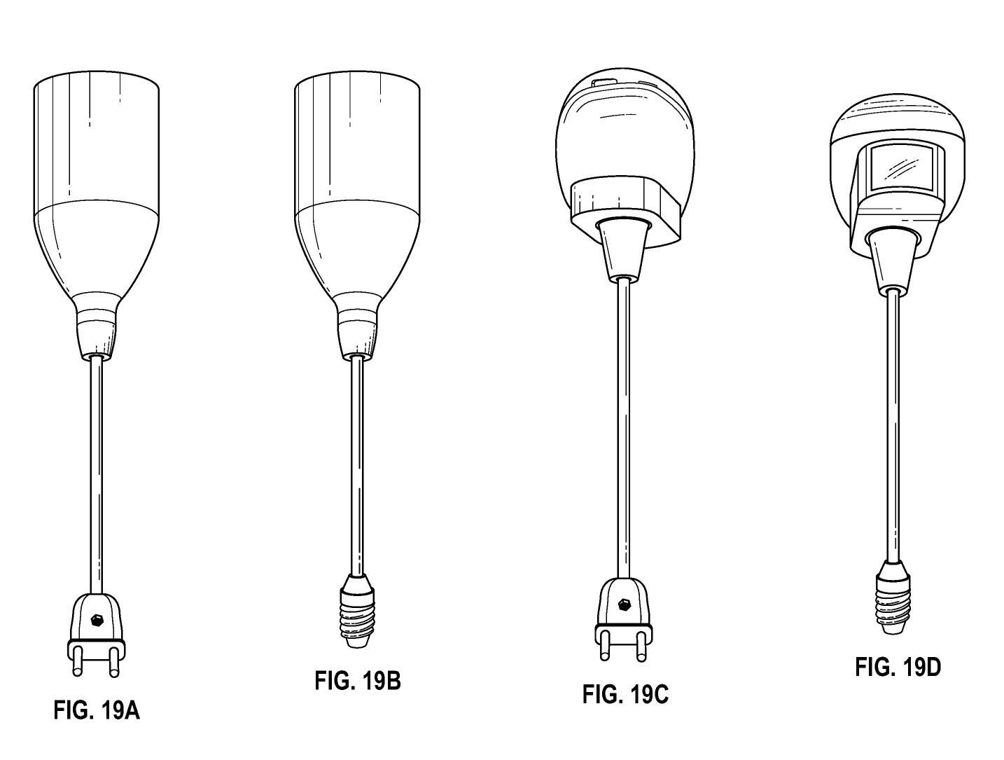

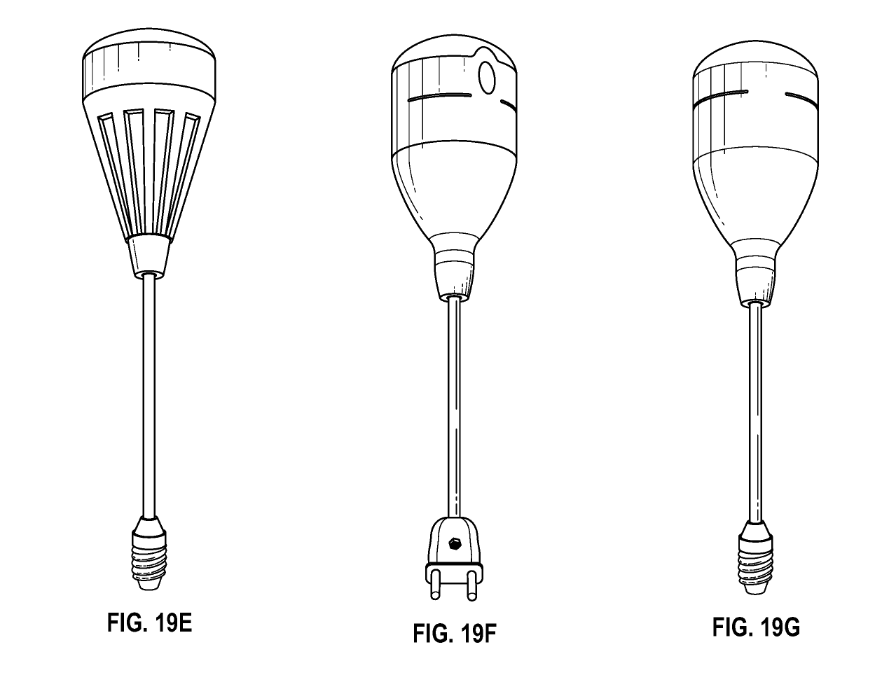

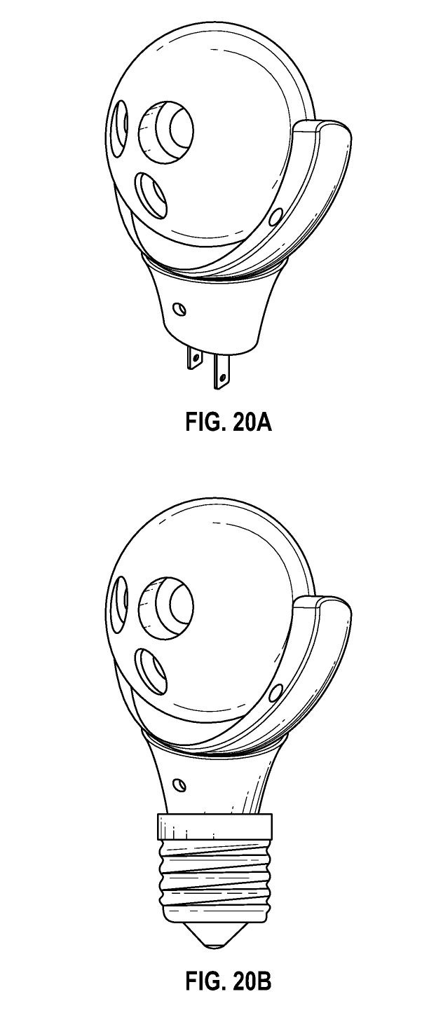

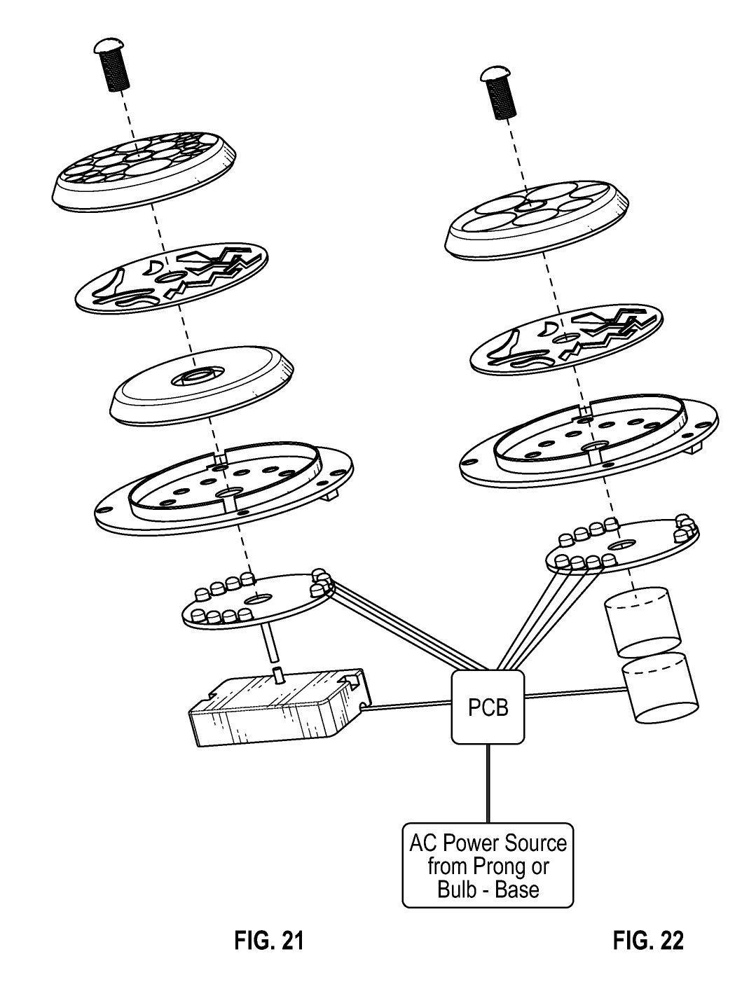

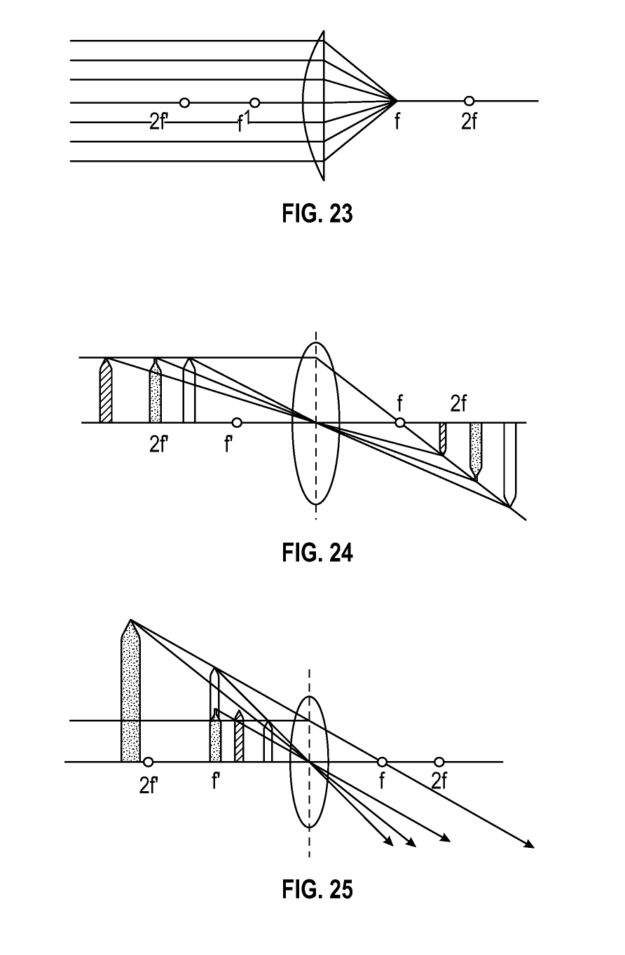

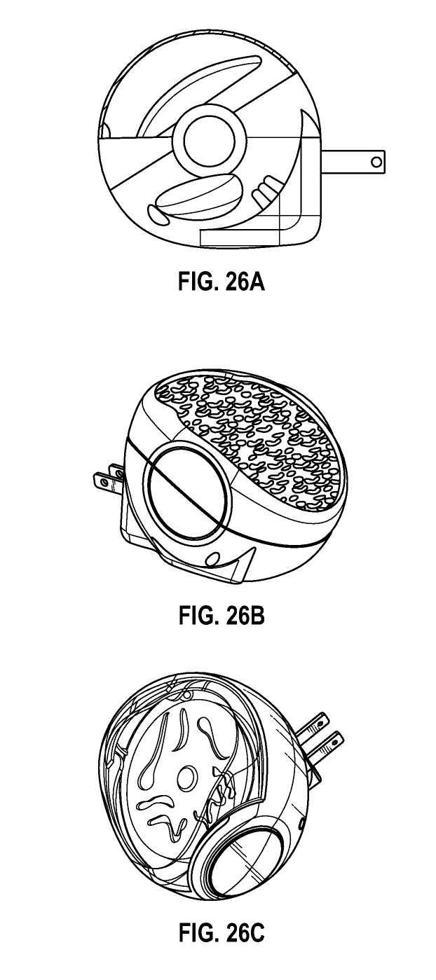

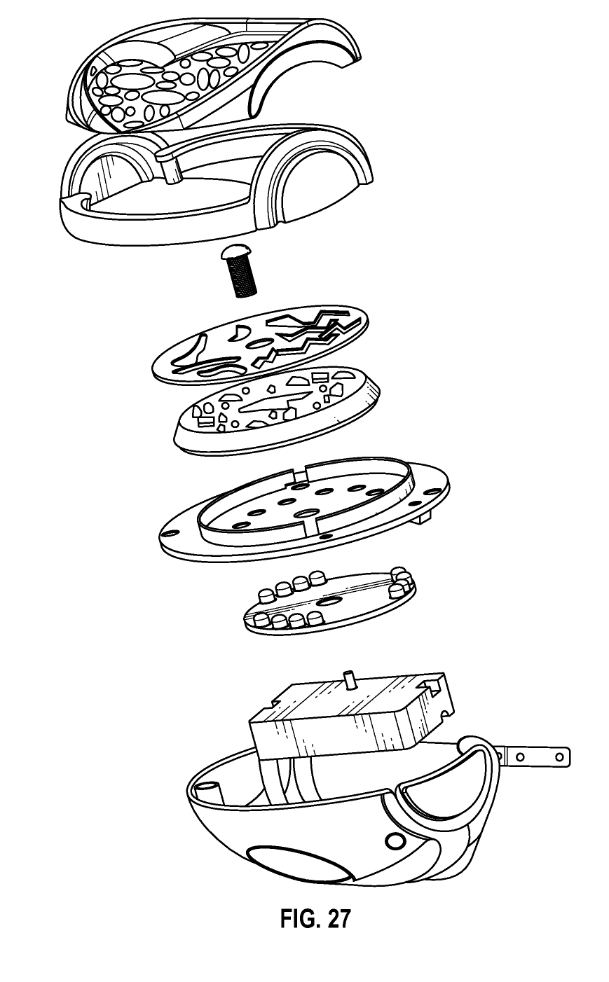

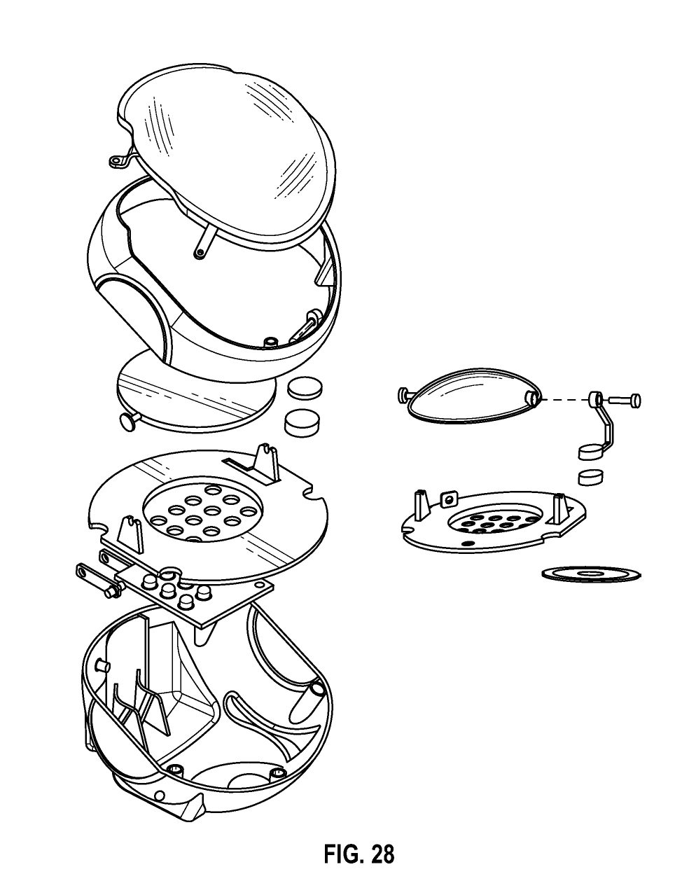

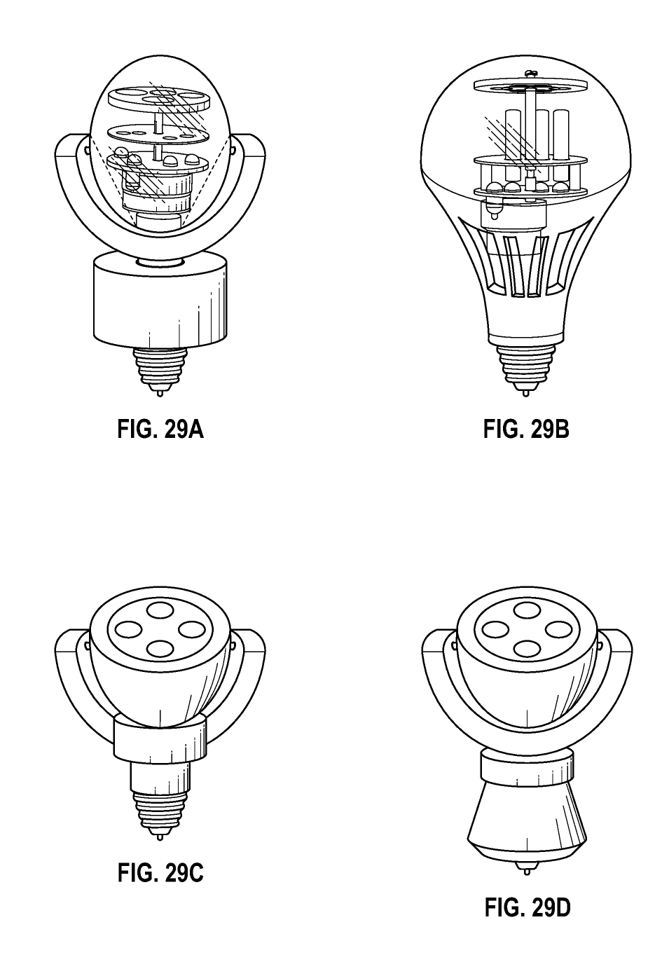

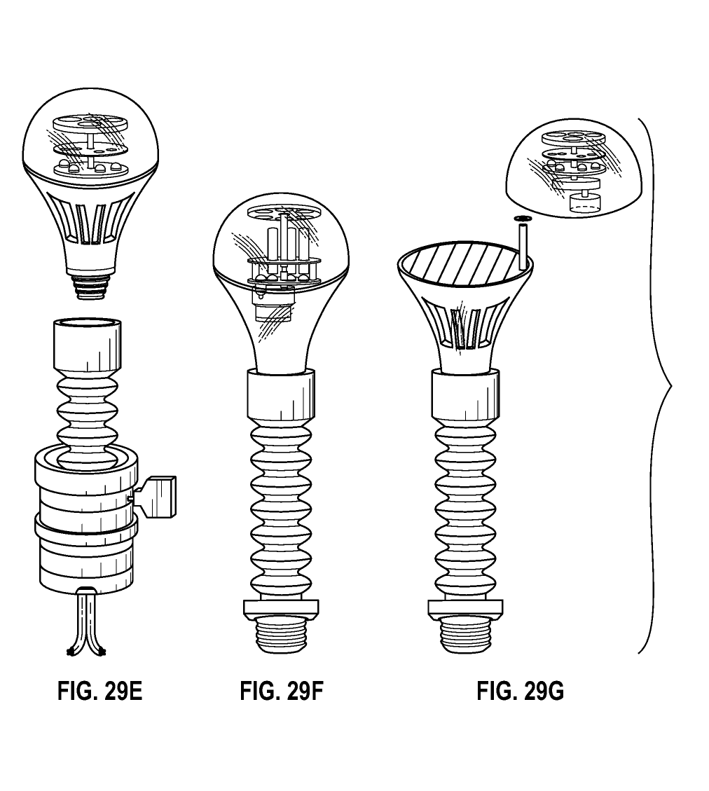

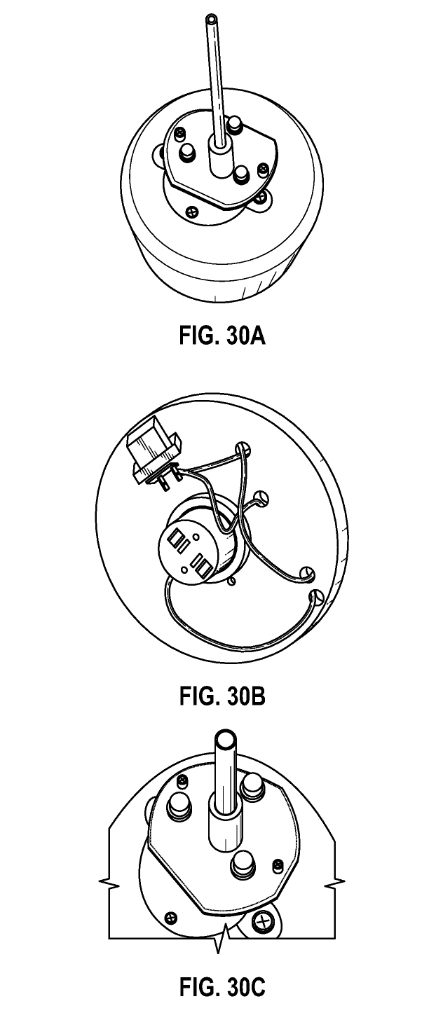

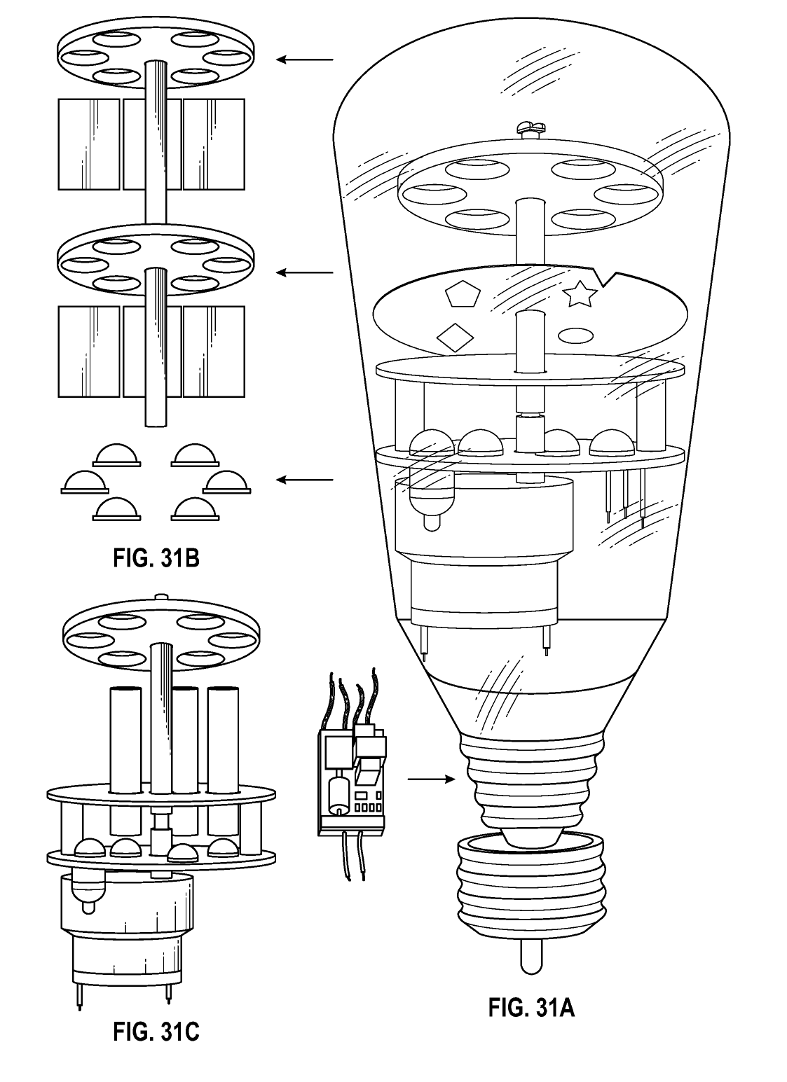

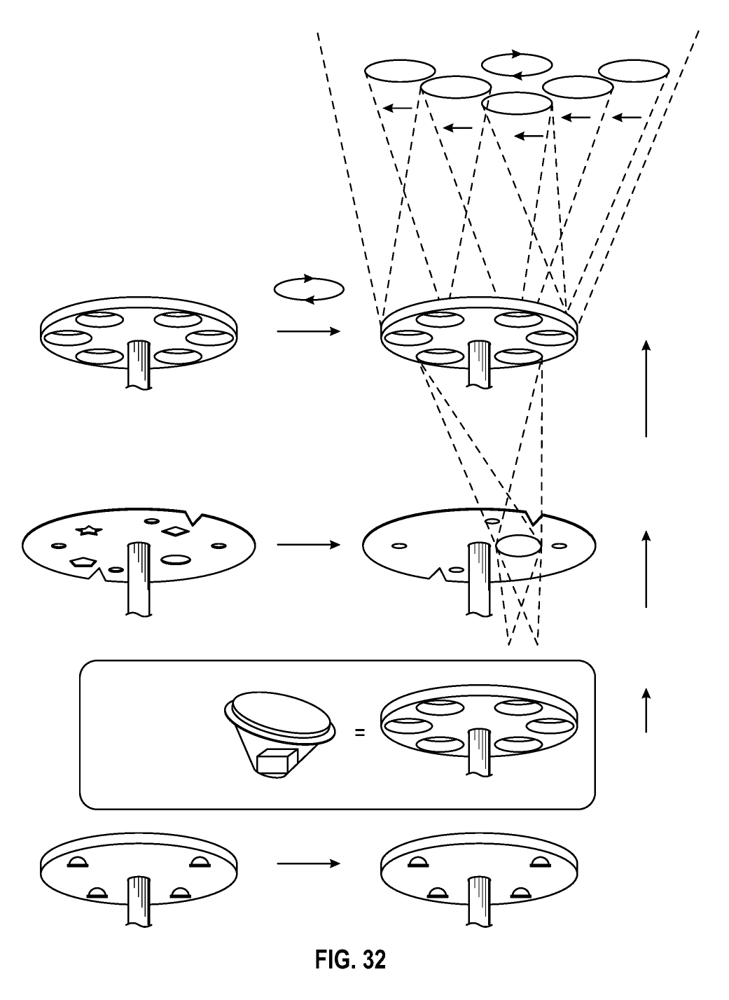

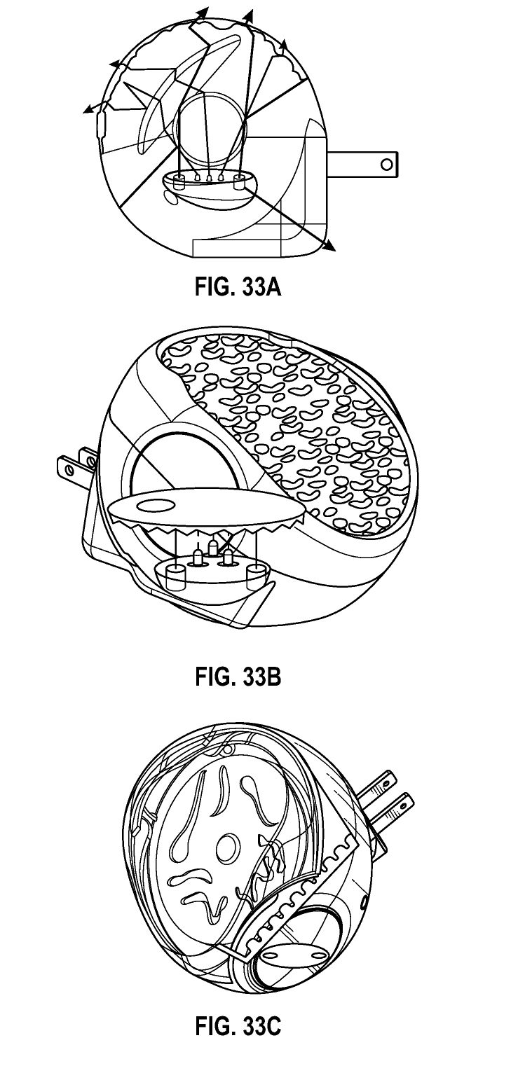

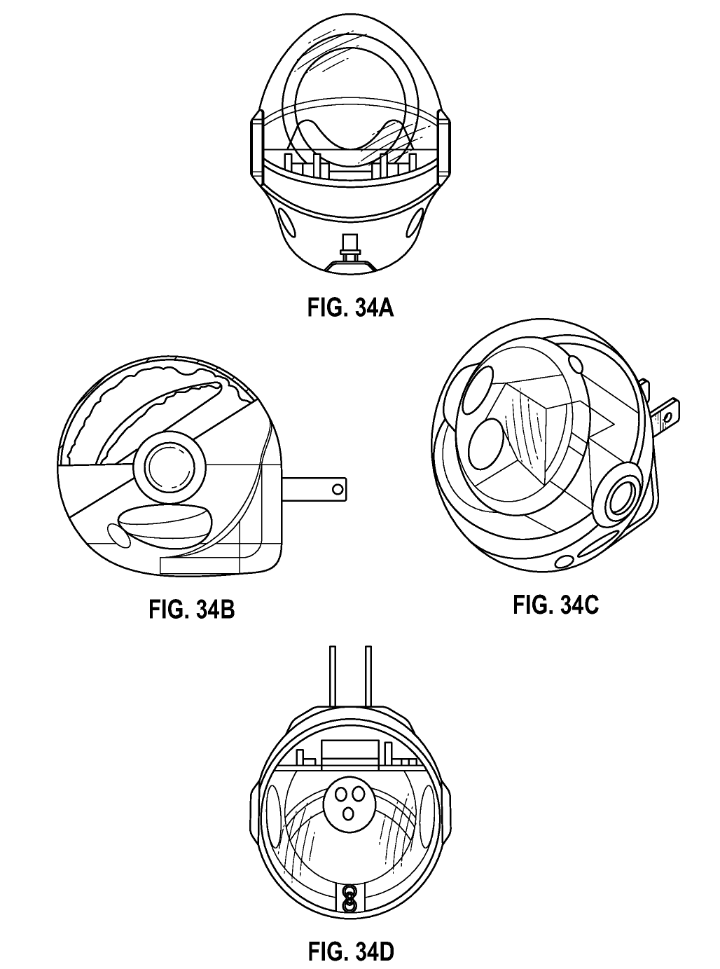

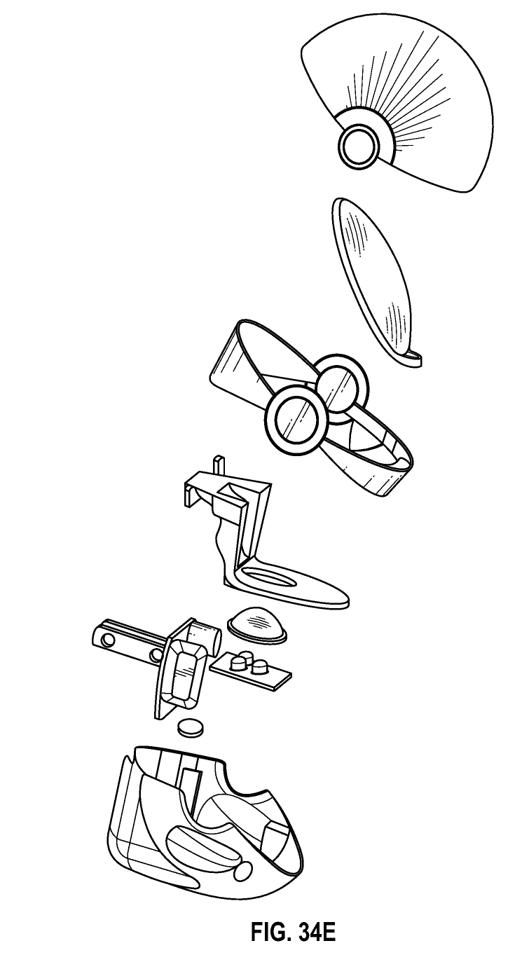

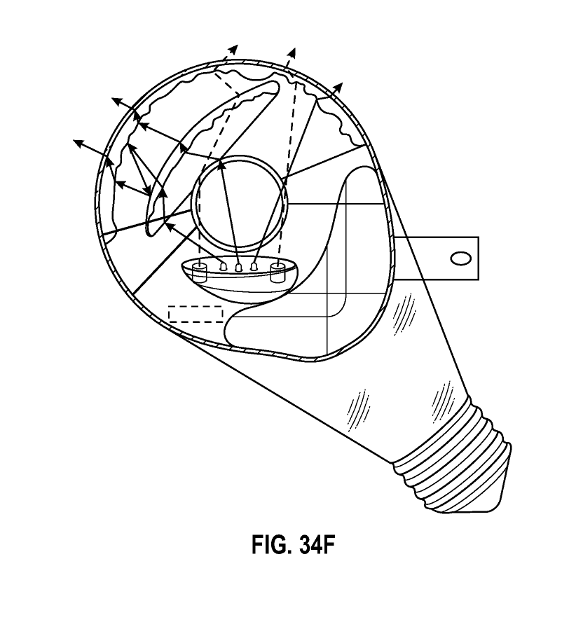

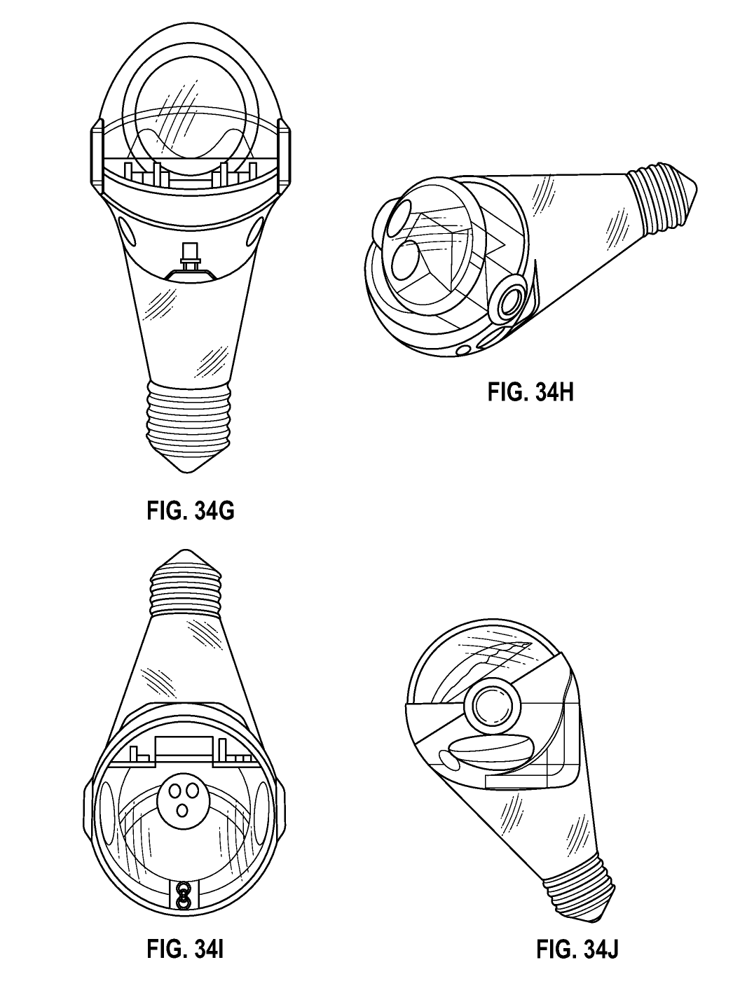

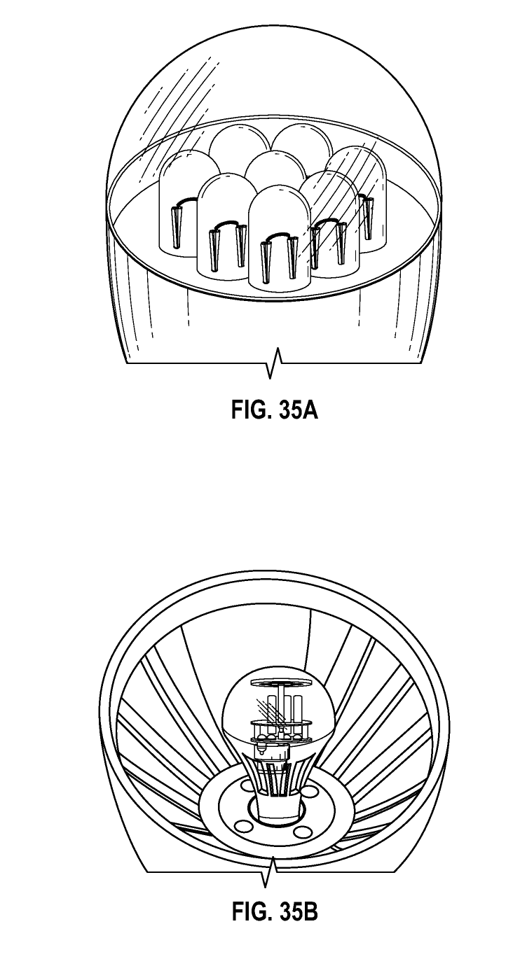

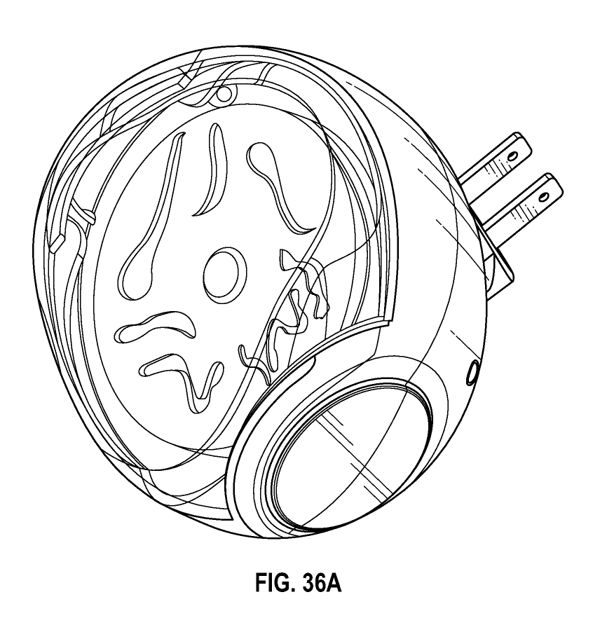

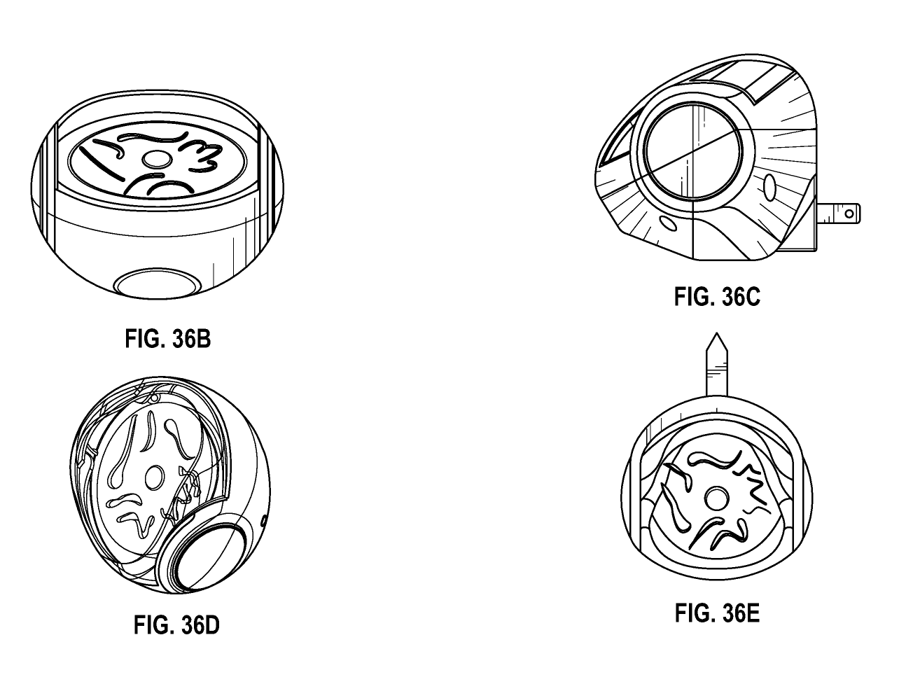

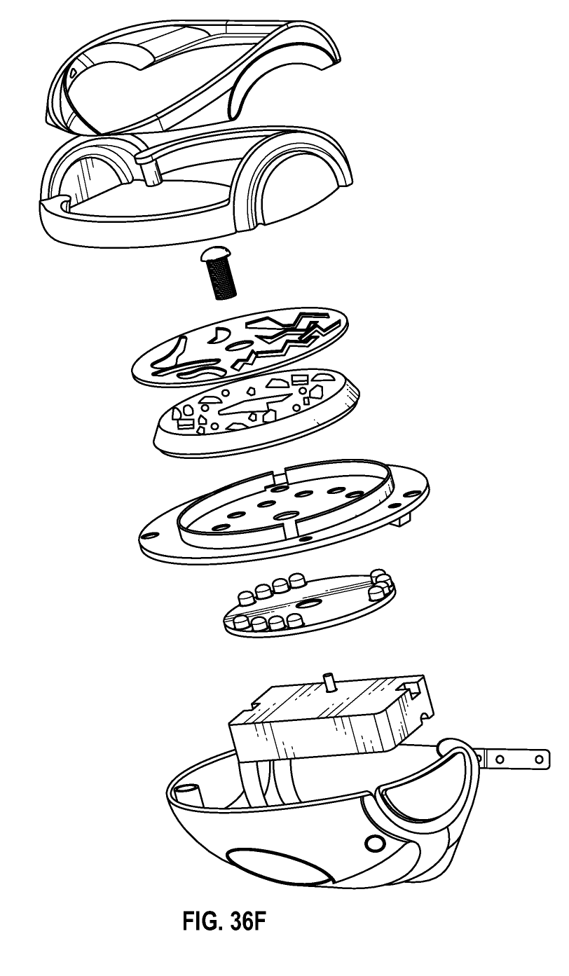

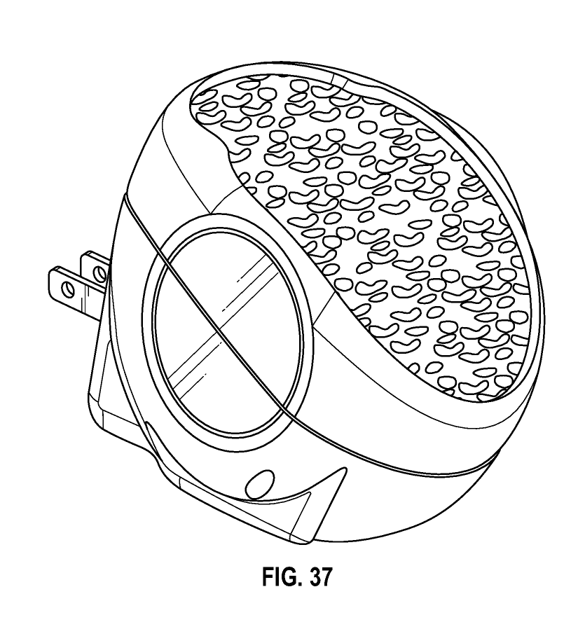

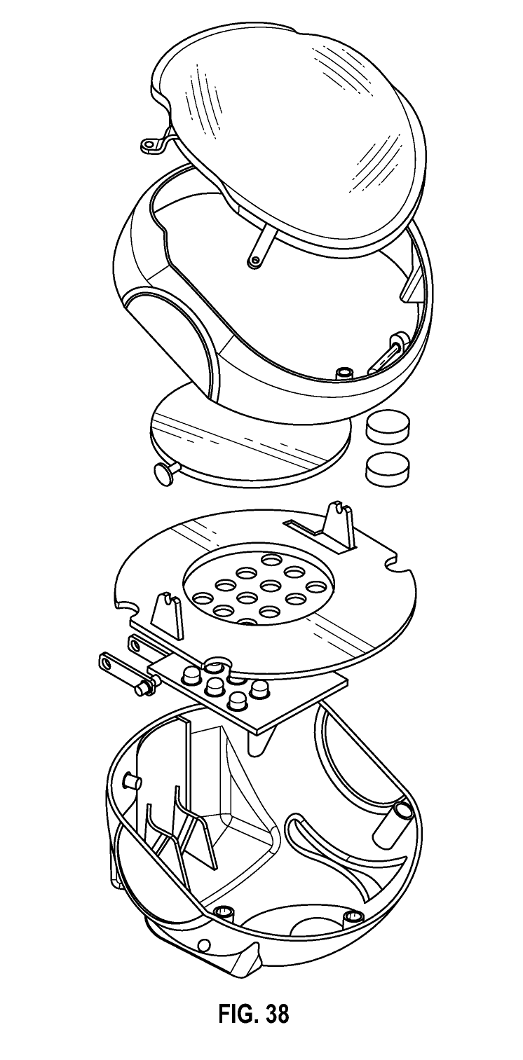

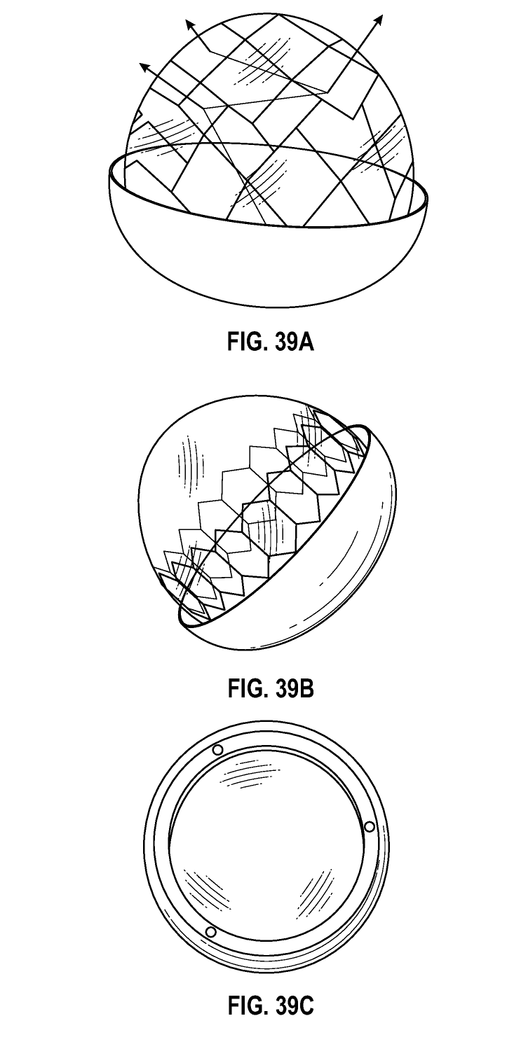

From FIG. 32: Disclosure the light theory for the more than one project head same as the co-pending filing that the one project night light or LED bulb or garden light has built-in multiple project-assembly like the co-inventor's U.S. Pat. No. 8,083,377 issued date Dec. 27, 2011 FIG. 15 and FIG. 16 has the multiple project head to create multiple big project images on areas or surface. The current invention has plurality of the LEDs and top has image-carrier in one piece or many different film/slide/openings/printed windows/stencils/to allow the LED light beam to pass through for form a lighted tiny-image to go through the top project-lens from number 1 to number N (N-can be same number of top project-lens of the disc or Holder) and from edge to other edge so can see the moving big project image from angle N-appear to Angle N-dis-appear. The construction for example but not limited for these limited drawings. It is appreciated all kind of alternative or replaceable or equal function or result or effects still fall within the current invention scope and claims.

The current inventions all drawing are same as above listed co-inventor co-pending or patent drawing with some change on the LED night light or LED or-and laser bulb or LED or-and laser garden light including but not limited to has more than one level(s) and use more than one movable-device can make the at least one level's parts or accessories to any desire location, position and orientation. Also, each of level(s) can has one or more than one functions selected from market available LED or-and laser light effects, function, performance. It is easily to refer all these concepts are same but belong to brand new while become the LED or-and laser night light or LED or-and laser bulb or LED or-and laser garden light applications with all co-pending filing cases' features and concept. It is appreciated all listed co-pending or patented drawing, concept, feature or equivalent or same functions parts/accessories/electric circuit/concept still fall within the current invention for LED or-and laser night light, LED or-and laser BULB, LED or-and laser garden light application.

Below drawing are co-pending filing case (#ZZZ-4) 14 page

FIG. 33A is the 1^{st} preferred embodiment show the LED or-and laser light device has more than one optics-elements has the outer half ball, ⅔ ball, dome, or sphere 1^{st} optic-element which is optics-lens and has the inner geometric shape 2^{nd} optics-element which is other optics lens. Both has its pre-determined optics properties so can allow LED or-laser light beam emit out to big area or wider view angle to viewer.

FIG. 33B is the 2nd preferred embodiment show the LED or-and laser light device has more than one optics-elements has the outer around 180 flat wider opening cover is the 1^{st} optic-element which is optics-lens and has the inner geometric shape 2^{nd} optics-element which is not the optics lens but made by preferred material which may a plastic film, slide, film, printed sheet, image-forming carrier, shape-forming carrier, color film, piece has openings or cutouts or windows or shaped printed to make the LED or-and laser beam to pass though non-block areas to shape the light beam. The 2^{nd} inner optics-element can work with moving device to make the image or lighted patterns has moving, changeable effects. Both has its pre-determined optics properties so can allow LED or-laser light beam emit out to big area or wider view angle to viewer.

FIG. 33C is the 3rd preferred embodiment show the LED or-and laser light device has more than one optics-elements has the outer around 180 flat wider opening cover is the 1^{st} optic-element which is optics-lens and has the inner geometric shape 2^{nd} optics-element which is not the optics lens but made by preferred material which may a plastic film, slide, film, printed sheet, image-forming carrier, shape-forming carrier, color film, piece has openings or cutouts or windows or shaped printed to make the LED or-and laser beam to pass though non-block areas to shape the light beam.

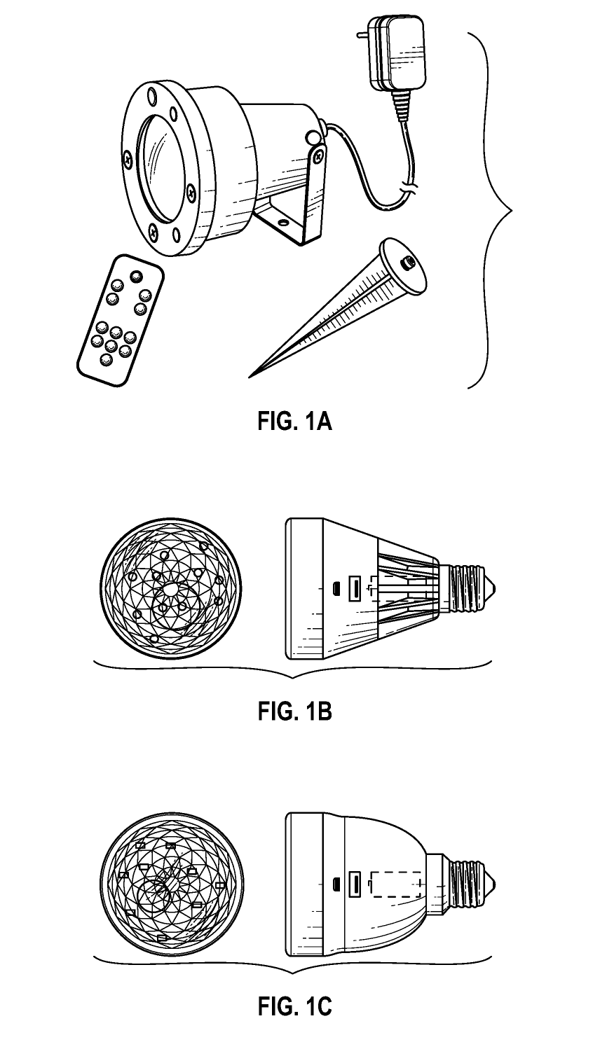

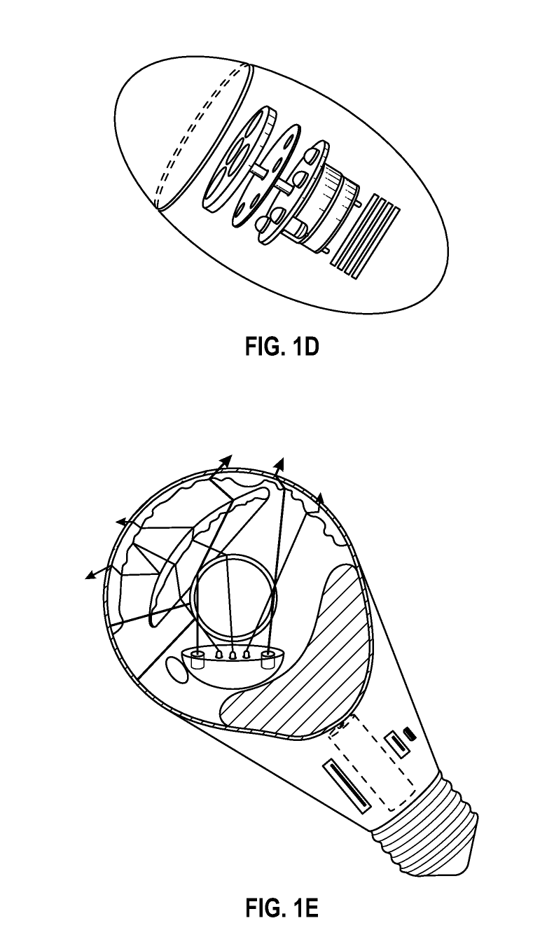

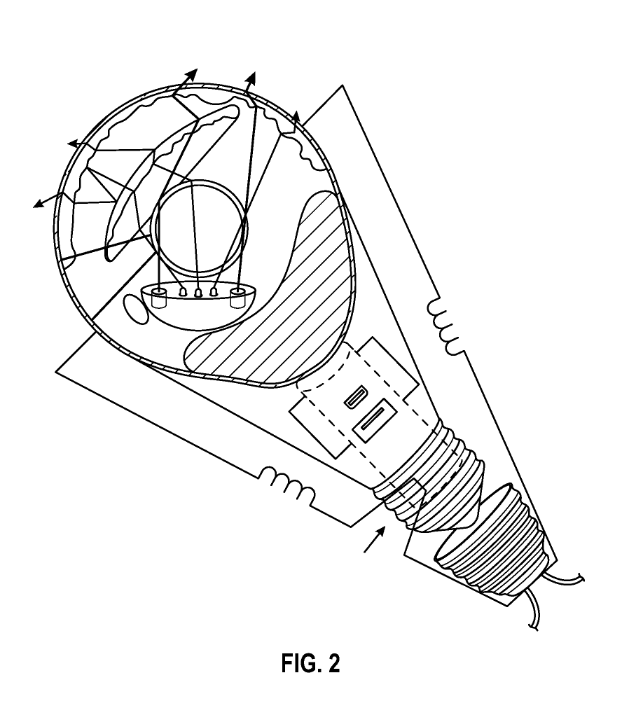

FIGS. 34A to 34D shown the 1^{st} preferable embodiment major 2 optics-elements and parts details. It also shows 1^{st} embodiment incorporate the USB female port as FIG. 1-1 or incorporated with prong terminals such as FIG. 1-2, FIG. 1-3, FIG. 1-4.

FIG. 34E show the 1^{st} preferable embodiment all major parts construction with details BOM

FIGS. 34F to 34J shows the alternative embodiment which uses different terminals to get the different power source such as bulb bases terminals to deliver the AC power into the Bulb-base for bulb-like LED or-and laser light products. Also show the Prong terminal to get the AC power or-and USB female ports to get DC power for original 1^{st} embodiment shape product. So as long as change the product shape can even have had same optics parts & accessories to get AC power by Prong or the Bulb-base.

FIGS. 35A and 35B show the inner optics-element can be a dish like reflector has plurality small tiny reflector to build along the dish like surface. The 2^{nd} inner optics-element can work with moving device to make the image or lighted patterns has moving, changeable effects. (Details shown aside the Figure)

FIGS. 35A and 35B that disclosure the 3^{rd} optics-elements like those are dish like reflector has plurality small tiny reflector to build along the dish like surface. The 2^{nd} inner optics-element can work with moving device to make the image or lighted patterns has moving, changeable effects. It has the 3^{rd} optics-elements like nuts, core, ball with many cut surface surround the surface so can allow the bottom LED or-and LED light beam passing through to get plurality of light beams to hit the dish like reflectors to get splendid light effects with or without moving or motor device to rotating to create the moving effects. All those Three or two optics-elements has its pre-determined optics properties so can allow LED or-laser light beam emit out to big area or wider view angle to viewer.

From FIG. 35B, show Furthermore may has 3^{rd} optics-elements like nuts, core, ball with many cut-surface(s) surround the surface of nuts, core, ball, so can allow the bottom LED or-and LED light beam passing through to get plurality of light beams to hit the dish like reflectors to get splendid light effects with or without moving or motor device to rotating to create the moving effects. All those Three or two optics-elements has its pre-determined optics properties so can allow LED or-laser light beam emit out to big area or wider view angle to viewer. (Details shown aside the Figure)

FIGS. 36A to 36E shown the 2nd preferable embodiment major parts details. (Details shown aside the Figure)

FIG. 36F show the 2nd preferable embodiment all major parts construction. (Details shown aside the Figure)

FIG. 37 shown the 3rd preferable embodiment major parts details. (Details shown aside the Figure)

FIG. 38 show the 3rd preferable embodiment all major parts construction. (Details shown aside the Figure)

FIGS. 39A to 39C show the one ½ ball or ⅔ ball or sphere or dome top cover optic-lens has multiple small size of reflective-surface(s) inside the ball and has multiple small size refractive-surface(s) on the outside surface to form an optic-elements has more than one of optics-properties.

### DETAIL DESCRIPTION

The current invention is continuously filing for

(#DD-1) U.S. application Ser. No. 12/834,435 filed on Jul. 12, 2010 which is continuously filing for

(#DD-2008) U.S. application Ser. No. 12/292,153 filed on Nov. 12 , 2008 now is U.S. Pat. No. 7,871,192 which has Child continuity filed cases

U.S. application Ser. No. 12/886,832 filed on Sep. 21, 2010 and

U.S. application Ser. No. 12/886,435 filed Jul. 12, 2010 and

U.S. application Ser. No. 14/622,628 filed on Feb. 13, 2015 and

U.S. application Ser. No. 14/737,434 filed on Jun. 11, 2015 and

U.S. application Ser. No. 14/943,645 filed on Nov. 18, 2015 and

U.S. application number 14/944,953 filed on Dec. 14, 2015 and

U.S. application Ser. No. 14/968,153 filed on Dec. 14, 2015

which is pending claims the benefit of Ser. No. 12/292,153 filed on Nov. 12, 2008.

Which teach the (1) tube to prevent from light leakage (2) image forming unit to create image or lighted pattern (3) optics-lens to enlarge and protect the inner parts prevent people electric shock.

From these plurality of Co-inventor since 2008 November to disclosure most simple construction projection assembly using update super brightness LED on 2008 and keep the same main construction incorporated the following laser on 2010. It is appreciated that all the co-inventor's co-pending, issued filed cases all should be consider as same or equal function or replacement skill or alternative method should still fall within the current invention and claims coverage.

From FIG. 001 disclosure the (LED or-and laser) light source for light device where the light device is a (LED or-and Laser) bulb which has desired top-cover here is a flat piece with big opening on top of the bulb so can allow the inner (LED or-and Laser) light source light beam can widely emit out to outside. The Flat piece top cover can be many different design for different light source. It can be like FIG. 001-1 which has plurality of prism optic-piece inside the top lens to allow the inner multiple color LEDs light beam to emit out to wider areas to be seen.

From FIG. 001-1) The top cover lens also had one area is non-treated window (Not opening but it is different with prism optic-piece area). These areas are design for inner Laser light source because the inner laser light source already had other Optics-lens forming-unit to put in-front of the output-end of laser beam, so the single laser beam passing through the one of optics-image forming-unit here is the grating film. The said grating-film which can make high power single Laser beam into plurality of lower power laser beam in many preferred lighted patterns including matrix, array with or without the motor/rotating/spin device to make it become moving. Furtherly, the single laser beam also has contour, shaped image with desired Red or-and green or-and blue or even white color laser image or matrix.

From the FIG. 001-1) and FIG. 001-2) the said (LED or-and laser) light source for light device, here the light device is a bulb which also has built-in rechargeable battery and circuitry and receiving ends as the co-pending (#MMM-2011) content listed (a to z) parts to make combination become the bulb has at least (1) power fail or-and (2) USB charger or-and (3) USB power bank for extra 3 extra or added functions to of the original bulb for multiple color variety functions' projection light or-and white color illumination lighting. This is the other features basing on the co-pending (#MMM-2011) and (#DD-2008) content, spirit, concept.

From FIG. 001-1) and FIG. 001-2) both show the inside had rechargeable battery and circuitry and one receiving end is USB be charged receiving port and the other receiving port is USB supply power to other electric device receiving port, so can make the LED has optional functions from these (1) project light (2) illumination light (3) Power fail light (4) USB Charger device (5) USB power bank. Which combination is more popular depend on market requirement.

From FIG. 001-2) the optic-lens top cover is variety of tiny convex lens and each has different thickness, radius, focus so this is totally different with FIG. 001-1) which is prism optic-units inside lens. So the optics-properties will be different even the inside still have (LED and Laser) light source and even has same non-treated window of top-cover to allow inside grating-film and laser light beam to create the laser light show. From the FIG. 001-1) and FIG. 001-2) can see the grating-film is one round piece and center had center-hole to install the rotating axis which allow the grating-film to rotating and laser beam is aim at one position so the rotating grating-film will rotate from 0 to 360 degree and pass the fixed location laser beam.

The grating-film or hologram-film or other optics-film(s) can has as many as different image, contour, shape, geometric art in one round piece for examples 4, 8, 12, 16, 24, 36 so while the optic-film is rotating, each certain arc will show out the different arts. How long time to show each arts depend on the rotating device speed and gear set design. It can be very long or very short depend on market requirement.

From FIG. 001) show the said (LED or-and laser) light source apply for the garden light which has big opening front or top lens, LED light source and transformer power source, photo sensor, motion sensor, siren/sound device, remote controller, ground stake/pole, it also can have laser light source inside and put a tiny or round disc laser-treated film (hologram or grating film) in front of laser beam emit-out end so can created a plurality of laser light beam. The said (LED or-and Laser) light source can be one or more than one depend on how splendid light performance market wanted.

The FIG. 001-3) show the similar with FIG. 001) for garden light application has (LED or-and Laser) light beam for any combination preferred. Here prefers the garden light in a sport team shape like NFL which has the outside housing is football shape. This application use LED light source and required for 100 feet to see clear image so may use super high power LEDs so can project the football team logo/slogan/Sign to 100 feet. At this time the heat came out from numbers of high power LEDs is very high so add the heat-sink or fan or other ventilations arrangement to allow the heat not hurt the parts & accessories also can prevent people to touched and injured.

From FIG. 002) also disclosure the following extra and optional features:

1. The project assembly for (LED or-and Laser) light device as claim 1, The said light device has groove, ditch, gap, slot, space to have wire arrangement for the said USB wire for charger or supply current to other device.

2. The project assembly for (LED or-and Laser) light device as claim 1, The said light device has groove, gap, slot, opening, ditch, holder to install the said be-charged device including portable phone, I pad, consumer electric device, computer device, communication devices which has USB charging related parts & accessories.

3. The project assembly for (LED or-and Laser) light device as claim 1, The said light device has desired outside shape for portable size products in order to make the said device can fix on position, change light beam emit direction, angle, orientation by its outside shape including but not limited for multiple cuts for one circuit into triangle, square, pentagon, hexagon, heptagon, octagon, nonagon, decagon, or any geometric shape with desired angle and height adjustable kits.

From the FIG. 001-4) show the (LED or-and Laser) light source for light device, the light device is a bulb which has all the 1^{st} optic-element is inside optics-lens which has refractive optics properties so can change the (LED or-and laser) light beam to other direction. Then, the (LED or-and laser) light beam came out from 1^{st} inner Optics-lens get into the 2^{nd} optic-lens which is Top-cover it may have refractive or-and reflective optics properties so can create more and much more lighted image or patterns to emit out from top-cover to desired surface including wall, ceiling, fence, ground, house, building, floor . . . etc.

From FIG. 001-4) also show the inside housing may also include (1) rechargeable battery or batteries which prefer the rechargeable type and (2) Circuitry to make recharge or power fail or power bank functions with or without IC help and (3) receiving ends here as the USB be charged port or-and supply power port, so these basic 3 parts selected from co-pending (#ZZZ-2011) list can make each or every bulb or light device with the (LED or-and Laser) light source can become at least 3 added functions top of the original projection function and illumination functions.

It is also appreciated the (LED or-and Laser) bulb's receiving socket can be the type for (a) install on substrate such as wall, ceiling, take, base or (b) it is a portable unit which simple only have socket with on-off switch and hook, magnetic piece so can let the said bulb become the portable items while the bulb has its own DC power source inside. This kind of tiny bulb socket with built-in switch will allow the people can carry everywhere and make the illumination as wish to make different area been illuminated. This hand carries portable (LED or-and Laser) Bulb can change every person's daily lighting fixture because daily lighting fixture always on the same position very few will have changed or moved. So, The current LED bulb with portable bulb-socket has built-in switch or inductive switch can let people to make every time different lighting arrangement is very attractive because now can jump out every family, working room, living room's illumination including change areas been illuminated, change color, change brightness, change, light emit direction so it is really good for people can use one portable LED bulb to study, work, rest, wakeup, take a walk, go to toilet, find the things, thinking with desired areas be lighted and desired light emitting direction to people eyes.

From FIG. 002) show more details how to apply the (LED or-and Laser) light source for a bulb. The bulb also can fit into all kind of light device. This embodiment disclosure how to use (LED or-and Laser) bulb into a garden light or desk lamp housing. It is very simple as long as the light device has one case or housing has built-in bulb-socket, then, just insert or twist the (LED or-and laser) bulb to the bulb-socket so can become replaceable, changeable (LED or-and laser) light device. Especially like this replaceable and changeable (LED or-and Laser) bulb light device is very good for holiday/seasonal lighting. As known, the seasonal/holiday garden light or outdoor light only use for few days after the holiday/seasonal gone, people throw away or put into garage for next year use. However, the current invention for as cop ending (#QQQ-2011) (#QQQ-1) has project and illumination function so can use simple IC a circuitry design can make the single bulb change from Holiday/Seasonal to Every illumination bulb. Or-and change from everyday illumination to Holiday/Seasonal day use . . . . This can simple use power shut-down circuitry or IC chip or remote controller to make this happen. The said (LED or-and Laser) bulb can do more not only change between the holiday←→Everyday, But also can be LED←→Laser or any combination of all kind of lighting function in 1 (LED or-and Laser) bulb as the (#QQQ-4) (#QQQ-5) (#ZZZ-4) (#XX-2010) (#DD-2008) co-pending filings for the variety assembly for Optics-lens, project-assembly, optics-elements for desired combinations.

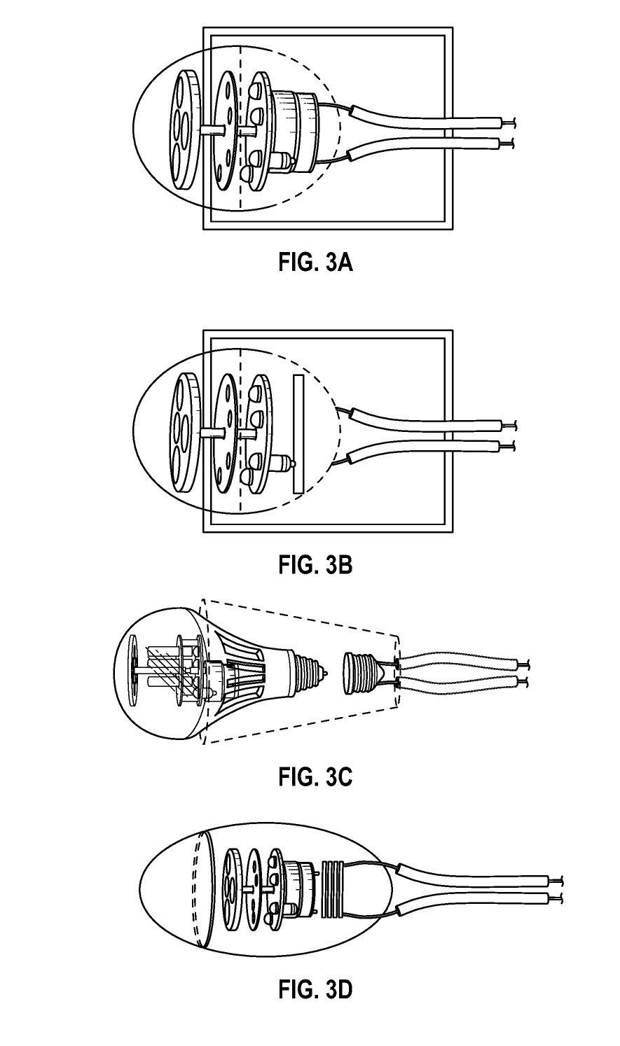

From FIG. 003-1) disclosure the one light device has its housing which can put into current invention's (LED or-and Laser) bulb or unit into so can instantly become a certain application lighting. From (003-1) if the housing is garden light shape housing, it can put the (LED or-and Laser) unit into and fixed and connected by wire to power source. It instantly become an (LED or-and laser) garden light power by wired. Here of, the said (LED or-and Laser) unit also has two pole on 2 sides to fit into the housing 2 pole holder so the said (LED or-and laser) unit also can be tile and changed the angle or position to aim for light beam direction.

From FIG. 003-2) same as FIG. 003-1) but has different rotating device. The FIG. 003-1) the said image forming-unit has printed piece or cut-outs or holes or windows or shaped arts with the rotate optic-lens sets on top, so the super bright high power LED light beam can pass through the image forming-unit and passing through the rotating refractive optics-lens so can see the image is moving for arc traveling path to viewer. The FIG. 003-1) use rotate device is a motor and gear set may have Variable resistor or other electric parts & accessories can make dimmable or speed adjustable or focus adjustable.

From FIG. 003-2) the rotate device is so silent and less power consumption clock movement instead of FIG. 003-1) the motor and gear-set which is noisy and big power consumption.

From FIG. 003-3) it the above discussed put the (LED or-and laser) bulb into any existing light device Big housing which has built-in bulb socket. While the bulb-socket are sealed into a super compact size housing with on-off switch and hook/hanger/magnetic will become an anywhere light as above discussed.

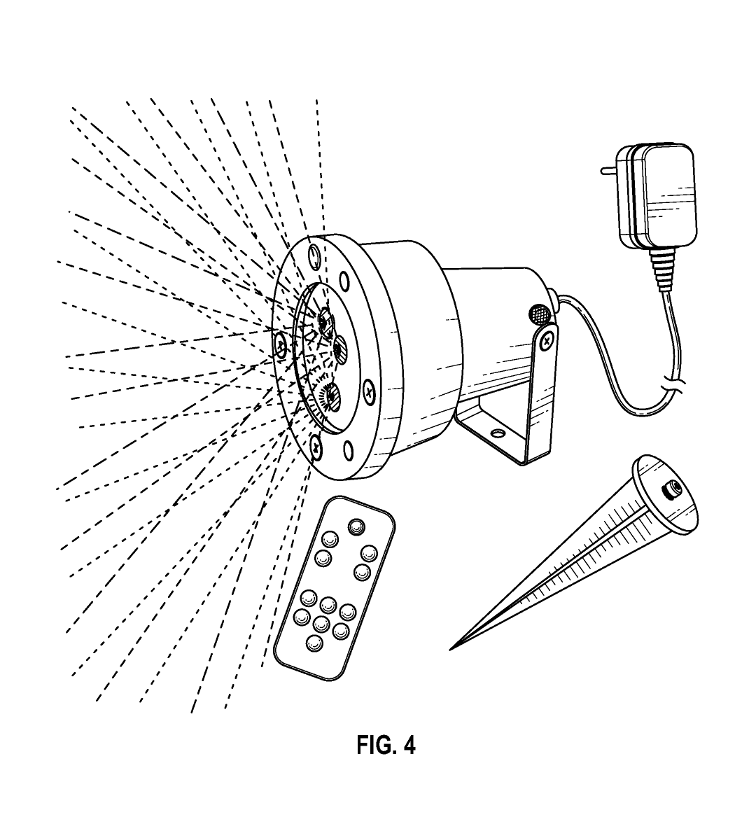

From FIG. 003-4) is same as above discussed FIG. 001-3) This is more details drawing for the inner construction.

From FIG. 004) is same as co-pend (#XX-2) FIG. 4 of Co-pending Ser. No. 15/170,071 for Laser Projection garden light.

Ffurthermore, the current invention also had update (22) features which follow co-inventor's all and non-listed co-pending or issued patents content, spirit, concept is as list below:

1. The project assembly for (LED or-and Laser) light device consist of;
At least one of (LED or-and laser) light source which has strong light beam to project image or lighted patterns from 10 feet to 100 feet distance to be seen; and
At least one project assembly to create the lighted image or patterns has following arrangement:
(a) At least one of tube; or tube-like piece; or cylinder shape tube; or-and housing parts to prevent light beam leakage out from light device.
(b) At least one of image forming-unit; or-and lighted pattern forming-unit; or optics-pattern forming-unit (optics-lens) fit within (A) and in-front of the light source(es) to get the lighted image or lighted patterns.
(c) At least one of optics-elements for the light device's top-cover which is one of flat piece; or partial round shape; or sphere; or dome shape has wider opening to allow inner light beam to pass through and show desired lighted image or-and lighted patterns on surface which is away from light device and at least 10 feet away to present desired lighted image or patterns for any wall, ground, floor, buildings, surface.

The project assembly for (LED or-and Laser) light device as claim 1, the said project assembly further incorporate with moving device which is one of a motor, clock movement, inductive device, rotating unit, spin unit, gear set, elastic twist set to make the said forming-unit; or-and optics-element; or-and optics lens; or-and top cover to move to create the moving effects.

2. The project assembly for (LED or-and Laser) light device as claim 1, the said project assembly has at least one of image forming-unit which selected from slide; film; printed piece; stencil; piece has holes, cutouts, windows; LCD displayer, wireless-data screen, LCoS Lens with data-changing screen, internet wireless image.

3. The project assembly for (LED or-and Laser) light device as claim 1, the said project assembly has at least one of the lighted image forming-unit which selected from printed piece; stencil; piece has holes, cutouts, windows; geometric shaped windows with or without the movable device.

4. The project assembly for (LED or-and Laser) light device as claim 1, the said project assembly has at least one of the optics image forming-unit which selected from all kind of optic-lens which has at least one of optics properties selected from (1) reflective; or-and (2) refractive; or-and (3) different light passing capability; or-and (4) laser treated film which has grating or hologram effects in one or-and 2 surface of the optics-lens or optics-film ; these optics-lens or piece or film has different thickness, texture, curvature, finish, focus, light passing through capability, color, gaps, line-number, on anywhere of the said single piece of said optics-lens or optics-film for pre-designed specification.

5. The project assembly for (LED or-and Laser) light device as claim 1, the said the said project assembly has high power LED light source which from 0.5 Watt up to 50 wattages with or without the heat sink, ventilation device, fan to get rid-off the heat made from light device.

6. The project assembly for (LED or-and Laser) light device as claim 1, the said (LED or-and laser) light source for light device has at least one of (LED or-and Laser) light source for any number from one to N (N is any number)

7. The project assembly for (LED or-and Laser) light device as claim 1, the said (LED or-and laser) light source for light device which can create as many as different light functions while incorporate with circuitry, or-and IC, or-and control device so can change the multiple function from one to others function under pre-determined circuit and function design.

8. The project assembly for (LED or-and Laser) light device as claim 1, the said (LED or-and laser) light source for light device has at least one of control device which in group combination selected from switch, sensor, motion sensor, sound sensor, remote controller, IR or RF remote controller, power on-off change function system, wireless communication system, Wi-Fi & APP controller, Z-way controller, wireless controller.

9. The project assembly for (LED or-and Laser) light device as claim 1, the said (LED or-and laser) light source for light device which the light device is powered by the (1) AC; or-and (2) DC; or-and (3) backup battery or rechargeable battery; or-and (4) solar power module charge the inner energy storage device and energy device offer the power to garden light under. dark environment;

10. The project assembly for (LED or-and Laser) light device as claim 1, the said (LED or-and Laser) light source for light bulb incorporated with light device, the said light device's housing has built-in at least one of bulb female socket to receiving the (LED or-and Laser) bulb male bulb-base and the said light device is controlled by control device for desired light functions, effects for steady or changeable features.

11. The project assembly for (LED or-and Laser) light device as claim 1, the said (LED or-and Laser) light source for light device the said (LED or-and Laser) light source is changeable including (1) change to other light performance, (2) change to other taste, (3) change from seasonal/holiday performance to everyday illumination function; and-or (4) change from everyday application to seasonal/holiday performance; to save consumer pocket.

12. The project assembly for (LED or-and Laser) light device as claim 1, the said (LED or-and Laser) light source for the bulb applications, the said bulb has built-in more than one bulb-base which in desired combo-base which combine at least 2 different base selected from E-11, E-12, E-17, E-26, E-27, E-30 or other market available size base including screw base, bayonet base, twist-base, one more twist or rotating angle base.

13. The project assembly for (LED or-and Laser) light device as claim 1, the said light device is outdoor lighting which has more than one functions including (1) power fail, (2) warning light, (3) SOS help light to get people notice and get help, (4) flood warning light, (5) motion sensor security light, (6) night light, (7) photo sensor light, (8) burglar alarm light, (9) camera or video and image or-and sound storage light, (10) animal/wolf/bear/deer alarm light, (11) animal repelled light (12) light has siren device; to protect residence person or-and property safety.

14. The project assembly for (LED or-and Laser) light device as claim 1, the said the light device project at least one of the image or lighted pattern has steady or moving effects, performance including; (1) Holiday/Seasonal art; (2) (LED or-and laser) lighted image; (3) image has matrix or array arrangement; (4) single or multiple color of (LED or-and Laser) (image or-and lighted patterns); (5) words, character, logo, geometric arts; (6) Sports team sign; (7) commercial related data, image, art, slogan.

15. The project assembly for (LED or-and Laser) light device as claim 1, the said light device incorporate with Laser light source has built-in safety sensor to stop the laser beam while object/people is detected and get into safety range and the light device will shut-down the laser light source until the object/people is out and away of the safety range.

16. The project assembly for (LED or-and Laser) light device as claim 1, the said light device incorporated with Laser-Bulb as light source having built-in safety sensor to stop the laser beam while object/people is detected and get into safety range and the light device will shut-down the laser light source until the object/people is out and away from the safety range.

17. The project assembly for (LED or-and Laser) light device as claim 1, the said (LED or-and laser) light source for light device which having at least one function including (1) project image or lighted pattern for steady or moving effects; (2) Offer the illumination; (3) take photo or video at any time, or while sensor been triggered; (4) offer power to other device from built-in USB ports and related USB wire accessories.

18. The project assembly for (LED or-and Laser) light device as claim 1, the said light device is a one of indoor light device including night light, bulb with bulb-base, down light, room light, desktop light, seasonal/holiday light including light string; (or-and) is a one of outdoor light device including garden light, patio light, seasonal/holiday light including light string, camping light has at least one or more than one functions including projection, illumination, USB charging or be charged function, USB power bank function, power fail function.

19. The project assembly for (LED or-and Laser) light device as claim 1, The said light device is an outdoor garden light has required waterproof or-and anti-environment has installation kits to Insert into ground or sit on the surface of outdoor fields.

20. The project assembly for (LED or-and Laser) light device as claim 1, The said light device has groove, ditch, gap, slot, space to have wire arrangement for the said USB wire for charger or supply current to other device.

21. The project assembly for (LED or-and Laser) light device as claim 1, The said light device has groove, gap, slot, opening, ditch, holder to install the said be-charged device including portable phone, I pad, consumer electric device, computer device, communication devices which has USB charging related parts & accessories.

22. The project assembly for (LED or-and Laser) light device as claim 1, The said light device has desired outside shape for portable size products in order to make the said device can fix on position, change light beam emit direction, angle, orientation by its outside shape including but not limited for multiple cuts for one circuit into triangle, square, pentagon, hexagon, heptagon, octagon, nonagon, decagon, or any geometric shape with desired angle and height adjustable kits.

23. The (LED or-and Laser) light source for light device consist of;
At least one of (LED or-and laser) light source or (LED or-and Laser)-bulb which has strong light beam to create image or lighted patterns from 10 feet to 100 feet distance to be seen; and
At least one optics-assembly to create the lighted image or patterns has following arrangement:
   (1)At least one of tube; or tube-like piece; or cylinder shape tube; or-and housing parts to prevent light beam leakage out from garden light.
   (2)At least one of image forming-unit; or-and lighted pattern forming-unit; or optics-pattern forming-unit (optics-lens) fit within the said in-front of the light source(es) to get the lighted image or lighted patterns.
   (3)At least one of optics-elements for the light device top-cover which is one of flat piece; or partial round shape; or sphere; or dome shape has wider opening to allow inner light beam to pass through and show desired lighted image or-and patterns on surface which away from light device at least is 10 feet away to present lighted image or patterns for any wall, ground, floor, buildings, surface.
      The improvement;
      The said (LED or-and Laser) light source and the said (A) (B) (C) all fit into the space of the said light device and powered by AC; or-and DC; or-and solar power with energy storage system.

24. The (LED or-and Laser) light source or bulb for garden light consist of;
At least one of (LED or-and laser) light source or (LED or-and Laser)-bulb which has strong light beam to create image or lighted patterns from 10 feet to 100 feet distance to be seen; and
At least one optics-assembly to create the lighted image or patterns has following arrangement:
   (1) At least one of tube; or tube-like piece; or cylinder shape tube; or-and housing parts to prevent light beam leakage out from garden light.
   (2) At least one of image forming-unit; or-and lighted pattern forming-unit; or optics-pattern forming-unit (optics-lens) fit within the (A) and in-front of the light source(es) to get the lighted image or lighted patterns.
   (3) At least one of optics-elements for the light device top-cover which is one of flat piece; or partial round shape; or sphere; or dome shape has wider opening to allow inner light beam to pass through and show desired lighted image or-and patterns on surface which away from garden light and at least is 10 feet away to present lighted image or patterns for any outdoor wall, ground, floor, buildings, house, surface.
      The improvement;
      The said (LED or-and Laser) light source and the said (A) (B) (C) all fit into the space of the said garden light.
      The said garden light has qualified for certain degree of waterproof or-and anti-environment and has installation kits to Insert into ground or sit on the surface of outdoor fields and powered by AC; or-and DC; or-and solar power with rechargeable energy storage system.
      Not only these (22) features but also has the below (3) co-pending filing cases with same skill, concept, combination, method as below copy all original filing details description for examiner to review or cross-reference much easily and quickly.

Below is co-pending filing (#XXX-2) Detail description should still fall within the current invention claims:

The current invention for a safety laser projection light which has light beam blocking wall and safety sensor means to prevent people from directly looking at the laser unit's strong light beams to overcome all marketplace concerns.

The current invention also provides a combination of a laser projection light and built-in LED light source that serves as a night light to supplement the laser projection light function in case people do not want to see laser light performance, so that people can turn off the laser projection light and keep the LED night light on when plugged into an outlet, thereby adding practicality to the laser projection light.

The current invention also may apply a motor means, adjustable means, time piece parts and accessories, and/or motion means to cause the at least one laser, hologram, or grating means to change relative orientation, position, and/or distance and thereby cause the light beam patterns to change or vary for an eye-catching laser beam light performance.

As shown in FIG. 1, the laser projection light includes a laser unit (1f), circuitry (1g), prongs (1q) (1q′), and an adjustable means (1e) to change the relative orientation or position of the laser, a hologram, a grating, or other optics means and create changeable, variable, variety, plurality of the different laser light beams performance.

The laser unit (1f) faces upwardly while the prong means (1q) (1q′) face a rear side of the housing facing a wall outlet and a sensor lj, lens lm, and blocking wall (see element 2-2d in FIG. 2-2) are on the front side. The laser light beams will be blocked by the blocking wall so the laser light beams can only be emitted to a certain angle from the ceiling, which angle can be designed so people cannot directly see the light beams to harm their eyes. The safety sensor means (1j) senses people close to the projection light and stops the laser unit from emitting laser beams to provide protection that is in addition to that provided by the blocking wall.

FIGS. 2-1, 2-2, 2-3, and 2-4 show details of the preferred embodiment of FIG. 1, including a lens (2-1d) (2-2b), front housing (2-1a), back housing (2-1c) (2-2a), laser unit (2-1e) (2-4b), LED (2-1g) (2-2f) (2-3e), prong means (2-1f) (2-2c), safety sensor means (2-1b) (2-3b), blocking wall (2-2d) (2-4c) and photo sensor means (2-1b, 2-2d, 2-3b).

FIG. 2-5 shows the laser light beam performance provided the laser projection unit on walls and a ceiling. It also shows the sensor means to sense people close to the laser projection light. When people fall within the sensing range, the sensor will deliver an electric signal to circuit means to turn off the laser unit and stop it from emitting laser beams. This will prevent kids or people from directly viewing the strong light beams emitted by the laser unit, which would otherwise harm the people's eyes. The sensor range can be designed as required by the market. A preferred range is one feet, covering a vertical range of 45 degrees above and below the center and a horizontal range of 90 degrees or more to the left and right of center. In the meantime, the laser projects onto the wall into which the projection light is plugged and onto the ceiling, but part of the projection area is blocked by the blocking wall

FIGS. 3-1, 3-2, 3-3, 3-4, 3-5, and 3-6 show a second preferred embodiment with a different shape of the laser projection light but which still has a blocking wall (3-1g) (3-2s) extending on one side of the housing, a safety sensor means (3-1h) (3-2t), a top housing (3-1e) (3-2q), a lower housing (3-1d) (3-2d), an LED night light base with UL approval certification (3-1a) (3-2a), a built-in LED (3-1d′) (3-2e) that serves as a night light, a photo sensor (3-1c) (3-2c), switch means (3-1j) (3-2u) to turn off the laser projection light by manual operation, a laser unit (3-1f) (3-2m), circuit means (3-2j), conductive means (3-2i) (3-2g), a holder (3-2h), a lens (3-1d) (3-2d), prong means (3-2b), a battery compartment (3-1b) or other electric parts and accessories to cause the laser (3-1f) (3-2m) and LED (3-1d′) 93-2e) to provide two light sources in one unit. This embodiment may also include just the laser projection light without the LED. Optional added features include a hologram, laser, grating optics means and means to change the relative position and orientation of the laser unit by a motor means, adjustment means, movement means or other means to enable at least one of the optics means to change from a last position or orientation and create changeable or variable laser light effects.

As shown in FIGS. 3-1 and 3-2, the blocking wall 3-1g,3-2s extends into the wider projection area so as to block laser beams on side of the projection area. The blocking wall 3-1g,3-2s is on the same side as the sensor 3-1h,3-2t for turning off the light device in case someone enters the sensing area. An LED 3-1d′,3-2e is also provided to provide a night light function through housing part 3-1d,3-2d even when the laser unit 3-1f,3-2n is switched off by switch 3-1c,3-2c. As usual, the night light LED may be controlled by a light sensor 3-1cj,3-2u. Power may be provided by batteries, a transformer or adaptor, or, as shown in FIG. 3-2, prongs 3-2b.

As shown in FIG. 4 which disclosure the concept to apply the laser light for garden light which has laser light source and its preferred laser optics-piece or-and other optics-piece to put into outdoor garden light which has ground stack/pole to insert into the garden ground with waterproof or water resistance or any environment grade quality for outdoor use. The laser project garden light mainly to offer the laser light effects for building, house, home, walls, fence, garage door all wider areas with desired light effects. Which have to have a wider opening for the said Laser garden light which is same as the above listed (#ZZZ-3) The current invention is a Division filing from the co-pending filing or parent filing cases as below attached drawing and details which from(#ZZZ-3) the Parent filing case U.S. Ser. No. 14/503,647 filed on Oct. 1, 2014 which is CIP Filing of (#ZZZ-2013)Parent case U.S. Ser. No. 14/023,889 filed on Sep. 11, 2013 show more details for Wide Areas projection by Laser(s) or by LED(s) or combination of the Laser(s) & LED(s). From above discussed and illustration shown the wider opening for laser project garden light, project bulb, light string has laser project light unit(s) all same need a wider opening on the laser light emit ends so can allow Laser light beam widely spread out from the laser light beam output end(s). Also, need to incorporated the laser optics-piece including but not limited such as grating piece or hologram piece or-and to incorporate the other optics-piece including but not limited for convex-lens, diffusor-lens, random-diffusor lens, plurality different or variable thickness diffusor lens, reflective lens, refraction lens with single or multiple or plurality of different optics-focus and thickness in one piece as design or light effects required. From above discussed on (#ZZZ-3) and illustration on the background can see show many different optics-piece which also including the said cut-out, stencil, color filter, windows, opening, shaped windows or same functions or equivalent piece which the purpose is to create desired light effects and place top of the light source output end including laser light source or LED light source or other light source. These laser optic-piece or any other optics-piece mainly to make simple laser or LED or incandescent bulb to get desired light effects for certain range and distance to see the lighted pattern.

Also From the (#ZZZ-3) The current invention is a Division filing from the co-pending filing or parent filing cases as below attached drawing and details which from(#ZZZ-3) the Parent filing case U.S. Ser. No. 14/503,647 filed on Oct. 1, 2014 which is CIP Filing of (#ZZZ-2013)Parent case U.S. Ser. No. 14/023,889 filed on Sep. 11, 2013 show incorporate the moving device which including but not limited for motor, gear set, moving device, rotating device, spin device, movement or any moving kits to make the said optics-piece including laser optics-piece or other optics-piece or other cutout, plastic piece, injection piece, lens, film, slide, cutout, stencil, window, filter to moving to make the moving device. It also may incorporate with IC, timer, sensor, switch, controller, wireless controller, Bluetooth, wifi, internet, wired or wireless communication sets, ZigBee, Z-wave communication or controller, power source, invertor, adaptor, transformer, USB power parts & accessories, solar module, rechargeable batteries, wind power source, chemical power source to turn on and turn off the said laser light device for pre-determined functions.

The said Laser Garden light has at least one of color of laser light source, It may be two or three color or more color and has pre-determined turn-on and turn-off timing to create one or more color lighted spot, image, shape, matrix, array for any conventional laser image effects which may be a dot matrix, linear array, seasonal signs, characters, words . . . and it may get IC help to create flashing, chasing, random, Fade-in and Fade-out, pair flashing, dot-matrix, image matrix, image array with desired time period, duty, cycle, brightness, colors . . . etc.

While incorporate with moving device to create the changeable, variable, sequential change laser beam light show has moving effects and changeable features. It also can incorporate with other light source such as super strong LED light source to create the other light effects to combine with laser light beam effects to form the alive image which may look like moving aurora effects, galaxy, solar system, water wave, animation for all marketing available laser light show all these features as above listed all the co-pending or co-inventor all filing case after the current filing case parent filing case (#XX-2010) including the (#TT-2010) (#ZZZ-3) (#QQQ-3) (#II) (#II-1) (#II-2) family including the each family parent and child filing case. All these filing cases after 2010 filing (#XX-2010) and CIP or Division (#TT-2010) (#ZZZ-3) (#QQQ-3) (#II) (#II-1) (#II-2) family all related technical, skill, method, design, concept, construction, functions, features, parts should be still consider within the current invention scope for the current invention for (a) Garden light (b) light string (c) laser Bulb (d) Laser Night Light application and each of the current invention claims had very clear limitations for each (a) (b) (c)(d) has certain parts and accessories as below claim content.

From FIG. 4 can see the garden light has 3 color laser light source including Red color, Green color, Blue color and has the simplest laser optic-piece on front with IC or-and motor/movement device to make the multiple colors laser light beams to come out continue changeable, variable, sequential changing light effects to project the lighted dots, Shape image, matrix, array, shapes, character, words to remote away distance to cover big and wide surface of building, house, ground, floor, fence, walls, surface, wall, residence to present desired words, image, message, geometric image on the said wide areas. The said garden light has ground stake or pole which can insert into garden ground or install on the garden floor and has the power source which may connect with 120 Volt AC or get power from the invertor/transformer/adaptor or from the garden available for low-voltage power source which for the conventional low-voltage garden light. It also can be powered by the solar power source, wind power source, chemical power source with its rechargeable energy storage device maybe are rechargeable batteries. From FIG. 4 also show the wireless controller for preferred embodiment to control the light functions, brightness, color, timer, on-off even can control the sound while the said Garden light incorporated with the sound device, speaker, Radio, Bluetooth speaker or wifi speaker or other market available sound device. The said garden light also can have metal base or bracket to hold or install the said garden light on other application while the garden light housing redesign to make 360 wide opening like the said above discussed (#ZZZ-3) drawing it can fit into Camping light device so can allow people to carry while go to Camping and still has the ground stake/pole to insert into the camping campus ground for 360 degree or wide angle areas has laser light show for night time celebration or party. The camping light may have Bluetooth speaker, USB port so can rechargeable inner rechargeable battery or batteries and same time it become a Power bank to charge mobile phone, iPad, iPhone while power ran out. These application is CIP or Division for co-pending filing for (#GGG-2011) U.S. Pat. No. 8,783,936, (#GGG-1) U.S. Pat. No. 8,915,608, (#GGG-2) U.S. Pat. No. 8,9119,137, (#GGG-3) U.S. Filing Ser. No. 14/189,062, (#GGG-1C) Filing Ser. No. 14/548,561, (#GGG-2C) Filing Ser. No. 14/548,620, (#GGG-3C) Filing Ser. No. 14/643,026, (#GGG-4) Filing Ser. No. 14/189,062, (#GGG-4C) Filing Ser. No. 14/827,810, (#GGG-5) Filing Ser. No. 14/839,935, (#GGG-5-1) Filing Ser. No. 14/858,538, (#GGG-6) Filing Ser. No. 14/834,557, (#GGG-7) Filing Ser. No. 14/834,823, (#GGG-8) Filing Ser. No. 14/834,613, (#GGG-9) Filing Ser. No. 14/870,601, (#GGG-10) Filing Ser. No. 14/951,872 family has all details discussion for the USB charging port features and method to making same.

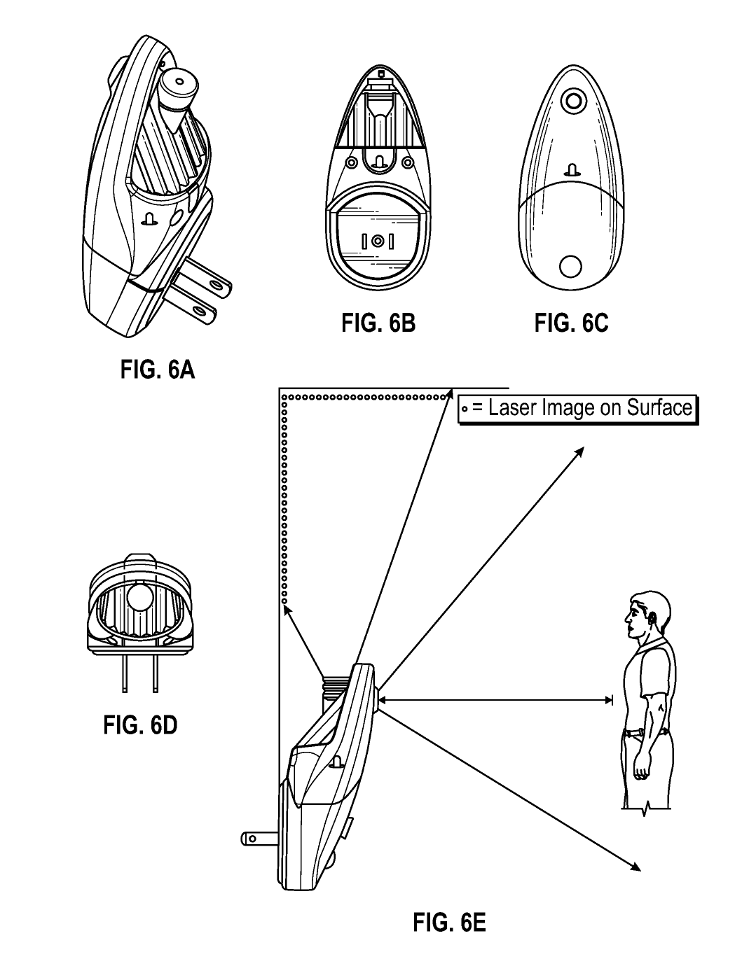

From FIG. 6A to FIG. 6G and FIG. 6A-1 to FIG. 6G-1 show the Laser project bulb for different construction. The inner parts & accessories for laser light source, laser optic-piece (grating or hologram or other laser piece), with or without motor is similar with the above discuss for FIG. 4 or the said all parent filing case and its CIP or Division co-pending cases. The Current from FIG. 6A to FIG. 6G mainly to show more optic-piece including but not limited including cutout, stencil, window (clear see though but not opening), filter, color filter, opening, plastic piece, reflective lens, refraction lens, convex lens, diffusor lens, variable thickness lens, plurality of focus lens, texture lens or all kind of plastic piece, film, injection piece, lens to increase the laser or-and LED project light performance, effects. From FIG. 6A to FIG. 6G show the all different lens and light top opening design. Laser light have to big and wide opening so allow all the laser beams can emit to all directions as many as possible. The preferred embodiment is 180 degree or can design for over 180 degrees up to 270 or smaller degree which depend on market requirement.

From FIG. 6A to FIG. 6G also show the Laser project has above discussed preferred parts and accessories inside the housing with the bub-base which can be any type of market available type for different bulb-holder for different shape/size bulb shape for different lighting fixture used. Furthermore, the current invention show the variety preferred more than 1 optics-lens, optics-piece, optics-cover to add top of the said inner laser light parts & accessories to create more eye-catching light performance. Such as FIG. 6D just has windows, FIG. 6E has the plurality of reflective properties lens. FIG. 6F has plurality of round diffusor lens into one-piece optic-cover to make inner laser light beam to become aurora effects, some other laser light is passing though from clear window which has no plurality of round diffusor lens so it only passes through inner laser-optic piece such as grating piece so can get plurality of lighted spots or matrix or array look like planets for different colors so can make like galaxy look-like effects. The FIG. 6G show the optics lens install on moving disc so can make the lighted image to moving for certain degree arc or circles on surface . . . . It maybe many tubes and limited optic-lens which has more details description and skill on co-pending filing (#QQQ-3) US filing Ser. No. 14/983,993 filed on Dec. 30, 2015. From FIG. 6A show the movable or tilt able LED project Bulb which can move the top level for projector away from top block means which may desk lamp top metal frame or shade frame/support so the laser or LED projector Bulb can overcome the block metal frame, metal shade support for desk lamp. From FIG. 6B is LED bulb for recess light or ceiling installation which is not like for Desk lamp has block metal frame or metal shade support, so no need tilt or movable along the axis to let project light beam do not block by the metal frame of metal shade support of desk lamp. From FIG. 6C show the project Bulb which has changeable slide, laser film, grating film, hologram film or other optics piece or slide, film, display piece on the roller which can use manual or automatically change so can different light effects. From FIG. 6D, FIG. 6E, FIG. 6F, FIG. 6G show all has wide opening on front of laser project bulb because need to have Bigger and wider opening so can allow all laser light beam spread out to wider areas. From FIG. 6A, FIG. 6B, FIG. 6C show the LED project Bulb which the top of the Bulb has Lens-size opening normally is as smaller as possible because it will affect the cost for the inner image-display/film/slide and inner other optic-lens such as convex lens or concave lens if had any and inner tube diameter and size. So LED project bulb top lens is as smaller as possible so can make low cost unit. So Laser and LED project bulb has major different construction but the current invention all is CIP or DIV for (#XX-10) filing and has more details can see from above listed co-pending parent filings cases.

From FIG. 6A-1 to FIG. 6G-1 show the housing shape with bulb-base to allow all Laser or LED project bulb fit into relatively Bulb-holder. The bulb shape for laser bulb need as big & wide as possible to allow all laser beam emit out. The LED project bulb top end only need have magnify lens size so it is smaller as possible to save cost. The regular LED bulb or Incandescent bulb or other light bulb for illumination purpose no need any opening because it glows for all direction as radiation light source. Not like Laser light source or LED light source belong to point light source so need laser optic-piece or other optic-piece to help to get the laser or LED narrow light beams to spread out to have desired light performance and effects.

From FIG. 5 show how to apply the FIGS. 6D, 6E, 6F,6G laser project bulb and FIG. 6A, FIG. 6B, FIG. 6C laser project bulb to apply the said market all kind of light string same as co-pending (#TT-10), The co-pending case (#TT-10=Laser or-and LED for all light device has project functions) (#ZZZ-3=Laser or LED for wide areas projection) (#II-09=Light string with project function) (#II-1=Light string with project function)(#II-2=light string with project function)(#QQQ-1=LED bulb has project functions) (#XX-10=Laser project light for all kind of lighting) also show the variety power source and linkable functions show as below drawing which is one of the example of these power source and one of the linkable example it is appreciated all kind of market available power source and linkable skill still fall within the parent and current filing cases that including but not limited for any AC or DC or solar power source(s) and linkable by quickly connector, plug, receiving ends and insert ends and all market available parts & kits.

The current invention to add the laser project Bulb with desired construction into the market available all kind of light string for everyday use for patio, backyard, BBQ areas for nighttime activities or Camping campus use. The current invention uses the similar of FIGS. 6D, 6E, 6F, 6G for wide opening laser project Bulb has inner at least one or more of the same color or different colors laser light source and its related laser-optics piece or piece(s) with or without added other optics-piece to get desired steady or movable or changeable or variable lighted image, message, dots, shape image, contour shape, array, matrix light effects. The laser or LED project Bulb it may not need bulb-base and the laser project light or LED project light can be install within the molded base by preferable parts for the said molded light string or has the bulb-base to let the said light string can replace the illumination bulbs (incandescent bulb or LED bulb) and-or laser project Bulb and-or LED project bulbs.

Because laser or-and LED project Blub or light is very costly so current invention preferred just use limited number of the Laser or-and LED project bulb or light for the existing illumination purpose light string including every day or seasonal light string. For example, 10 light string maybe only add 2 for laser or-and LED project bulb or light, so the cost is not dramatically too high. However, some application has very long light string in one piece such as 36 feet or 48 feet which can have more unit such as every 6 feet has one Laser or-and LED project Bulb or light unit on the whole light string. Some short items have big space between each illumination bulbs so can have whole string with laser or-and LED project bulb. The number of laser or LED project bulb or light depend on market requirement,

While the everyday light string or seasonal light string has limited number or whole light string has all laser or-and LED project bulbs or units can make a big light performance than the current only illumination purpose for these light string. Furthermore, if add the laser project bulb(s) or unit(s) on the light string. The wide area will be lighted by the eye-catching, splendid, colorful, changeable, variable lighted spots, image, shaped image, words, message to increase accent and decoration the backyard, garden, patio, BBQ areas or other areas, space people have night time or dark environment activities.

So the current invention for the FIG. 5 show the very exciting light strings for everyday light string which use incandescent or LED light source or other light source to offer illumination but also has laser light beam light effects or-and LED project light effects is the big improvement than single offer illumination singles one functions light string for more value.

From the CIP or Division filing after the parent (#XX-2010) and its Child filing (#XX-1) U.S. Filing Ser. No. 14/844,314 filed on Sep. 3, 2015 and parent filed case (XX-2010) U.S. filing Ser. No. 12/938,564 filed on Nov 3, 2010 now is U.S. Pat. No. 9,239,513. See FIG. 1 and FIG. 2 and FIG. 3 and FIG. 4. And later filing cases including but not limited for co-pending case (#TT-10=Laser or-and LED for all light device has project functions) (#ZZZ-3=Laser or LED for wide areas projection) (#II-09=Light string with project function) (#II-1=Light string with project function)(#II-2=light string with project function)(#QQQ-1=LED bulb has project functions) has details discuss the said how to connect the project light or project Bulb by the clipper, holder, hook, frame, snake hose, flex-n-hold, bar, fix device, connector, snap kits to hold, fix, position, the said laser or-LED bulb or light-unit on the light string and can position the direction for the laser or LED light beams to emit to desired areas and direction. The said Laser or-and LED bulb or light-unit for the market available all kind of light string with positional kits help to let laser or-LED project light can emit to desired wide or near-by areas is the 3^{rd} application for current invention as above illustration with some examples show but not limited for all above listed co-pending case or after (#XX-10=Filed Nov. 3, 2010) all filed cases concept, idea, construction, features should be fall within the current invention scope and spirit should be missed for laser project light for (a) Garden light (b) Laser project Bulb or light unit (c) Laser project bulb or light unit for all kind of light string (d) laser project for Night light application for indoor and outdoor use.

Below is co-pending filing (#QQQ-5) Detail description should still fall within the current invention claims:

From the above background and drawing discussion, the current invention for LED night light or LED Bulb can present a continue moving big projection image to move within certain degree from appear to dis-appear for angle or-and present multiple big project image on the surface at the same time.

The current invention co-pending filing cases already made a big improvement than conventional market available all kind of LED night light or-and LED bulb which only can offer near-by areas illumination not like the current invention NOT ONLY has more than one levels, parts, accessories can change position by moveable-means to make the inventor's LED night light or-and LED Bulb can overcome all kind of block-means which may happen by the following situations but not limited to:

(a) heat created by LED(s) or its circuit, electric components

(b) light beam block means to affect or interfere light traveling

(c) signal block means to affect or interfere all kind of electric signal transmitting

(d) other block means to destroy the said LED desire functions, performance, effects

But also inventor's LED or-and laser night light, LED or-and laser bulb, LED or-and garden light can use for one LED or-and night light, LED or-and laser bulb, LED or-and laser garden light to offer near-by and far-away illumination or image or both and the said night light or bulb or garden light. It also can have other features such as

(1) Multiple colors with changeable colors and moving effects

(2) Multiple functions select from market available any LED or-and laser light effects for indoor and outdoor lighting

(3) Multiple control means which select from market available control, sensor, switch, blue-tooth, wifi, internet, app software, remote, infra-red or other electric or electronic related circuit or device(s) (4) More than one movable-means

(5) Changeable geometric shape

(6) Changeable construction

(7) moveable means select from any group combination from bar, pole, spin, rotate, hinge, arms, joints, join, frame, connector, sections to make the levels, parts, accessories to be move away to desire location, positions. These are the main features of the current invention.

The co-pending filing cases already made said LED or-and laser Bulb, LED or-laser garden light has more than one level(s) and has desire level(s) can change position, location, orientation to overcome any block-means to get the desire LED or-and laser functions by variety type of moveable-means.

Also, the current invention as co-pending filing cases has light beam emit out from LED or-and laser light source that has at least one of desire control kits selected from power failure, remote control, Infra-red controller, blue-tooth with mobile phone, Wi-Fi, internet control, app software control, motion sensor to trigger light beam to offer illumination or image or lighted patterns with moving or steady effects to area(s).

Also, the co-pending filing cases also has other (16) features as below listed:

Features 1: The LED bulb is consisting of:
At least one LED(s) as light source of said LED bulb which emit light beam to desire areas, locations with predetermined illumination, function, time period, performance.
The said LED bulb has parts or accessories for desire group combination select from optic means, lens, adjustable focus means, twisted means, rotate means, elastic contact end, more than one output light beam(s), rotating frame, bulb shade with arms for rotating/tile, more twist bulb base, support for shade, LED assembly, LED tubular means, adjust means, project means, digital data display means, LCoS display means, LCD display means, digital camera means, data storage means, data been projected by optics means, sensor means, switch means, IC means, circuit means, extend means, extractable means, filter means, stencil means, cutout means, painting means, motion sensor means, Remote control means, blue tooth means, Internet wireless means to make the said LED bulb emit the light beams, image, time, data, digital message, internet data(s) to desire near-by area(s) or remote-away distance area(s) for illumination.
The said LED bulb connect with power source by contact means of base in preferred construction and configuration and incorporate with electric parts & accessories to emit the light beam(s) to areas with adjustable angle cover preferred in x-y-z axis or any combination as required for preferred light performance, effects, functions.
The improvement including:
At one of the output light beam(s) from the said LED bulb can adjust direction to certain area(s), location(s), distance(s) while adjust above listed component(s) of said LED bulb.
The said base of LED bulb is mail insert means to fit into the female receiving means for desired construction.
The said LED Bulb at least has adjustable parts to make the said at least one of light beam can change position, direction, orientation.

Features 2:
The LED Bulb as above listed (Feature #1), the said elastic contact means which allow the said LED bulb can adjust the said at least one of the light beam can be position, location, direction to certain area(s) in x-y-z axis.

Features 3:
The LED Bulb as above listed (Feature #1), the said extendable, extractable means which is The parts can be extend away from the said LED Bulb and has certain configuration and construction to allow install some electric parts & accessories, sensor means, motion sensor means, remote control means, heat sensitive means within so can overcome heat, light's shade, light's lens, light's curtain, light's glass, light's cover, cavity's depth, or any other block means.

Features 4:
The LED Bulb as above listed (Feature #1), the said same light beam can incorporate with Optics means, optics lens, optics lens assembly with parts & accessories to make the same light beam has different light performance. Features 5: The LED Bulb as above listed (Feature #1), the focus adjust means can make same light beam to present different light performance on the certain location, position, area for desire brightness, size, performance.

Features 6:
The LED Bulb as above listed (Feature #1), the said Bulb's frame, support or arms or bar or bendable tube which offer the Bulb can be twist, tilt, rotate, spin, adjust angle and also has hold means to overcome any heat issues to make the said change desired angle.

Features 7:
The LED Bulb as above listed (Feature #1), the said Base of LED bulb can be in any construction including screw type, pins type, poles type, multiple poles type, twist type, bayonet type, conventional market type for current invention.

Features 8:
The LED Bulb as above listed (Feature #1), the said More than one light beam output(s) which means the said LED bulb has more than one of the light beam(s) are emit to the location(s), area(s), position(s) which is remote-away from the said LED Bulb.

Features 9:
The LED Bulb as above listed (Feature #1), the said LED assembly, LED tubular means, Project means the construction, parts & accessories which for LED light source so can make the certain LED(s) light beam do not leakage out and passing though the said optics means, optics lens, display unit, image, LCD display image, LCoS image, digital display can be emit out of said LED Bulb to get light beam or image to desire location, position, areas.

Features 10:
The LED Bulb as above listed (Feature #1), the said sensor means, switch means, motion sensor means, remote control means, blue tooth means, photo sensor means or other market available electric parts & accessories incorporate the circuit means to make the said LED light source to emit light under predetermined light function, performance, effects.

Features 11:
The LED Bulb as above listed (Feature #1), the said extend means, retractable means can install the select electric parts & accessories, also the LED light source depend on the LED bulb application including up or down or horizon arrangement.

Features 12:
The LED Bulb as above listed (Feature #1), the said LED Bulb can illuminate the areas including any combination of areas(s) which are near-by area(s), far-away area(s) or together for both near-by and far-away area(s) effects.

Features 13:
The LED Bulb as above listed (Feature #1), the said LED bulb has more than one functions not only offer the illumination for near-by area or remote-away distance area(s) but also may incorporate with motion sensor, remote control, blue-tooth for other functions.

Features 14:
The LED bulb consist of;
At least one LED bulb which has at least one LED(s) as light source to offer the illumination or image while the light source is connect with related circuit means, IC means, electric parts & accessories and related switch means, sensor means, remote control means, blue-tooth means or equivalent trigger means.
The said LED Bulb has extendable means to install the electric parts & accessories, extra LED, sensor means, control means, RF receiving means, IR sensor means, or other equivalent control means to overcome the LED(s) heat, or surrounding block-means of lighting fixture shade, cover, glass, frame, support, ceiling, wood piece, metal piece, plastic pieces.
The said extend means can extend to certain distance to away from LED(s) heat or any block-means to allow the light beams or electric signal delivery direction without interfere by surrounding heat and block-means to let said LED bulb can have pre-determined function(s), Performance(s), Effects(s).

Feature 15: The LED bulb consist of:
At least one LED bulb which has at least one LED(s) as light source to offer the illumination or image while the light source is connect with related circuit means, IC means, electric parts & accessories and related switch means, sensor means, remote control means, blue-tooth means or equivalent trigger means.
The said LED bulb supply the illumination or image to a remote-away areas(s) by angle, position, orientation, direction, focus adjust means while incorporated with optics means, optics lens, project assembly, LED(s) assembly.
The said LED bulb emit the light beam to desire area(s) in preferred combination of near-by illumination, far-away illumination, near-by image, far-away image, digital data image, movie image, internet digital data image, time display, motion picture image, colorful image.

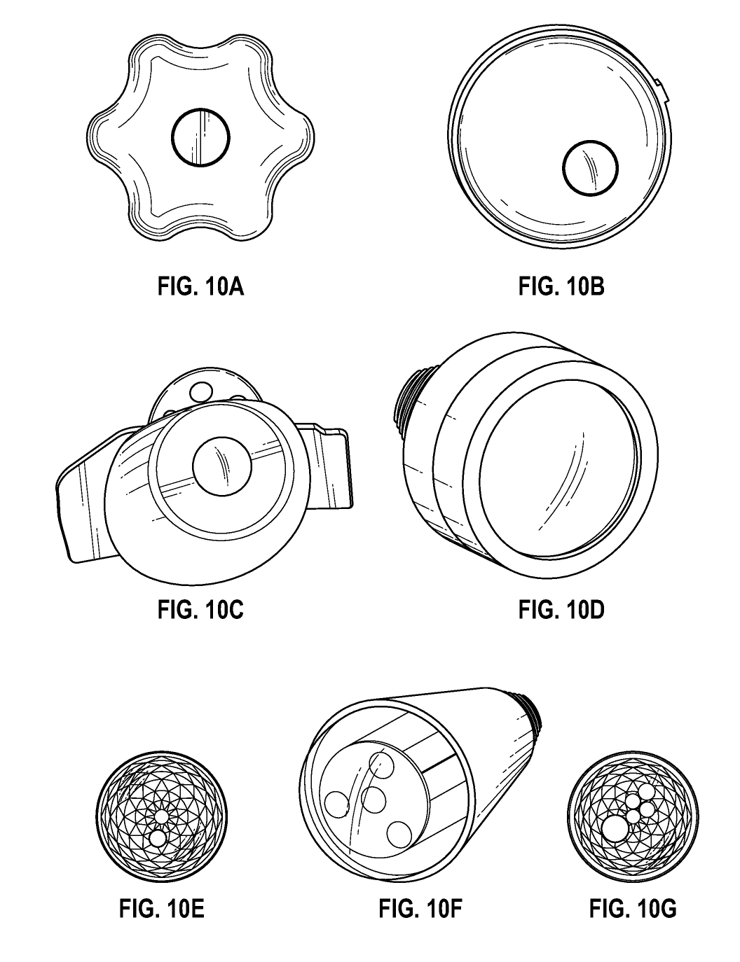

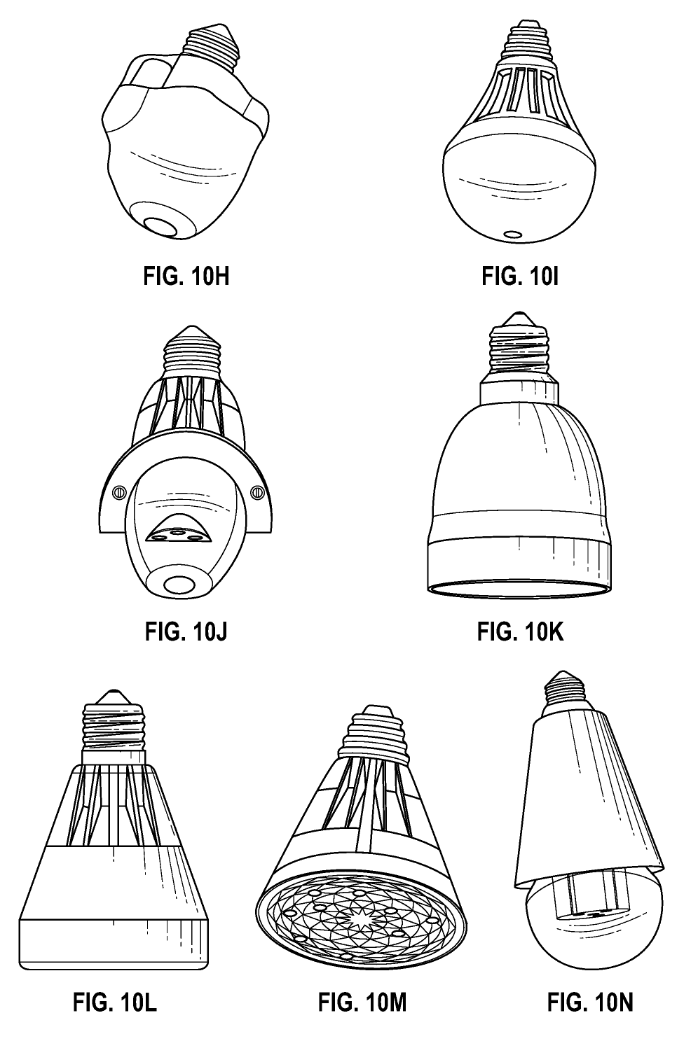

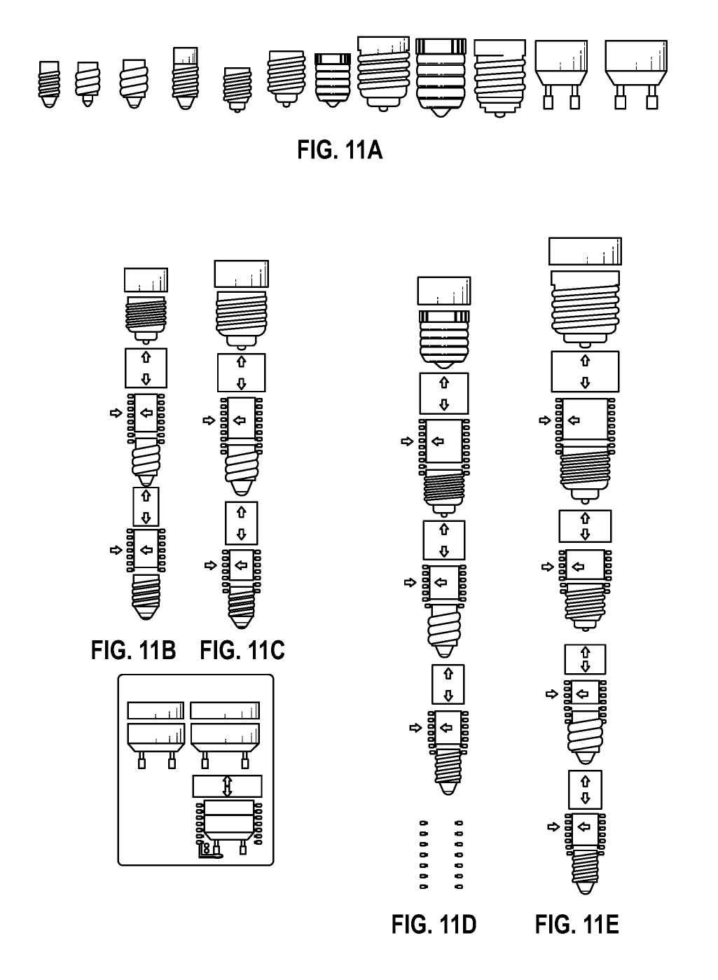

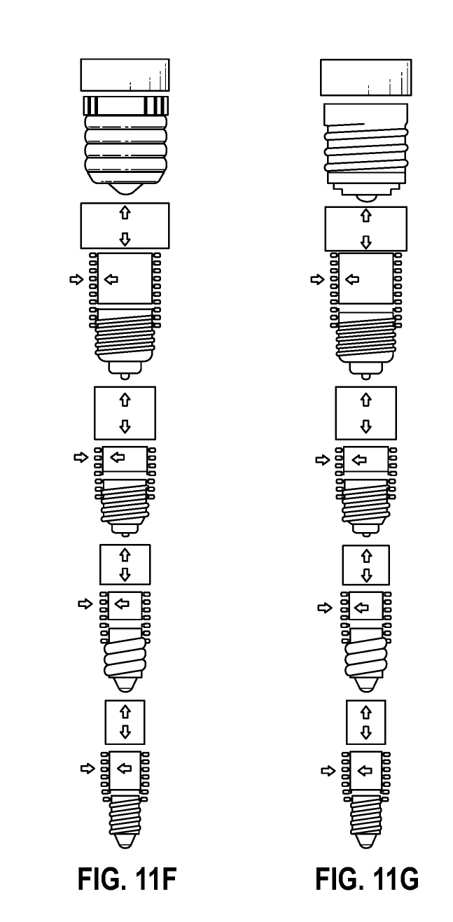

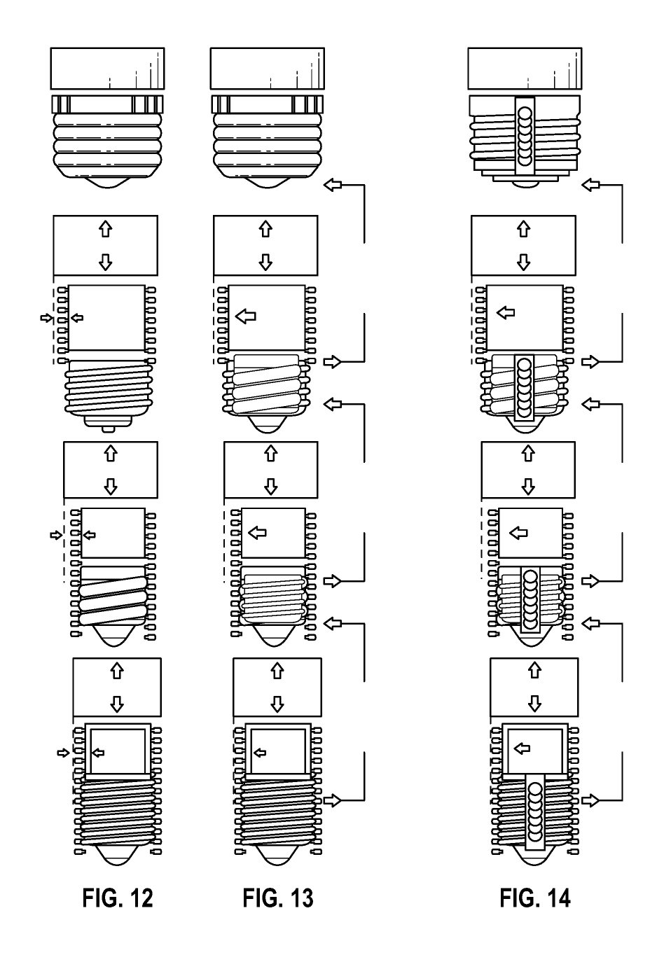

Feature 16:
The LED bulb consist of;
At least one LED bulb which has at least one LED(s) as light source to offer the illumination or image while the light source connects with related circuit means, IC means, electric parts & accessories and related switch means, sensor means, remote control means, blue-tooth means or equivalent trigger means.
The said LED Bulb has more than one of light beam emit out from the said LED bulb for illumination or image.
At least one of the LED light beam are triggered by control means which may select from group combinations from motion sensor, remote control, Infra-red sensor, Bluetooth means, power failure means & build in Direct current power storage means, sensor means, switch means, or other electric parts & accessories means.
The current invention has very details notes on each drawing so here do not discuss details, please refer to attached drawing with brief description below:
FIG. 1 and FIG. 2: Disclosure the 1^{st} embodiment of the said project image main construction for LED night light or LED Bulb has LED light source(s) (01), image carrier(s) (02), project-lens(s) or project-lens assembly (03) to form the big project image (not shown) on desired location and emit out from the said LED night light or LED bulb. All the current invention or the co-pending applications of the said projection LED light all still use the optic theory of the FIG. 10 and FIG. 11 and FIG. 12 only different for the three main projection theory 3 major parts LED light source(s) (01), image carrier(s) (02), project-lens(s) or project-lens assembly (03) put on different location, has different construction, arranged fit on tube or housing parts, incorporated with IC or desired circuit, has motor/movement/spin/rotating device to make the said 3 major parts to change position, or has track, groove, ditch to make the manual or automatically adjust the optic-lens to adjust the focus, has moving parts to allow adjust the project image angle or other features listed or discussed inside of all co-inventor's earlier applications cases.

From FIG. 1 the said Movement (05) which is super silent noisy device which has axis (06) has elongate length to install the LEDs (01) its base circuit board which connect with the PCB (04′) which has the electric parts & accessories to control the LEDs to has desired function including chasing, random, pair flash, sequential, random flash, fade-in and fade-out or any LEDs light function available from market place .The LEDs position with the top position-board (08) which has walls can fit with the preferred or optional other optic-lens which main purpose is to make the each LED's narrow LED light beam to become wider viewing angle LED light beam so can cover to the as wider as possible wider range light beam can emit to the said image carrier(02) so can get shaped light beams to pass through the opening(s), printed window(s), cutout(s), films, slides on the said image carrier (02). The shaped or tiny image light beam out from the said image carrier will emit to the said top project-lens or project-lens-assembly (03) which can be a single project lens (03′) or plurality of the optics-lens from into one assembly (03). The project-lens or project-lens-assembly (03) has at least one optic properties is the refraction the shaped or tiny-image light beam to wider viewing angle image has the desired brightness, color, image, shape, moving. The said big or wider viewing angle project-image (not shown) show on the certain distance away from the said LED night light or from the same construction put inside different outside housing such as into a LED bulb shape and connect with the power source from the LED bulb's base which may be an update retractable contact point allow people to twist one more or more circles to let the can have desired position or orientation.

From FIG. 1, the Axis (06) of the movement (05) extend to top and install LEDs (01) and circuit board and top position board (08) with wall to install the optic-lens (09) and all these parts including LEDs (01), circuit board, top position board (08), optics-lens (09) all is not rotating for this embodiment. Only the image-carrier (02) is moving, rotating, spin with the said movement (05) axis (06) and speed can be design as wish. The moving image carrier (02) will allow the below LED(s) (01) light beam to pass through the different portion of the said image carrier (02) and the shaped or tiny-image light beam will be come out from the openings, cutouts, film, slide, printed windows to emit to the top plurality of optics-lens-assembly's (03) big viewing angle from more than 90 degree to 270 degree project-lens so can project a super big size of the project-image on the desired surface including ceiling, walls, floor to show out moving effects or the said shaped or tiny-image light beam out of the said image-carrier. The said FIG. 1 shaped or tiny-image light beams while pass through the top plurality of optic-lens assembly project-lens which will be refracted the all shaped light beam to random directions with different shaped light patterns while the image carrier has shape openings or cutout or printed windows not film or slide so it look like the aurora effects with moving effects which are created by the moving image-carrier one of the application not limited to for other or alternative or equal construction to make the image-carrier to be rotated, spin, moving.

From FIG. 2 very similar with the FIG. 1 but the rotating or moving unit is the said Top Project-lens or project-lens-assembly (03′) not the said Image carrier (02′). The different arrangement or rotating unit from the image carrier (02) to change to project-lens or project-lens-assembly (03′) will form the different light effects. To rotating the project-lens or project-lens-assembly (03′) will get the shaped or tiny-image out for the image-carrier to pass through the top each single optic-lens of the multiple optic-lens assembly so can get one by one image on the different location and look like continue image moving for certain degree such as 6 optics-lens assembly can get around 60 degree moving image. This has details design description on the FIG. 6. Same as FIG. 1, the FIG. 2 embodiment has the 3 major components for LEDs (01′) and Image-carrier (02′) and Project-lens-assembly (03′) all fit along with the below motor (05′) and motor gear set (05″). The motor has very faster rotate cycles per minutes (RPM) so need one motor gear set (05″) to reduce to preferred RPM so people will not see too quickly rotating or moving project-image feel bad. The LEDs (01′) fit on the circuit board and LED(s) light beam emit through the optional position board (08′) or other design frame(F), support (S), holder (H) or has the other optics-lens (not shown) to make the narrow LEDs light beam to become wider viewing angle LED light beam and pass though the said the top of the LEDs position board (08′) has the image carrier (02′) which same as the FIG. 1 has the preferred shaped openings, cutouts, stencils, film, slide, display-unit so can allow the LEDs light beam to pass and emit the said shaped or tiny-image light beam to the said each single project-lens(03″) to form the image and because the each single project-lens (03″) is rotating so the shaped or tiny-image light beam will go though one by one of the single optics-lens (03″) to form the image on different timing and angle so can form a continue same big project-image shown on the surface.

From FIG. 2, to rotate the said project-lens or project-lens-assembly (03′) which has number of the single optic-lens (03″) and while the shaped or tiny-image light beam has sufficient wider angle so can pass through the many of the said the single optic-lens (03″) because optics-lens is rotating so the image will be same and the look like same image continue show up and moving from one circle side to other circle side. The moving direction can be clockwise or anti-clockwise which depend on the below motor or movement or spin device rotation direction. The number of the shape or opening or cutout or printed window or film or slide or the display-unit and its related LED number to form the lighted shape or tiny-image light beam also will get the number of big project-image.

More detail for the moving Project-lens or project-lens-assembly (03) for lighting effects shown on the FIG. 6 with more details.

From FIG. 1A show the co-pending filing case with the alternative way to create a wider viewing angle project-image on the surface. This embodiment use more than one optic-lens has at least one is refractive lens to make the LEDs light beams to pass though the 1^{st} lens to get narrow LEDs light beam to become many of refraction light beams and the said many refraction light beams go through the outside 2^{nd} lens to make the wider viewing angle project-images. The said 1^{st} lens may also has texture which can be a wave type and the LEDs can be more than one of Blue-light and Green-light or white-light LEDs with IC controller to make the said LEDs color changing on desired time period with desired functions and speed and brightness may select but not limited for fade-in and fade-out, chasing, pair-flashing, random, automatically changing function, freeze function, sequential or other market available LED light functions still fall within the current invention's scope.

The FIG. 1A, the blue, blue, blue color 3 LED light beam emit to the wave texture optical lens which is has received all the LEDs light beam and go through the Wave texture refraction optic lens so came out many of the light beam and pass though the 2^{nd} lens then can come out a lot of wave shaped blue, green, white project image. While the blue, green white LEDs are turn on and turn off on different time period and from 1^{st} Blue→2^{nd} Blue→3^{rd} blue with preferred fade-in and fade-out sequential, and LEDs arrangement with 1→2→3 front and back, then, can create the moving water wave effects so this is use non-motor device to make a big viewing angle moving project-image is the one of the current and co-invention application features and should be fall within the current invention for moving project-image scope.

From FIG. 1B and FIG. 1BB which FIG. 1B show the outside shape and FIG. 1BB show the details construction how to make the moving project-image like the said Aurora as the said preferred embodiment of FIG. 1. The said FIG. 1 has the top wide angle around 180 degree project-lens which are formed by plurality of small optic-lens like FIG. 1 and each small optic-lens has its focus and thickness and curvature of the lens so can make the different reflective, refractive light effects. The said inner construction as the above discussed FIG. 1, the main 3 components LEDs, image-carrier, project-lens-assembly as above discussion. The current invention and all the FIG. 1A, FIG. 1B, FIG. 1C, FIG. 1BB, FIG. 1CC has prongs to become a big viewing angle projection night light while the same construction of the major 3 components fit into the Bulb shape housing with bulb-base can instantly become the LED Bulb has the moving project-image LED bulb. The power source come from wall outlet or from the bulb-base power source just through the different conductive prong or conductive bulb base. So all the current invention coverage for LED plug-in night light or the LED bulb with conductive bulb base for all kind specification should be still fall within the current invention. So all the preferred embodiment has prong is equal has the bulb base. The housing can be any geometric shape.

From FIG. 1C and FIG. 1CC is outside shape and details construction show the other alternative way to get the moving project-image for LED night light or the LED bulb. Again, this is same as Co-pending filing case (#ZZZ-3) U.S. application Ser. No. 14/503,647 which apply the same 3 major components LEDs (01″) , image-carrier (02″) , and Project-lens assembly (03″) to form the big viewing angle project-image by electric magnetic force to pull or push the vibration, shaking, swing, waving, moving part (02B), arm (02B), pole (02B), craft (02B), axis (02B), bar (02B), pole (02B) connect with magnetic unit (02A) which will be affect or reaction to the said magnetic-coil device (02E) while the different current passing through the said magnetic-coil (02E) to create magnetic field and force to pull or push the magnetic-unit (02A) for close or pull away. So the magnetic-unit will bring the attached, connected, joint-together said moving part (02B), arms (02B), pole (02B), craft (02B), axis (02B), bar (02B), pole (02B) to be waving, shaking, swing, moving to make the 1^{st} optic lens or image-carrier (02″) has texture or without texture to be change position to make the said desired light effects. The said Moving parts (02B) is attached on the 1^{st} optic-lens or image carrier (02″) two sides pole (02C) while the moving parts (02B) is moving and the two sides pole (02C) sit on the two side frame (02D) will be also change position so make the said 1^{st} optic-lens or image-carrier (02″) moving so make the image carrier 1^{st} optics-lens to emit the different light beam to the top project-lens and form the big viewing angle project image on the desired floor, ceiling or walls but not shown on the wall where has the outlet or surface has the bulb base.

From FIG. 3, FIG. 3A, FIG. 3B, FIG. 3C, FIG. 3D, FIG. 3E, FIG. 3F show the co-pending filing all kind of preferred LED bulb designs and shape. The inner may have the desired moving optics-lens, moving image-carrier, different LED turn on and turn off time, magnetic reaction force device, or single project tube device, or multiple single project tube device, or project assembly inside these housing to get the wide viewing angle moving project-image show on the surface.

From FIG. 4 and FIG. 4A, FIG. 4B disclosure the Co-pending Filing (#ZZZ-12) U.S. application Ser. No. (#ZZZ-1) Ser. No. 14/323,318 and (#ZZZ-12) Ser. No. 14/023,889 those drawing show the 1^{st} embodiment to use the said motor (05-4A) to drive the axis (A) to rotating the top project-lens which has multiple refraction or-and reflection lens to allow the inner LEDs (01-4) (01-4B) to passing though the multiple reflective or-and refractive lens to spread out the different turn on and turn off LED color light beam to wide viewing angle for moving project-image. The each of color of the said LEDs (01-4) and (01-4B) can be different color and turn on and turn off controlled by IC so can had all kind of light effects including chasing, random, pair flash, fade-in and fade out, sequential, color changing, freeze function, auto changing function, 7 function in 1 or any other available function from market place.

The FIG. 4, FIG. 4A , FIG. 4B also has circuit (C-4) (C-4A) (C-4B0 and motor's gear set (05′-4) (05′-4A) (05″-4B) so can get desired rotating speed of axis (A) to drive the top multiple reflective or-and refractive dome lens can rotating under predetermined speed to make people enjoy the moving and changeable color, function light effects from the said current invention for LED Night Light or LED Bub while the same construction fit into the plug-in Night light or fit into the said Bulb shape with the bulb base to get the Power source.

From FIG. 5A disclosure the Same construction with the FIG. 2 which has the Moving or Rotating optic-lens-assembly (03D) which has the 6 of the single optic-lens (03-1) which can project the shaped or tiny-image light beam through the refractive lens (03-1) to become big project-image shown on the desire surface. The current invention has the 6 single optical-lens arrange within a frame (F) for 360 degree so each single optic-lens (03-1) almost cover the 60 degree of the said frame (F). So the wide viewing angle project-image will move so around 60 degree for circle range while the top project-lens-assembly each single project lens take 60 degree, then the big project image traveling will be around 60 degree. The said LEDs (01-1) has narrow viewing angle so may have optional Optic-lens added like FIG. 5B (02-2) to let the narrow light beam become wider viewing angle light beams or add the distance from the LED top to the image-carries but it will be loose some light brightness. While the LEDs light beam emit to top the said image carrier (02-1) through the image carrier's (02-1) openings, printed windows, stencils, cutouts, films, slide, display-units or changeable image or display, the said lighted shaped or tiny-image light beam will emit to top single optical-lens (03-1) fixed on the said frame(F) of the said projection-lens-assembly (03D). The wider viewing angle the said shaped or tiny-image light beam go through the said each single optics-lens (03-1) and form the image because all the optic-lens (03-1) is rotating one by one so the each of single optic-lens image will look like a continue one image to moving from circle one side to other side for certain degree depend on the each of single optic-lens (03-1) occupy how many angle of the said frame (F).

The FIG. 5A, the image carrier (02-1) has 4 shaped opening, holes, cutout, printed windows, film, slide, display-unit, changeable display windows so can project 4 different images if had relatively LED for the said 4 different tiny-images that is openings, holes, cutout, printed windows, film, slide, display-unit, changeable display windows to create the 4 big project-image and rotating on all same direction or desired directions.

From FIG. 5A the LED (01-1), Image carrier (02-1), project lens assembly (03-1) and single optics-lens (03-1) and motor (05A) and Gear set (05″-1) all fix along the axis (A) with desire frame (F) or fix on the housing parts (not shown) so whenever the outside housing changed the current invention can be for LED night light or LED bulb and each had its prong or Bulb base to get the AC power.

From the FIG. 5B same as the all co-inventor and co-pending LED project light has the same LEDs(01-2) and image-carrier (02-2) and Project-lens assembly (03-2) with single optic-lens (03D) and only the said project-lens-assembly is rotting along the axis (A) with tube or tube assembly to install the said other optional optic-lens to wider the narrow LEDs light beam and also use the tube or tube-assembly to prevent from the light beam leakage so can concentrate all LED wide light beam to cover as many as single optic-lens. Or/The Tube or tube-assembly it is an optic-lens to make the narrow LED light become wider and also can prevent from the light leakage through the wall of the said Optic-like Tube or tube-assembly. This depend on the market requirement so this FIG. 5B is for just concept for optic-like tube means which can be in any shape such as wider top and narrow end type of optic-like tube or tube-assembly (Not shown).

From FIG. 5C show the alternative way the image-carrier is a film or slide which fit into the optic-like tube or tube-assembly which may straight or wider-top-narrow-base optical-tube which has reflective material coated outside so no light can leakage to outside and LEDs may also into the one end of the optic-like tube or tube-assembly so even the film or slide is install within the optic-like tube inside by groove, holder, ring. So the wider shaped or tiny-image light beam emit to top rotating single optic-lens (03-3) and create moving rotating certain degree multiple big projection image such as STARWAR characters, Frozen character or any Disney Characters or cartoon, time, logo, art work etc.

From FIG. 6 show the 3 main components LEDs (01-LED), image carrier (02-ImCa), project-lens-assembly (03-PL) to make the wider viewing angle big moving project image. The said LEDs(01-LED) has its relatively top image carrier (02-ImCa) so can has the shaped or tiny-image light beams to emit to the project-lens-assembly (03-PL) each single project-lens to get the continuously moving clear and big project-image to travel certain degree of the circle with wide viewing angle to viewer.

The LEDs (01-LED) has narrow light beam as right hand side of FIG. 6 for narrow light beam (N1) through the other optic-lens (OP-1) or optics-like tube (OP-1) can become wider (W2) and passing through the image carrier (02-ImCa) with some distance to get much wider (W3) shaped or tiny-image light beam to emit to project-lens-assembly (03-PL) to form the continuously moving big project-image (04-MBPI). The more LEDs (01A, 01B, 01C, 01D) and its image-carrier (04A) can get more moving big project image. The moving big project image (04-MBPI) the moving direction for clock-wise or anti-clock wise will be depend on the motor and its gear-set direction. The moving big projection image (04-MBPI) moving angle will depend on the number of single optics-lens (04E) number within the 360 degree of holder or frame. More single optics-lens (04E) will has less traveling angle of the said moving big project image (04-MBPI). For the FIG. 6, the 6 single optic-lens (04E) within the 360 degree frame or holder, the moving big project-image (04-MBPI) will travel around 360/6=60 degree. So more single optic-lens (o4E) inside of the frame (F) will get less travel angle. Also, the less openings (04B), cutouts (04C), printed windows (04D), film (04B), slides (04E) will get less type/design/shape/image of the moving big project-image(04-MBPI). Also, if only had one top single optic-lens with one printed-window, the one continue moving big project image(04-MBPI) will move very slow because the axis rotate 360 degrees only had one single optic-lens can project image for around 180 degrees. So the moving big project image (04-MBPI)
FIG. 1A and FIG. 1B and FIG. 1C: Disclosure the 3 embodiment of the said project night light has the wider viewing angle moving project image from the said 3 different moving theory night light. FIG. 1A is use LEDs on time on different time period to change the Light source relative position, orientation to the said image carrier or-and project-lens(s). FIG. 2A is used motor or movement, spin, rotate, moving device to make the said image carrier(s) to moving to make the big project image to moving. FIG. 3A use the magnetic & magnetic-coil with mechanical arms to make the image carrier to moving, shaking, swing to make the said big project image moved.
FIG. 1BB: Disclosure the FIG. 1B for details construction which has movement or motor on bottom with axis long enough to hold and rotate the said image carrier and also allow the LEDs and circuit board along the axis so can allow LED(s) light beam passing through the top optic-lens (change narrow LED light beam to wider and parallel light beam) to hit the top image-carrier and light passing through the image-carrier's opening, cutout, windows, printed window, film, slide, or display or digital data display and go through the top project-lens which may in variety type including but not limited for one refraction-lens or multiple refraction-lens or refraction with reflection lens or any combinations from market available type to create desired light effects. (This drawing same as co-pending filing (#ZZZ-3) U.S. application Ser. No. 14/503,647),
From 1CC; Disclosure the FIG. 1C for details construction which has the magnetic & magnetic coil sets to make the magnetic reaction force to pull and push the swing-arm's built-in magnetic unit so can move the swing-arms swinging to make the image-carrier to moving back-and-forth to simulate the sea wave moving effects. The LED light beam pass through the said sea-wave texture image-carrier and emit the tiny image to the top project-lens to magnify to project to wider viewing angle project image on the desire surfaces including wall, ceiling, floor. The moving device here is by magnetic reaction force not from the motor/movement/rotate or spin devices.
FIG. 3A and FIG. 3B and FIG. 3C and FIG. 3D and FIG. 3E and FIG. 3F: Disclosure the other embodiment of the said LED bulb for down light, or entrance light, stair light, recess light applications such as FIG. 3A, FIG. 3B, FIG. 3C for normal down light installations. Some of other LED Bulb which may has the block-means from the ceiling, walls, lamp shade which made of cement, concrete, metal, porcelain, pottery or any material which will block out the electric wave, electric signal to transmit though to affect or interfere the LED Bulb operated by Wi-Fi, Blue-tooth, internet, App software electric signal delivery so the current invention has different design (FIG. 3F, FIG. 3E, FIG. 3D) has moveable-means such as retractable, extendable, spin, rotate, moving arms, snake house, hinge to move the LED Bulb's at least one level(s) away from (a) Heat (b) light traveling (c) electric signal transmitting (d) all other block-means related to the said LED.
FIG. 4 and FIG. 4a, FIG. 4b disclosure the current invention co-pending filing (#ZZZ-1) U.S. application Ser. No. 14/323,318 which is Continue in Pat filing of (#ZZZ-13) U.S. application Ser. No. 14/023,889 both is related to the wider area image or project image night light with motor/spin/rotating kits to project moving big image.
FIG. 5a and FIG. 5b and FIG. 5c and FIG. 5d disclosure the preferred 5^{th} embodiment which has the basic 3 main construction of the LED(s), image carrier(s), project-lens assembly as all co-pending filing related to one or more than one project filing cases. The current invention had motor/movement means to drive axis to rotating and top of the motor has plurality of LED(s) as light source, the LED light beam go through the image-carriers which has one or more than one film/slide/openings/printed windows with or without the holder or disc which is not rotatable or moving. The lighted tiny image from the said image carrier emit to the top project-lens assembly which may be one or more than one which is moving, rotate, spin to allow the tiny-image light beam to fall within each of project-lens from one edge to other edge to form the big project image moving on top ceiling or walls or floor from angle N to N-1. The normally the angle depend on how many project-lens inside a round disc or spheres or dish-like carrier or holder. Such as 6 lens arranged on the disc as FIG. 5A, the each of project-lens around 60 degree, the moving big project image also will show on the surface will has around same 60 degree from appear to dis-appear. This embodiment all parts all fit within the said LED bulb housing parts not as the co-inventor's earlier filing cases the LED, film/slide/displayer/screen, project-lens incorporate with tube or tube-assembly piece. The current invention mainly to fit within the LED bulb housing parts only.
From FIG. 5B disclosure the alternative arrangement for the rotating multiple project-lens assembly which has a round holder to hold or fix the 6 project-lens each from edge to edge of lens around 60 degree or less so the big project image will move from appear to dis-appear around degree on surface. The difference than the FIG. 5A is the light beam from LED(s) and tiny-image light-beams has the relatively and separate tube(s) to position with each LED(s) and Light output end of lighted tiny-image ends, so the light beams from these 2 sections will not leakage too much to inside of the said housing.
From FIG. 6a: Disclosure the light theory for the more than one project head same as the co-pending filing that the one project night light or LED bulb has built-in multiple project-assembly like the co-inventor's U.S. Pat. No. 8,083,377 issued date Dec. 27, 2011 FIG. 15 and FIG. 16 has the multiple project head to create multiple big project images on areas or surface. The current invention has plurality of the LEDs and top has image-carrier in one piece or many different film/slide/openings/printed windows/stencils/to allow the LED light beam to pass through for form a lighted tiny-image to go through the top project-lens from number 1 to number N (N-can be same number of top project-lens of the disc or Holder) and from edge to other edge so can see the moving big project image from angle N-appear to Angle N-dis-appear. The construction for example but not limited for these limited drawings. It is appreciated all kind of alternative or replaceable or equal function or result or effects still fall within the current invention scope and claims.

The current inventions all drawing are same as above listed co-inventor co-pending or patent drawing with some change on the more than one of level LED Bulb and show more details for variety of the moveable-means which can easily find from market available skill or method all fall within the current invention scope not limited for the above disclosure for the arms, snake house, or the movable, rotate, spin, bar, pole . . . etc. So it is easily to refer all these concepts are same but belong to brand new while become the LED bulb applications with all prior arts features and concept. It is appreciated all listed co-pending or patented drawing, concept, feature or equivalent or same functions parts/accessories/electric circuit/concept still fall within the current invention for LED BULB application. So the same construction of the co-inventor's prior arts, parent filing case, issued patents for the project assembly including all same concept, equal function, alternative skill, replacement method should be considering still fall within the current invention claims scope and range and coverage.

Below is co-pending filing (#ZZZ-4) Detail description should still fall within the current invention claims:

FIG. 1 and FIG. 1A and FIG. 1B: shows 3 preferred embodiment of the current invention has prong and more than one optic element(s) to create wide viewing angle image. All of these embodiments has common parts including (1) Light source-LEDs or Laser-light(s) (2) Wider angle top cover (preferred for Optics-lens has refractive function) with its preferred optic properties (3) More than one of optics element(s) including inner 1^{st} one or inner more optics element(s) each may has plenty light passing or shape lighting or-and the reflective or refractive function build-in (4) Each optics element(s)—has predetermined optics properties by making has different size, shape, thickness, variable thickness, height, cutout, stencil, window, silkscreened, or other assortment, arrangement, combination and the geometric optics-element may also has plenty of the convex-lens or concave lens or reflective tiny piece build in one optic reflector as 1^{st} one optics-element(s) all variable construction should be fall within the current invention scope.(5) the optics element(s) or light source (LEDs or/and laser-light) may incorporate with motor/spin/rotating/movement /magnetic unit & coil assembly to make the optical elements or light source to become moving optical-element(s) or light source to make the splendid light performance to has changeable image, lighted patterns, message, time, geometric art, nature scene, galaxy, milky way, sky, cloud, starts, mom, water waves, animal, characters, cartoon, sign, logo, commercial to been seen.

From FIG. 1 and FIG. 1A and FIG. 1B, the LED and/or laser-light device which has more than one optical element(s) including optics-lens(es) which reflective or refractive properties. These devices have plug-in type prongs to connect with outlets from a wall, an extension cord, a power station, or a desk lamp power station's outlet receptacle. The LED and/or laser light device creates the light images towards ceilings, walls, floors, grounds, and all other preferred flat and visible area, but not limited to these prefers. The top cover of said device, has a designated or waved or diffusion or refraction treatment with preferred thickness, is able to project and create said images or-and lighted patterns to be widen to a bigger space, area, location, or all said surfaces.

The optics-elements has more than one including but not limited for optics-lens which has convex or reflective or refractive or any combination of these optics properties' construction basing on the requirement. Hence, the current invention any light beam can traveling or passing through at least more than one geometric shape optics-element and the said light beam emit out from LED or-and laser-lights' head to hit the 1^{st} reflective or refractive optics-lens or other material optics-element(s), then, Hit 2^{nd}, 3^{rd}, 4^{th} . . . . Till the light beam are pass through to outside through the top cover optics-elements which preferred is optic-lens with refraction properties.

The optics elements have more than one number and can be an optic lenses or any kind of material that will change the directions of path of the lights coming from the LEDs or-and laser. Optical lens either has convex lenses with designed thickness or reflective/refractive lenses to increase light effects and incorporate with moving device to make the movement patterns of the lights, these lenses are not limited to be used as one, but can be used as any combination of market available optics-lens with different optics properties.

From FIG. 1 show the more than one of optics-element(s) including the Top cover is optics-lens and inner optics-elements also is an optics-lens with desired lens specification and optics properties. This 1^{st} embodiment shown the 2 optics-elements both are optics-lens. The Top cover optic-lens has textures or variety or variable thickness reflective or-and refractive design to make all incoming light beam to reflective or-and refracted traveling or passing though the top cover optics-lens to refraction to wider areas to viewer. The light beam emits from the below desired number and color and brightness LEDs or-and Laser-Light(s) to get the very splendid color, light sport, diffusion, variable pattern while incorporated with the said IC or movement device, motion unit to make the light effects has moving and color changing and exciting effects to view.

From FIG. 1A shown the more than one of optics-element which is Not Only including the Top Cover optics-lens with textures here prefer as wave textures , but also inner 2^{nd} optics-element is not optics-lens which is made of other preferred material with desired treatment including printed film, stencil, plastic sheet has opening, cutouts, shaped or windows incorporate with movable, shakable, waving, rotating, spin device(s) so can make the non-movable Light source including LEDs or/and Laser-lights light beam passing though the movable 2^{nd} optics-elements and its optics designs such as textures or plurality of wave shaped light beam go through the 1^{st} optics-lens multiple times of reflection or/and refraction so get the pre-designed light effects after the light beams come out from top cover optics-lens. This is the examples for 2 optics-elements one is optic lens as top cover and other is the other material's optic-elements which has it preferred shaped or film or slide or pre-shaped window or printed film or image-forming carrier on the optics-element to make the designed shape, image, characters, sign, slogan, words.

The light beam come out from 2^{nd} optic-elements which incorporate with moving device so the light beams has its moving effects and then hit the 1^{st} top cover optics-lens and its texture or optics designs will make multiple times reflection or/and refraction can make the light performance become motion waves effects or such as Aurora, moving clouds, changeable galaxy, moving stars, moving milky river or other nature scene can be produce under details design for inner 2^{nd} optics-elements with design-forming carrier or image-forming carrier which may is film, slide, LCD display, stencil, printed film . . . etc.

From FIG. 1B show the moving optics as FIG. 1A preferred embodiment which has more than one of optics-elements which has 3 optics-elements which has plurality of tiny reflective-lens to form a big reflector as FIG. 2 and FIG. 2A which has desired different size, shape, geometric shape, thickness, focus, colors and may incorporate with motor, spin kit, rotating unit, movement, magnetic unit & coil assembly, shaking unit, waving kits, crane-shaft to make the fixed LEDs or Laser-lights' light beam travel and passing through the lower 3^{rd} optical-unit which preferred is crystal-like ball or nuts to create a hundred of light beam to hit to 2^{nd} optics-element may is a moving or steady reflector which has plurality of small reflective lens arrange on a dish-like surface or 2^{nd} optic-element made by other material has shaped holes, windows, cutouts, opening means and light can be shaped to certain range such as aurora light shape , cloud shape, star shape, milky river, galaxy shape , then the light beam will hit to the 1^{st} optics-element which is a top cover optics-lens to enlarge light beam to spread out to wider viewing angle image to let viewers to see.

The FIG. 1, FIG. 1A, FIG. 1B shown detail drawing show all the light beam emits out from the lower position's LEDs or-and Laser-Light(s) traveling or/and passing though different 2^{nd} or 3^{rd} optic-elements to make some plurality of light beams or shaped light beams and hit the cover optics-elements which preferred is optic-lens. The current invention can create the perfect light effects which are very good design and cannot make by single Optics-property such as only reflective or only refraction to get such effects.

From FIG. 1, FIG. 1A, FIG. 1B The current invention shown some optics-element(s) including
(1) Optic-lens has textures
(2) Optics-element made of other material has shape holes, opening, cutouts, window, stencil, film, slide, LCD display, wireless changeable images.
(3) Optics-element or Optic-lens is moving while incorporate with crane-shift, motor & axis, spin kit, rotating kits, clock movement, Magnetic unit & coil assembly.
(4) Optic-element is a geometric shape unit has plurality tiny reflective lens arranged for geometric shape surface with different shape, size, color, thickness, variable thickness into or form a one unit to get fixed LEDs or-and Laser-light light beam to plurality of light beams become very splendid and spread out light beam
(5) Optic-lens for dome, half ball, ⅔ ball or sphere shape Cover which has wide opening so can has wider viewing angle to make all light beams to spread out to wider and Bigger areas with said designed Image wanted with or without refractive optics properties.
(6) Optics-element made by preferred material such as plastic can be any shape such as sheet, piece, ball, half ball, dome, nuts, ⅔ ball, sphere, bar, cover or any other geometric shape with its preferred optic construction including texture, opening, window, convex lens, slide, film, character image, LCD display, magnify lens, variable thickness, variable focus by plurality of tiny optic-lens, reflective piece, refraction-lens has steady fixed or has moving , waving, shaking, vibration, rotating device to added features.
   So these are the other features for the current invention from the above FIG. 1, FIG. 1A, FIG. 1B.

From FIG. 1 and FIG. 1A and FIG. 1B. It has alternative design to get desired light effects which just has more than one LEDs or/and laser-light(s) so can use LED or-and Laser light source has different time to turn on and turn off with desired cycle, duration and frequency so can make the lighting is changeable for color, brightness so look like the moving or variable light effects to save a lot of complicated assembly or cost by using the motor or movement.

The LEDs or/and laser-light(s) may selected from group of color, specification, size, functions, power, watt, and each LED or/and laser-light(s) can has its emit direction, orientation, angle to anywhere while the inner has more than one reflective lens as inventor's prior patented claims so the each LED or/and laser-light(s) device has different light emit direction even LED or/and laser-light emit angle is narrow but after the light beam been under may reflected or/and refracted then, the light will come out from its wide opening cover including 180 flat, dome, ½ ball, ⅔ ball, sphere or dome shape cover so can get the wider viewing angle image or lighted patterns shown on desired sides, areas, surface.

This is the result basing (1) More than one LEDs or laser-light(s) (2) More than one Reflect or Refractive optics-lens or units (3) more than one optics-elements with desired optic properties (4) Selected incorporate with other parts & accessories may in desired combination selected from motor, movement, magnetic unit & coil assembly for inductive control the optic-lens waving, Interchangeable power source, moving optics-elements, optic-element made of light-block material has shaped holes or opening or windows, texture lens, optics lens, plurality of optics lens, IC, power source etc. which may use all inventor's co-pending prior arts scope as inventor's all prior patents and co-pending all LED project light concept as above and below listed (9) co-pending and issued Prior arts.

Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918). LED light has laser means

U.S. Ser. No.12/624,621 (Now is U.S. Pat. No. 8,303,150) LED project light for Seasonal items

U.S. Ser. No.12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Sep. 8, 2010 filed

U.S. Ser. No 12/938,564 Laser projection light device, Nov. 4, 2010 filed

U.S. Ser. No. 12/948,953 LED light has time projection. Nov. 13, 2010 filed.

U.S. Ser. No. 13/021,107 LED light has 3Diemsional projection, Feb. 4, 2011 filed.

Above listed Projection light device total has (9) projection light device are parent filing cases as CIP filing of the current invention.

From FIG. 1 and FIG. 1A and FIG. 1B show the Plug-In type light device with base are install on the Plug-In housing to make the Alternative Current (A.C.) to drive the inner circuit, LEDs or/and laser light, Sensor, switch, controller or wireless controller, and optional motor to make the moving optics-element including but not limited for optic-lens so can make motion effects of the related image to ceiling/walls/floor has plenty of color and moving (If add the motor or moving device).

The Said geometric shape optics-element(s) has more than one reflective or refractive or shape the light beam properties for the current FIG. 1 and FIG. 1A and FIG. 1B for all the said optics-elements of LED or-and laser light device.

The said LED or-and Laser light which preferred has the sphere or ball or half ball or ⅔ ball or dome or around 180 degree flat wide opening lens as top cover optics-lens has desired of optics-lens with desired optics properties including magnify and diffusion or spread out the light beams by (1) mirror-polished reflective or refractive lens for outside or inside and has (2) round convex surface outside of each optics-lens so it become a convex-lens so it will be not only can reflect the light beams also can allow light beam refraction and pass through to 180 degree wide opening flat cover or dome cover or sphere cover so the wider 180 degree flat opening or dome or sphere or half-ball or ⅔ ball Cover optics-lens is needed for current invention.

It is appreciated that the non-shown details for the Alternative Current (A.C.) type power unit has receptacle to receiving transformer, adaptor or AC wires. Adaptor or AC wires to drive the circuit to make the light source(s) turn on and emit light beam to desire area(s). It also can use USB wire to get power from the USB Ports.

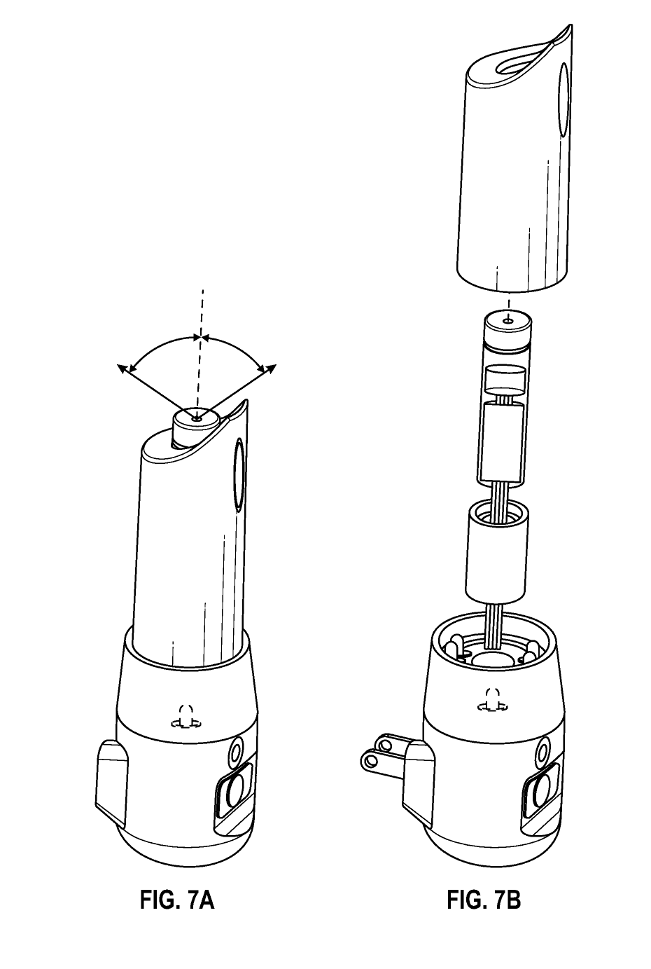

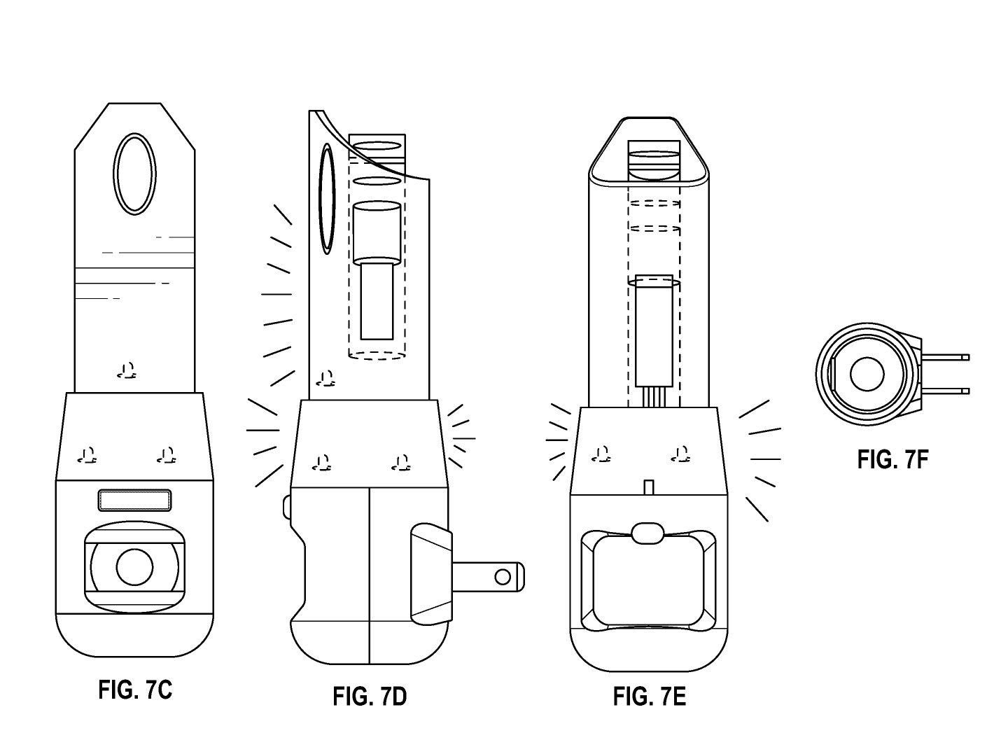

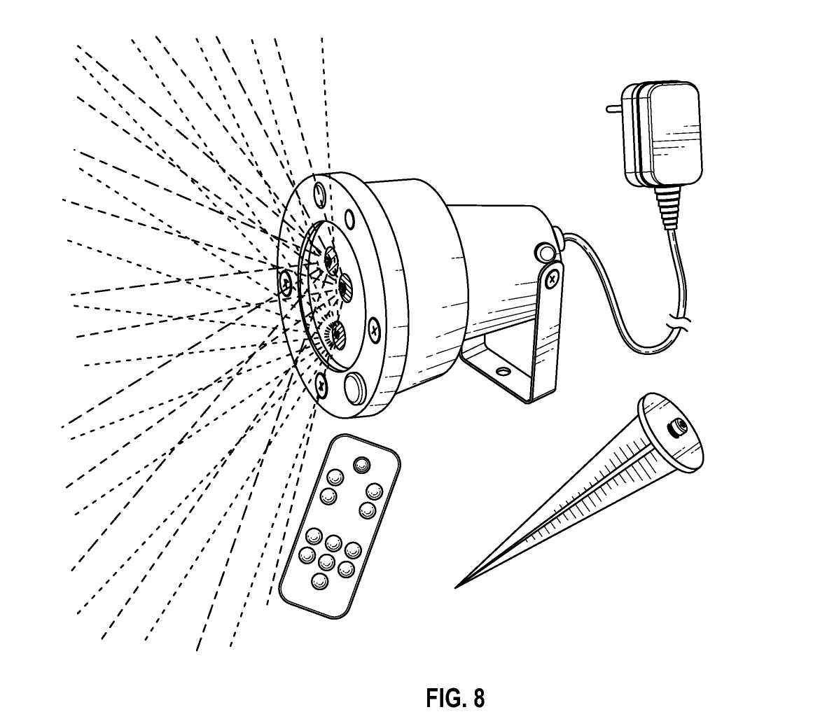

From FIG. 1-6, FIG. 1-7, FIG. 1-8, FIG. 1-9, FIG. 1-10 It also can have the LED or-and laser light device has the Bulb-like shape housing and bulb-base as current delivery terminals to get AC power instead for Prongs application which always located on lower position. The Bulb-like shape device has bulb-base will be always on higher location for people to use is other current inventions features. These common skills can use from market place.

From FIG. 1 and FIG. 1A and FIG. 1B shows light device its optic-element has more than one reflective or refractive on its surface within one optics-lens to allow light beam can traveling or pass though the convex-lens especially for the TOP Cover Optics-element and reflect within the reflective-lens or refractive lens (2 in one piece) to let light emit out to create image on ceilings, walls, floor, so the more than one of optics-elements also including the one piece of lens has more than one optic-properties.

FIG. 1-1 and FIG. 1-2 and FIG. 1-3 and FIG. 1-4: shows a first preferred embodiment of the current invention has (2) Optics elements-one is top cover is optic-lens with refractive or-and reflective properties and one is inner disc-like optics-lens has refractive or-and reflective properties or convex lens both has the preferred wave-textures has variable thickness so the LEDs or Laser-Lights some of the light beam can passing though the disc-like optics-lens has wave textures then has 1^{st} lighted patterns or image and all these 1^{st} group light beam will traveling or passing the 2^{nd} Big and Wide optics-lens to create the Super large size viewing angle image, lighted patterns, message, time, geometric art, nature scene, galaxy, milky way, sky, cloud, starts, moon, water waves, animal, characters, cartoon, sign, logo, commercial to been seen.

From FIG. 1-1 show the current invention for 1^{st} embodiment which can get the AC power from different housing design from AC prong, AC bulb base or get the DC power from DC USB female port. The prong and Bulb base and USB female ports all only need to have Positive and negative current connect to 2 prong or 2 terminal of bulb base or 2 end of the USB female terminal so the current invention can have different shape of products but with same optics application for Prong unit, Bulb base unit, USB port unit only different only at the power input terminal design as FIG. 1-1 to FIG. 1-4 for prong and FIG. 1-7 to FIG. 1-10 for bulb base unit. The FIG. 1-6 show same optics arrangement but different terminals including prongs, bulb base, USB female ports.

From FIG. 1-1 and FIG. 2-4 Show no prong on drawing which may get the Direct Current (DC) by the USB female ports so these can be DC power unit which can have power from any Direct current device such as batteries, energy storage means, solar power, wind power, chemical power.

It is appreciated for the Interchangeable power source as the inventor prior art as above listed patent U.S. Pat. No. 8,434,927.

FIG. 1-5 shows the First embodiments details construction.

FIG. 1-6 shows the 2^{nd} preferred embodiment of the current invention which is using a bulb base as power supply. This figure symbolizes this invention can be powered up using many different ways such as, as shown in FIG. 1-6, a bulb base, prongs, or USB kits. FIG. 1-6 also shows the inner design which consists LED lights or-and laser lights (pattern shown as full lines and dotted lines) that are passing through the said 1^{st} optics-element which maybe a convex lens and the 2^{nd} optics-elements which may be a 2^{nd} optic-lens which has refractive properties to enlarge and spread out the light beam emit out from 1^{st} optics-element here preferred is convex lens to the outer lens (sphere) which are used for reflection and refraction. FIG. 1-6 also shows the replace of prongs by the shaped housing which has bulb base (making this product a bulb), or it can be other or alternative to get power from the USB port.

From FIG. 1-6 show the same optics-elements and same optics-application can fit for different shape of the product may has different terminals to get the power. The FIG. 1-6 show the unit has prong which same as the FIG. 1, FIG. 1-2, FIG. 1-3, FIG. 1-4 so can plug into the outlet device on wall or power strips or desk top power station. While it incorporated the bulb-base it can simple to change the product housing shape to bulb-like shape and the 2 power terminals can easily to connect on the bulb base wall for one pole and bulb base bottom for 2^{nd} pole which will has total same optics parts & accessories with the prong products. Furthermore, while people would like to use USB female ports to connect with power source by USB wires, it is simple just add one USB female port on FIG. 1, FIG. 1-1 to FIG. 1-4 housing so can instantly can power by the Prong or the USB female ports by AC current (for Prong Product) and DC current (for USB female port) which only need change the inner circuit not even touch the Same optics parts & accessories.

FIGS. 1-6, 1-7, 1-8, 1-9, and 1-10 shows the 2^{nd} preferred embodiment of the current invention which shows this invention to have (2) Optic elements: top cover on the outside, and inner disc-like convex lens. The said (2) optic elements both have preferred textures and designs (wave-like) to vary the thickness of the lens so the said LED lights or laser-lights can pass through the inner disc-like convex lens which hasta designed thickness or texture(wave-like),or lights can pass through alternative elements of optical lens(es), such as holes, stencils, walls, openings, or cutouts to project and show figures FIG. 1A and FIG. 1B without using an optical lens that has designed thickness, then pass through the outer optic element has refractive properties so can enlarge and spread out the light beam which widens the created or projected image(s), lighted patterns, message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s). FIGS. 1-6, 1-7, 1-8, 1-9, and 1-10 also shows the preferred embodiments on different power source housings such as corn-like bulb housing has bulb base; possible for many shape of the bulb available from market place and bulb bases such as e12, e17, e26, etc.

From FIGS. 1-7, 1-8, 1-9, and 1-10 show 4^{th} preferred embodiment that has the bulb shape light unit has bulb-base which-the current invention can acquire power from any bulb bases that are connected to an AC power source such as lamps, or bulb base adapters. The bulb base does not limit to one specification; any bulb bases (most commonly E12, E17, E26) can connect to the current invention. The said the current for different product housing design with preferred power terminal including prong, Bulb base, USB female ports so can be plugged in or USB wire connected in or-screwed in tightly to ensure the connectivity between the bulb base and the current this invention.

FIG. 2 and FIG. 2A shows The 3rd preferred embodiment of the current invention's optic elements has (1) The inner optic-elements is a reflector unit which has Plenty of small size different reflective optics lens build in on one piece of metalized treated reflector, the plenty of optics unit which has different size, shape, geometric shape, thickness, focus, reflective properties, refractive properties to make the LED(s) or Laser-light(s) light source light beam can traveling or passing to make the splendid and pre-designed light beam pattern, color, spread out, shape, brightness, and other light effects, performance, functions available from market place and may incorporate with motor/movement/spin/rotating/magnetic unit & coil assembly-to make the said optic-elements become moving optics-elements. From FIG. 2 and FIG. 2A shows the more than one optics-elements on the top of light source (LEDs and Laser-lights) the both light source light beam hit the center crystal-like optics ball, some light traveling and passing though the crystal-like optics ball basing on reflective or refraction theory so can create the very eye-catching light effects. The Both of optics-elements can cooperate with motor/moving/spin/rotating/magnetic unit & coil assembly to make optics-elements for moving-and moving at least one or both reflective lens and reflective-ball to get the desired light effects.

From FIG. 2 and FIG. 2A show the (2) preferred optics-elements has built-in plurality tiny reflective-lens of different size, shape, thickness, focus, color optics lens in one disc-shape reflector piece to make the LEDs or-and Laser-lights' light beam traveling or passing through to hit the others optic-element which has desire optics properties may in group combination select from optics lens, convex lens, concave lens, reflective lens, refractive lens, moving optic-element, element made by light-block material with holes, or opening or windows or cutouts or stencils, optic texture lens to make the light beam→1^{st} optic means→2^{nd} optics means (or to N optics means) to create the splendid light performance, effects, functions.

From FIG. 2A, it also appreciated that the more than one optics means and LEDs or/and Laser-lights has also incorporated with other electric parts & accessories may in group combination selected from power source, circuit, motor, movement, spin kit, rotating kit, magnetic unit & coin assembly, IC, sensor, controller or wireless controller, conductive piece, prong, Bulb base, USB set, circuit, and all other electric parts & accessories so can have right and pre-determined light function.

FIG. 2-1 and FIG. 2-2 and FIG. 2-3 and FIG. 2-4 and FIG. 2-5 shows the Second preferred embodiment which same as FIG. 1-A for moving optics-elements or moving light source which the said optics-elements (is not the optics-lens) has shaped openings, cutouts, holes, stencils, windows to allow the LEDs or/and Laser-light beam passing though the light-bock means' holes/opening/cutouts/stencils/windows and form the shaped lighted patterns and its light beam traveling (reflected) or passing though (refracted) by the top Wide angle view angle cover which has its preferred optics textures (plurality and variable focus of convex or concave small piece of lens to combine for one big as FIG. 2-1 big cover), thickness, convex or concave lens properties, reflective or refraction optics properties to has image, lighted patterns, message, time, geometric art, nature scene, galaxy, milky way, sky, cloud, starts, moon, water waves, animal, characters, cartoon, sign, logo, commercial to been seen. The second embodiment also may incorporate with motor/movement/spin/rotating/moving/magnetic unit & coil assembly to make the optics-element(s) or-and light source become moving type to make the motion light effects. This will increase more value for the said current invention.

FIG. 2-6 shows the second embodiment details construction.

From FIG. 2-6 Show the inner construction for one of preferred the light device has built-in motor (or equivalent motor as above listed all replaceable device) to fix the motor on the housing may by screw. It also shown the motor has optional gear-set (not shown) to reduce the motor's rotating speed to slower speed to prevent from people uncomfortable to see quickly moving image on ceiling, walls, floor. It also not shows the switch, electric parts & accessories, conductive wires to connect with circuit and the get the power source constructions.

From FIG. 3-1 shows the Third preferred embodiment again has more than one of optics elements including top around 180 degree wide opening optic-lens cover which preferred has wave-like textures or plurality of small convex lens with different focus design big or small size mixed with variety of the thickness or-and refractive or-and reflective properties so has variable focus while the LEDs or/and laser-lights light beam hit the cover's some light beam will reflective and some light beam will refractive to viewer or desired areas.

For FIG. 3-1, The inner also has the 2^{nd} optics elements which may is a moving optic-elements connect with motor or magnetic unit & coil assembly to make shaving, waving, moving, motion of the said moving optic-elements so the light beam traveling or passing though the inner moving optics elements will make the LEDs or/and Laser-lights' light beam become changeable position, direction, orientation and hit the top cover's optic elements designs to come out more splendid light effects may be in any combination select from image, lighted patterns, message, time, geometric art, nature scene, galaxy, milky way, sky, cloud, starts, moon, water waves, animal, characters, cartoon, sign, logo, commercial to been seen.

From FIG. 3-2 shows the Third embodiment details construction.

FIG. 4-1 and FIG. 4-2 and FIG. 4-3 show the co-pending drawing for alternative design of Top cover optic-elements has plurality of reflective and refractive optics arrangement to form a one dome or sphere lens design so can make light source light beams to back and forth within the Top Cover in ball shape to make the light source light beam to spread out to get the image for wide range, big size but this also can apply and fall within the current scope of the invention. The current invention can has the half ball, ⅔ ball, sphere, to get desired wider area or big area has the lighted patterns though the top optic-elements only because the top optic-elements consist of plurality and more than one of reflective or-and refractive lens use injection process to form one piece of the ball, ball like, sphere, half ball, ⅔ ball and incorporated with inside the LED(s) or-and Laser light source with predetermined color, number, brightness, IC, sequential, cycle, duration time, fade-in-N-fade out, pair flashing to get desired light effects. It also has the desired moving device which may selected from motor, spin kit, rotating kits, clock movement, timer, sensor, switch and get power source by prongs, bulb base, USB kits from AC or DC power source for plug-in wall outlet(female) by Prong(male) or insert into bulb socket (female) by Bulb base (male) or insert into USB port (Female) by USB Plug(male).

From co-pending filing, the alternative design for top cover with convex lens features also still fall within the current invention scope as (#ZZZ) (#ZZZ-I) (#ZZZ-II). FIG. 4 also Show the Light beam reflect within the more than one reflect-surface which on inner of the optics-lens which are in the shape of sphere. Also, the light beam pass though the outside convex-lens to project the image or lighted patterns to the ceilings, walls, floor. This embodiment teach (1) more than one reflect-surface inside of optics-lens and refract-surface outside the same optics lens (2) light project though the more than one optics-surface of same one piece of optic-lens which the inner side is a flat mirror-polished reflector and outside is convex-shape lens so it is built 2 kind of optics-properties in one optics-lens (3) each reflective and refractive lens get together to form a semi-sphere geometric shape outer optics-lens.(4) 2 half-sphere ball or ⅔ ball or dome or sphere are preferred designs.

FIG. 4-1: Show the other viewing angle for the ⅔ ball shape optic-lens has both reflective and refractive optics properties and base to form the LED or-and Laser light device which has more than one optics-properties. The ⅔ ball outer cover has more than one reflect-and refract lens. This is different with inventor's earlier U.S. Pat. No. 7,632,004 LED night light has more than one optics means.U.S. Pat. No. 8,277,087 has more than one reflect means. U.S. Pat. No. 7,455,444 LED night light has more than one LED. U.S. Pat. No. 8,434,927 interchange power source for current invention scope. Because Co-inventor prior art show is 2 separated piece not built-in one piece of optics-lens but still can be explain is continue filing for optics arrangement.

From FIG. 4-2: Show the inner side of the other shape optical-lens which has more than one reflective surfaces inside of optics-lens so can overcome LED's narrow light beam angle. The current invention all LED or-and laser light source has different direction to emit the light beam after go through multiple inner reflect-surface even the light angle is narrow it is not a problem because the light emit from LED or-and laser light source's head will hit the 1st reflect-surface, then hit to 2nd, 3rd, 4th . . . reflect-surface(s) till the light beam been pass though outside multiple convex-surface of the ball-like outer optics-lens so this is current features too! Add motor can make the image be rotating to get moving image to viewer. The construction.

ow the co-pending drawing for alternative design of Top cover optic-lens has plurality of reflective and refractive optics-surface(s) design built-in inner and outside of the cover optics-lens, so can make light source light beams to back and forth within the Top Cover inner of the ball-like shape to make the light source light beam to spread out to get the image for wide range, big size but this also can apply and fall within the current scope of the invention.

In the preferred embodiments, images are created based on the relationship between the first optics-element(s) and the second optics-element(s) or all other optics-element(s). The light device can employ any kind of design, shape, display, or geometric arrangement of the more than one optics-elements to create big size or large image to cover Big area for special light effects though the Big or wider opening of the Top cover with desired reflective or refractive lens assembly.

Although specific preferred embodiments of the current invention are described above, it is to be appreciated that all alternative, equivalent, same-function and/or same-skill-or-theory variations, modifications, replacements, arrangements, or constructions may still fall within the current scope of the invention.

1. The project assembly for (LED or-and Laser) light device consist of;
At least one of (LED or-and laser) light source which has strong light beam to project image or lighted patterns from 10 feet to 100 feet distance to be seen; and
At least one project assembly to create the lighted image or patterns has following arrangement:
(a) At least one of tube; or tube-like piece; or cylinder shape tube; or-and housing parts to prevent light beam leakage out from light device.
(b) At least one of image forming-unit; or-and lighted pattern forming-unit; or optics-pattern forming-unit (optics-lens) fit within (A) and in-front of the light source(es) to get the lighted image or lighted patterns.
(c) At least one of optics-elements for the light device's top-cover which is one of flat piece; or partial round shape; or sphere; or dome shape has wider opening to allow inner light beam to pass through and show desired lighted image or-and lighted patterns on surface which is away from light device and at least 10 feet away to present desired lighted image or patterns for any wall, ground, floor, buildings, surface.

2. The project assembly for (LED or-and Laser) light device as claim 1, the said project assembly further incorporate with moving device which is one of a motor, clock movement, inductive device, rotating unit, spin unit, gear set, elastic twist set to make the said forming-unit; or-and optics-element; or-and optics lens; or-and top cover to move to create the moving effects.

3. The project assembly for (LED or-and Laser) light device as claim 1, the said project assembly has at least one of image forming-unit which selected from slide; film; printed piece; stencil; piece has holes, cutouts, windows; LCD displayer, wireless-data screen, LCoS Lens with data-changing screen, internet wireless image.

4. The project assembly for (LED or-and Laser) light device as claim 1, the said project assembly has at least one of the lighted image forming-unit which selected from printed piece; stencil; piece has holes, cutouts, windows; geometric shaped windows with or without the movable device.

5. The project assembly for (LED or-and Laser) light device as claim 1, the said project assembly has at least one of the optics image forming-unit which selected from all kind of optic-lens which has at least one of optics properties selected from (1) reflective; or-and (2) refractive; or-and (3) different light passing capability; or-and (4) laser treated film which has grating or hologram effects in one or-and 2 surface of the optics-lens or optics-film ; these optics-lens or piece or film has different thickness, texture, curvature, finish, focus, light passing through capability, color, gaps, line-number, on anywhere of the said single piece of said optics-lens or optics-film for pre-designed specification.

6. The project assembly for (LED or-and Laser) light device as claim 1, the said the said project assembly has high power LED light source which from 0.5 Watt up to 50 wattages with or without the heat sink, ventilation device, fan to get rid-off the heat made from light device.

7. The project assembly for (LED or-and Laser) light device as claim 1, the said (LED or-and laser) light source for light device has at least one of (LED or-and Laser) light source for any number from one to N (N is any number)

8. The project assembly for (LED or-and Laser) light device as claim 1, the said (LED or-and laser) light source for light device which can create as many as different light functions while incorporate with circuitry, or-and IC, or-and control device so can change the multiple function from one to others function under pre-determined circuit and function design.

9. The project assembly for (LED or-and Laser) light device as claim 1, the said (LED or-and laser) light source for light device has at least one of control device which in group combination selected from switch, sensor, motion sensor, sound sensor, remote controller, IR or RF remote controller, power on-off change function system, wireless communication system, Wi-Fi & APP controller, Z-way controller, wireless controller.

10. The project assembly for (LED or-and Laser) light device as claim 1, the said (LED or-and laser) light source for light device which the light device is powered by the (1) AC; or-and (2) DC; or-and (3) backup battery or rechargeable battery; or-and (4) solar power module charge the inner energy storage device and energy device offer the power to garden light under. dark environment;

11. The project assembly for (LED or-and Laser) light device as claim 1, the said (LED or-and Laser) light source for light bulb incorporated with light device, the said light devise's housing has built-in at least one of bulb female socket to receiving the (LED or-and Laser) bulb male bulb-base and the said light device is controlled by control device for desired light functions, effects for steady or changeable features.

12. The project assembly for (LED or-and Laser) light device as claim 1, the said (LED or-and Laser) light source for light device the said (LED or-and Laser) light source is changeable including (1) change to other light performance, (2) change to other taste, (3) change from seasonal/holiday performance to everyday illumination function; and-or (4) change from everyday application to seasonal/holiday performance; to save consumer pocket.

13. The project assembly for (LED or-and Laser) light device as claim 1, the said (LED or-and Laser) light source for the bulb applications, the said bulb has built-in more than one bulb-base which in desired combo-base which combine at least 2 different base selected from E-11, E-12, E-17, E-26, E-27, E-30 or other market available size base including screw base, bayonet base, twist-base, one more twist or rotating angle base.

14. The project assembly for (LED or-and Laser) light device as claim 1, the said light device is outdoor lighting which has more than one functions including (1) power fail, (2) warning light, (3) SOS help light to get people notice and get help, (4) flood warning light, (5) motion sensor security light, (6) night light, (7) photo sensor light, (8) burglar alarm light, (9) camera or video and image or-and sound storage light, (10) animal/wolf/bear/deer alarm light,(11) animal repelled light (12) light has siren device; to protect residence person or-and property safety.

15. The project assembly for (LED or-and Laser) light device as claim 1, the said the light device project at least one of the image or lighted pattern has steady or moving effects, performance including; (1) Holiday/Seasonal art; (2) (LED or-and laser) lighted image;
(3) image has matrix or array arrangement; (4) single or multiple color of (LED or-and Laser) (image or-and lighted patterns); (5) words, character, logo, geometric arts; (6) Sports team sign; (7) commercial related data, image, art, slogan.

16. The project assembly for (LED or-and Laser) light device as claim 1, the said light device incorporate with Laser light source has built-in safety sensor to stop the laser beam while object/people is detected and get into safety range and the light device will shut-down the laser light source until the object/people is out and away of the safety range.

17. The project assembly for (LED or-and Laser) light device as claim 1, the said light device incorporated with Laser-Bulb as light source having built-in safety sensor to stop the laser beam while object/people is detected and get into safety range and the light device will shut-down the laser light source until the object/people is out and away from the safety range.

18. The project assembly for (LED or-and Laser) light device as claim 1, the said (LED or-and laser) light source for light device which having at least one function including (1) project image or lighted pattern for steady or moving effects; (2) Offer the illumination; (3) take photo or video at any time, or while sensor been triggered; (4) offer power to other device from built-in USB ports and related USB wire accessories.

19. The project assembly for (LED or-and Laser) light device as claim 1, the said light device is a one of indoor light device including night light, bulb with bulb-base, down light, room light, desktop light, seasonal/holiday light including light string; (or-and) is a one of outdoor light device including garden light, patio light, seasonal/holiday light including light string, camping light has at least one or more than one functions including projection, illumination, USB charging or be charged function, USB power bank function, power fail function.

20. The project assembly for (LED or-and Laser) light device as claim 1, The said light device is an outdoor garden light has required waterproof or-and anti-environment has installation kits to Insert into ground or sit on the surface of outdoor fields.

21. The project assembly for (LED or-and Laser) light device as claim 1, The said light device has groove, ditch, gap, slot, space to have wire arrangement for the said USB wire for charger or supply current to other device.

22. The project assembly for (LED or-and Laser) light device as claim 1, The said light device has groove, gap, slot, opening, ditch, holder to install the said be-charged device including portable phone, I pad, consumer electric device, computer device, communication devices which has USB charging related parts & accessories.

23. The project assembly for (LED or-and Laser) light device as claim 1, The said light device has desired outside shape for portable size products in order to make the said device can fix on position, change light beam emit direction, angle, orientation by its outside shape including but not limited for multiple cuts for one circuit into triangle, square, pentagon, hexagon, heptagon, octagon, nonagon, decagon, or any geometric shape with desired angle and height adjustable kits.

24. The (LED or-and Laser) light source for light device consist of;
At least one of (LED or-and laser) light source or (LED or-and Laser)-bulb which has strong light beam to create image or lighted patterns from 10 feet to 100 feet distance to be seen; and
At least one optics-assembly to create the lighted image or patterns has following arrangement:
(1)At least one of tube; or tube-like piece; or cylinder shape tube; or-and housing parts to prevent light beam leakage out from garden light.
(2)At least one of image forming-unit; or-and lighted pattern forming-unit; or optics-pattern forming-unit (optics-lens) fit within the said in-front of the light source(es) to get the lighted image or lighted patterns.
(3)At least one of optics-elements for the light device top-cover which is one of flat piece; or partial round shape; or sphere; or dome shape has wider opening to allow inner light beam to pass through and show desired lighted image or-and patterns on surface which away from light device at least is 10 feet away to present lighted image or patterns for any wall, ground, floor, buildings, surface.
The improvement;
The said (LED or-and Laser) light source and the said (A) (B) (C) all fit into the space of the said light device and powered by AC; or-and DC; or-and solar power with energy storage system.

25. The (LED or-and Laser) light source or bulb for garden light consist of;
At least one of (LED or-and laser) light source or (LED or-and Laser)-bulb which has strong light beam to create image or lighted patterns from 10 feet to 100 feet distance to be seen; and
At least one optics-assembly to create the lighted image or patterns has following arrangement:
(1) At least one of tube; or tube-like piece; or cylinder shape tube; or-and housing parts to prevent light beam leakage out from garden light.
(2) At least one of image forming-unit; or-and lighted pattern forming-unit; or optics-pattern forming-unit (optics-lens) fit within the (A) and in-front of the light source(es) to get the lighted image or lighted patterns.
(3) At least one of optics-elements for the light device top-cover which is one of flat piece; or partial round shape; or sphere; or dome shape has wider opening to allow inner light beam to pass through and show desired lighted image or-and patterns on surface which away from garden light and at least is 10 feet away to present lighted image or patterns for any outdoor wall, ground, floor, buildings, house, surface.
The improvement;
The said (LED or-and Laser) light source and the said (A) (B) (C) all fit into the space of the said garden light.
The said garden light has qualified for certain degree of waterproof or-and anti-environment and has installation kits to Insert into ground or sit on the surface of outdoor fields and powered by AC; or-and DC; or-and solar power with rechargeable energy storage system.
